(19) United States
(12) Patent Application Publication
(10) Pub. No.: US 2024/0269039 A1
(43) Pub. Date: Aug. 15, 2024

(54) AUTHENTICATION/TRACKING OF PHARMACEUTICAL PACKAGES USING WAVE-SHIFTING MARKER CRYSTALS

(71) Applicant: SiO2 Medical Products, Inc., Auburn, AL (US)

(72) Inventors: Robert S. Abrams, Albany, NY (US); Ahmad Taha, Auburn, AL (US); Peter J. Sagona, Auburn, AL (US); Howard Bell, Princeton, NJ (US); Alexandra Bell, Princeton, NJ (US); Josh Collins, Wallingford, PA (US); Thomas E. Fisk, Auburn, AL (US)

(21) Appl. No.: 18/563,518

(22) PCT Filed: May 24, 2022
(86) PCT No.: PCT/US2022/030746

§ 371 Date: Nov. 22, 2023

Related U.S. Application Data
(60) Provisional application No. 63/327,325, filed on Apr. 4, 2022.
(60) Provisional application No. 63/288,750, filed on Dec. 13, 2021.
(60) Provisional application No. 63/285,940, filed on Dec. 3, 2021.
(60) Provisional application No. 63/214,110, filed on Jun. 23, 2021.
(60) Provisional application No. 63/213,698, filed on Jun. 23, 2021.
(60) Provisional application No. 63/192,547, filed on May 24, 2021.

(51) Int. Cl. A61J 1/14

(52) U.S. Cl. CPC A61J 1/1468; A61J 2200/70; A61J 2205/10; A61J 2205/50

(57) ABSTRACT

The present disclosure is directed to pharmaceutical packages, such as syringes, vials, etc., containing wave-shifting crystals that, when excited, emit light having one or more characteristics by which information about the package, such as a unique package identifier, may be obtained. The wave-shifting crystals may be rare earth doped crystals. In some embodiments, the wave-shifting crystals may be incorporated into or onto a wall of a vessel, e.g. a syringe barrel or vial, in a way that maintains transparency of the vessel wall. In other embodiments, the wave-shifting crystals may be incorporated into or onto a portion of the package that need not be transparent, such as a needle shield, tip cap, or vial closure. The wave-shifting crystals may be used to track and/or authenticate a pharmaceutical package.

The present application claims priority to U.S. Provisional Patent Application No. 63/327,325, filed on Apr. 4, 2022, U.S. Provisional Patent Application No. 63/288,750, filed on Dec. 13, 2021, U.S. Provisional Patent Application No. 63/285,940, filed on Dec. 3, 2021, U.S. Provisional Patent Application No. 63/214,110, filed on Jun. 23, 2021, U.S. Provisional Patent Application No. 63/213,698, filed on Jun. 23, 2021, and U.S. Provisional Patent Application No. 63/192,547, filed on May 24, 2021, the entireties of which are incorporated herein by reference.

### FIELD OF THE INVENTION

The traceability of pharmaceutical packages, and in particular pharmaceutical packages containing injectable drugs, has become increasingly important. In an ideal scenario, a pharmaceutical package such as a drug-containing vial, cartridge, or pre-filled syringe, would be traceable across a timeline that includes (1) the manufacture of the container, (2) the filling of the container with a pharmaceutical product, and (3) the supply chain of the filled pharmaceutical package. The traceability of individual packages is a key feature to enable better control of the pharmaceutical throughout the supply chain.

Embodiments of the present disclosure relate to the incorporation of luminescent wave-shifting crystals, including for instance rare earth doped crystals, into pharmaceutical packages and to the use of the luminescent wave-shifting crystals, e.g. rare earth doped nanoparticle crystals, for the authentication and/or tracking of the unfilled vessels and/or the drug product within the packages.

### SUMMARY OF THE INVENTION

Embodiments of the present disclosure are directed to a pharmaceutical package comprising a vessel defining a lumen, a pharmaceutical solution within the lumen, a closure, and wave-shifting crystals, optionally in which the wave-shifting crystals are rare earth doped crystals, optionally in which the wave-shifting crystals are nanoparticle crystals, optionally in which the wave-shifting crystals are rare earth doped nanoparticle crystals, configured to emit light having one or more characteristics by which the package may be identified.

The pharmaceutical package of any embodiment, in which the wave-shifting crystals are rare earth doped crystals.

The pharmaceutical package of any embodiment, in which the wave-shifting crystals are nanoparticle crystals.

The pharmaceutical package of any embodiment, in which the wave-shifting crystals are rare earth doped nanoparticle crystals.

The pharmaceutical package of any embodiment, wherein the wave-shifting crystals are incorporated into a wall of the vessel.

The pharmaceutical package of any embodiment, wherein the vessel comprises at least one wall made of a thermoplastic material, for instance wherein the thermoplastic material comprises one or more of the following: polypropylene, polyethylene, COP, COC, or CBC.

The pharmaceutical package of any embodiment, wherein the vessel is a syringe barrel, a cartridge, a vial, or a blister pack.

The pharmaceutical package of any embodiment, in which the wave-shifting crystals are embedded in the at least one wall made of a thermoplastic material.

The pharmaceutical package of any embodiment, in which the wave-shifting crystals do not refract light.

The pharmaceutical package of any embodiment, in which the wall containing the wave-shifting crystals is transparent.

The pharmaceutical package of any embodiment, in which the wall containing the wave-shifting crystals has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The pharmaceutical package of any preceding embodiment, wherein the vessel is blow molded, optionally injection stretch blow molded, from a preform comprising a thermoplastic resin that contains the wave-shifting crystals.

The pharmaceutical package of any embodiment, in which the vessel is a vial, optionally a 2 ml vial, a 6 ml vial, a 10 ml vial, or a 20 ml vial (with the recited amounts being a fill volume).

The pharmaceutical package of any embodiment, wherein the vessel is injection molded from a thermoplastic resin that contains the wave-shifting crystals.

The pharmaceutical package of any embodiment, in which the vessel is a syringe barrel.

The pharmaceutical package of any embodiment, in which the wave-shifting crystals have dimensions/diameters 10 microns or less, alternatively 8 microns or less, alternatively 5 microns or less, alternatively 2 microns or less, alternatively 1 micron or less, alternatively 800 nm or less, alternatively 600 nm or less, alternatively 500 nm or less, alternatively 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.

The pharmaceutical package of any embodiment, in which the wave-shifting crystals are present in the wall of the vessel in an amount of about 1000 ppm or less, alternatively about 750 ppm or less, alternatively about 500 ppm or less, alternatively about 250 ppm or less, alternatively about 100 ppm or less, alternatively about 50 ppm or less, alternatively about 40 ppm or less, alternatively about 30 ppm or less, alternatively about 25 ppm or less, alternatively about 20 ppm or less, alternatively about 15 ppm or less, alternatively about 10 ppm or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The pharmaceutical package of any embodiment, in which the wave-shifting crystals do not leach from the vessel wall.

The pharmaceutical package of any embodiment, in which at least a portion of the thermoplastic vessel wall comprises two or more layers, wherein at least one of the two or more layers is free of the wave-shifting crystals, and at least one of the two or more layers contains the wave-shifting crystals.

The pharmaceutical package of any embodiment, in which at least a portion of the thermoplastic wall includes an in-mold label or an in-mold component containing the wave-shifting crystals.

The pharmaceutical package of any embodiment, in which the wave-shifting crystals are configured and present in an amount sufficient such that, when excited, the emission is detectable/readable by a mobile reader.

The pharmaceutical package of any embodiment, wherein the pharmaceutical package comprises one or more non-transparent areas and wherein the wave-shifting crystals are present in at least one of the non-transparent areas.

The pharmaceutical package of any embodiment, wherein the vessel is a vial and a base of the vial comprises the non-transparent area in which the wave-shifting crystals are present.

The pharmaceutical package of any embodiment, wherein the vessel is a syringe barrel and a flange of the syringe barrel comprises the non-transparent area in which the wave-shifting crystals are present.

The pharmaceutical package of any embodiment, wherein the vessel is a vial and the closure comprises a closure, for instance a seal, optionally a flip-off seal, that is the non-transparent area in which the wave-shifting crystals are present.

The pharmaceutical package of any preceding embodiment, wherein the vessel is a syringe barrel and the package further comprises: a plunger rod that is the non-transparent area in which the wave-shifting crystals are present and/or a needle shield or tip cap that is the non-transparent area in which the wave-shifting crystals are present.

The pharmaceutical package of any embodiment, in which the wave-shifting crystals are applied to or embedded in at least one of the non-transparent areas.

The pharmaceutical package of any embodiment, in which the wave-shifting crystals are blended into a thermoplastic material that makes up at least a portion of the non-transparent area.

The pharmaceutical package of any embodiment, in which the wave-shifting crystals are blended into an ink and applied to a portion of the package to produce the non-transparent area.

The pharmaceutical package of any embodiment, wherein the one or more non-transparent areas comprise text, a scannable code, or a geometric shape, optionally in which the scannable code is a bar code or QR code.

The pharmaceutical package of any embodiment, wherein the one or more non-transparent areas are channels or recesses burned into the vessel wall by a laser.

The pharmaceutical package of any embodiment, wherein the one or more non-transparent areas are embossed on the vessel, optionally wherein the vessel is a vial and the one or more non-transparent areas are embossed on a base of the vial.

The pharmaceutical package of any embodiment, wherein the one or more non-transparent areas provide sufficient contrast with the transparent vessel wall to be read by the human eye, a camera of a smartphone or tablet, or a conventional scanner.

The pharmaceutical package of any embodiment, wherein the one or more non-transparent areas are gray-scale or black.

The pharmaceutical package of any embodiment, wherein the wave-shifting crystals are applied to or embedded in the channels or recesses.

The pharmaceutical package of any embodiment, wherein the scannable code and the wave-shifting crystals are configured to be interrogated by a smart phone or tablet, and capable of being detected by a camera of the smart phone or tablet.

The pharmaceutical package of any embodiment, wherein the wave-shifting crystals have diameters less than 500 microns, optionally between about 1-500 microns, optionally from about 10-500 microns, optionally from about 50-500 microns, optionally from about 100-500 microns, optionally from about 1-200 microns, optionally from about 10-200 microns, optionally from about 50-200 microns, optionally from about 50-100 microns.

The pharmaceutical package of any embodiment, wherein the vessel comprises at least one wall made of glass, optionally borosilicate glass or aluminosilicate glass, optionally borosilicate glass, optionally Type 1 borosilicate glass, optionally aluminosilicate glass, optionally Type 1 aluminosilicate glass. The pharmaceutical package of any embodiment, in which the wave-shifting crystals are embedded in the at least one wall made of glass.

The pharmaceutical package of any embodiment, wherein the package further comprises secondary packaging and the wave-shifting crystals are incorporated into the secondary packaging. The pharmaceutical package of any embodiment, wherein the secondary packaging comprises a film covering, a flexible pouch, a box, a carton, a tray, or the like.

The pharmaceutical package of any embodiment, further comprising a coating on at least a portion of at least one wall of the vessel.

The pharmaceutical package of any embodiment, in which the coating is present on an interior surface of the at least one wall. The pharmaceutical package of any embodiment, in which the coating is present on an exterior surface of the at least one wall.

The pharmaceutical package of any embodiment, in which the coating is configured to provide the vessel with improved gas barrier properties.

The pharmaceutical package of any embodiment, in which the coating is configured to provide the interior surface of the at least one wall with improved lubricity properties.

The pharmaceutical package of any embodiment, in which the coating is configured to contact the pharmaceutical solution within the lumen.

The pharmaceutical package of any embodiment, in which the coating is configured to reduce aggregation of one or more components of the pharmaceutical solution.

The pharmaceutical package of any embodiment, in which the coating is applied by chemical vapor deposition (CVD) or atomic layer deposition (ALD), optionally CVD, optionally ALD.

The pharmaceutical package of any embodiment, in which the coating comprises one or more layers having the composition Si_{w}OₓC_{y} or Si_{w}NₓC_{y}, where w is 1, x is from about 0.5 to 2.4, and y is from about 0.6 to about 3, as determined by XPS.

The pharmaceutical package of any embodiment, in which the coating comprises one or more layers having the composition SiOₓ, wherein x is from 1.5 to 2.9.

The pharmaceutical package of any embodiment, in which the coating comprises one or more metal oxide layers, optionally one or more metal oxide layers having the composition Al2O3, AlxTiyOz, HfO2, In2O3, MgO, SiO2, SrTiOx, Ta2O5, TiO2, Y2O3, ZnO, ZnO:Al, ZrO2, La2O3, or CeO2, optionally one or more metal oxide layers having the composition Al2O3.

The pharmaceutical package of any embodiment, in which the coating is applied by wet solution deposition.

The pharmaceutical package of any embodiment, in which the wave-shifting crystals are incorporated into the coating.

The pharmaceutical package of any embodiment, in which the at least one wall of the vessel having the coating in which the wave-shifting crystals are incorporated is transparent. The pharmaceutical package of any embodiment, in which the wall having the coating in which the wave-shifting crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The pharmaceutical package of any embodiment, in which the wave-shifting crystals are present in the coating in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The pharmaceutical package of any embodiment, in which the wave-shifting crystals are present in an ink, and at least a portion of a vessel wall comprises the ink.

The pharmaceutical package of any embodiment, in which the ink is applied to an exterior wall of the vessel.

The pharmaceutical package of any embodiment, in which the ink is transparent.

The pharmaceutical package of any embodiment, in which the wall having the ink in which the wave-shifting crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The pharmaceutical package of any embodiment, in which the ink is holographic.

The pharmaceutical package of any embodiment, in which the ink is applied to at least a portion of the vessel in a predetermined pattern.

The pharmaceutical package of any embodiment, in which the ink is applied in a scannable coded pattern, optionally a bar code or QR code.

The pharmaceutical package of any embodiment, in which the wave-shifting crystals are present in the ink in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The pharmaceutical package of any embodiment, in which the coating or ink is applied to the vessel by inkjet printing or pad printing.

The pharmaceutical package of any embodiment, in which the wave-shifting crystals are present in a label, optionally an adhesive label, and at least a portion of the vessel or closure comprises the label.

The pharmaceutical package of any embodiment, in which the label is adhered to an exterior wall of the vessel.

The pharmaceutical package of any embodiment, in which the label is transparent.

The pharmaceutical package of any embodiment, in which the wall having the label in which the wave-shifting crystals are present has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The pharmaceutical package of any embodiment, in which at least a portion of the label is holographic.

The pharmaceutical package of any embodiment, in which the wave-shifting crystals are present in a portion of the label in a predetermined pattern.

The pharmaceutical package of any embodiment, in which the wave-shifting crystals are present in a portion of the label in a scannable coded pattern, optionally a bar code or QR code.

The pharmaceutical package of any embodiment, in which the wave-shifting crystals are present in a portion of the label in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The pharmaceutical package of any embodiment, wherein a portion of the vessel or closure is etched, optionally laser etched, to produce a recess and the wave-shifting crystals are incorporated into at least a portion of a recess.

The pharmaceutical package of any embodiment, wherein etching forms a recess having a predetermined pattern.

The pharmaceutical package of any embodiment, in which the predetermined pattern comprises a scannable coded pattern, optionally a bar code or QR code.

The pharmaceutical package of any embodiment, in which a polymeric resin comprising the wave-shifting crystals is positioned in the recess.

The pharmaceutical package of any embodiment, in which the polymeric resin comprises an epoxy; optionally in which the polymeric resin is an epoxy.

The pharmaceutical package of any embodiment, in which the vessel is a vial and the recess is located on a base of the vial.

The pharmaceutical package of any embodiment, in which the vessel is a syringe barrel and the recess is located on a flange of the syringe barrel.

The pharmaceutical package of any embodiment, in which the wave-shifting crystals are present in the polymeric resin in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The pharmaceutical package of any embodiment, in which the wave-shifting crystals are luminescent.

The pharmaceutical package of any embodiment, in which the wave-shifting crystals are configured/tuned to react/luminesce to one or more specific wavelengths of light.

The pharmaceutical package of any embodiment, in which the wave-shifting crystals are configured/tuned to luminesce in response to light having a wavelength within the ultraviolet spectrum, light having a wavelength within the visible spectrum, light having a wavelength within the infrared spectrum, or any combination thereof.

The pharmaceutical package of any embodiment, in which the wave-shifting crystals are configured/tuned to luminesce solely in response to light having a wavelength within the ultraviolet spectrum.

The pharmaceutical package of any embodiment, in which the wave-shifting crystals are configured/tuned to luminesce solely in response to light having a wavelength within the visible spectrum.

The pharmaceutical package of any embodiment, in which the wave-shifting crystals are configured/tuned to luminesce solely in response to light having a wavelength within the infrared spectrum.

The pharmaceutical package of any embodiment, in which the wave-shifting crystals are configured/tuned to luminesce only in response to light having a wavelength within a defined wavelength range.

The pharmaceutical package of any embodiment, in which the wave-shifting crystals are cathodoluminescent.

The pharmaceutical package of any embodiment, in which the wave-shifting crystals are down-converting phosphors.

The pharmaceutical package of any embodiment, in which the wave-shifting crystals are up-converting phosphors.

The pharmaceutical package of any embodiment, in which the wave-shifting crystals are configured/tuned to produce an emission in one or more defined wavelength bands/ranges.

The pharmaceutical package of any embodiment, in which the wave-shifting crystals are configured/tuned to have a defined rise time, decay time, or both.

The pharmaceutical package of any embodiment, in which the wave-shifting crystals are configured/tuned to produce an emission having an intensity within a defined range.

The pharmaceutical package of any embodiment, in which the wave-shifting crystals are configured/tuned to produce an emission having dimensions within a defined range.

The pharmaceutical package of any embodiment, in which the wave-shifting crystals are configured and present in an amount sufficient such that their luminescence is detectable by a hand-held pharmaceutical package authentication device, an industrial pharmaceutical package authentication device, optionally a mobile authentication device, optionally a smartphone or similar device, or any combination of devices.

The pharmaceutical package of any embodiment, in which the authentication device interrogates the pharmaceutical package using one or more discrete wavelengths.

The pharmaceutical package of any embodiment, in which the wave-shifting crystals have dimensions/diameters between about 10 nm and about 1,500 nm, alternatively between about 10 nm and about 1,000 nm, alternatively between about 10 nm and about 500 nm, alternatively between about 10 nm and about 250 nm, alternatively between about 10 nm and about 100 nm, alternatively between about 10 nm and about 50 nm, alternatively between about 100 and 1,500 nm, alternatively between about 100 and 1,000 nm, alternatively between about 200 and 1,500 nm, alternatively between about 200 and about 1,000 nm.

The pharmaceutical package of any embodiment, in which the wave-shifting crystals have dimensions/diameters 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.

The pharmaceutical package of any embodiment, in which the wave-shifting crystals are rare earth doped crystals.

The pharmaceutical package of any embodiment, in which the wave-shifting crystals are nanoparticle crystals.

The pharmaceutical package of any embodiment, in which the wave-shifting crystals are rare earth doped nanoparticle crystals.

The pharmaceutical package of any embodiment, in which the rare earth doped crystals, optionally rare earth doped nanoparticle crystals, comprise a rare earth element-containing lattice and a dopant.

The pharmaceutical package of any embodiment, in which the dopant comprises a rare earth element, and wherein the rare earth element-containing lattice contains a first rare earth element and the dopant comprises a second rare earth element, whereby the second rare earth element differs from the first rare earth element.

The pharmaceutical package of any embodiment, in which the first rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.

The pharmaceutical package of any embodiment, in which the second rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.

The pharmaceutical package of any embodiment, in which the dopant comprises two or more different rare earth elements.

The pharmaceutical package of any embodiment, wherein the lattice comprises NaYF₄.

The pharmaceutical package of any embodiment, wherein the dopant comprises Yb and a second rare earth element.

The pharmaceutical package of any embodiment, wherein the dopant comprises one of the following combinations: Er and Yb; Tm and Yb, Nd and Yb, Ho and Yb, or Pr and Yb.

The pharmaceutical package of any embodiment, in which the rare earth doped crystals, optionally the rare earth doped nanoparticles, comprise a lattice and one or more rare earth element dopants.

The pharmaceutical package of any embodiment, in which the lattice comprises NaLiF.

The pharmaceutical package of any embodiment, in which the dopant comprises Nd or Pr.

The pharmaceutical package of any preceding embodiment, in which the lattice comprises Y2O3.

The pharmaceutical package of any preceding embodiment, in which the dopant comprises Er and Yb.

The pharmaceutical package of any preceding embodiment, in which the lattice comprises Gd, optionally Gd₂SO₂ or Gd₂O₃.

The pharmaceutical package of any preceding embodiment, in which the wave-shifting crystal comprises one or more of Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er.

The pharmaceutical package of any preceding embodiment, in which the rare earth doped crystals have a polyhedral morphology.

The pharmaceutical package of any embodiment, in which the rare earth doped crystals have a uniform morphology.

The pharmaceutical package of any embodiment, in which the wave-shifting crystals are configured to produce an emission in response to interrogation by a device, optionally a smartphone, having an infrared (IR) illuminator, a VCSEL, an LED light, or a combination thereof.

The pharmaceutical package of any embodiment, in which the wave-shifting crystals are configured and present in an amount to produce an emission that is readable by a device, optionally a smartphone, having a CMOS sensor or CMOS camera.

The pharmaceutical package of any embodiment, in which the wave-shifting crystals are of a uniform or substantially uniform size, in which substantially uniform means within a tolerance of about 10 nm or less.

The pharmaceutical package of any embodiment, wherein the pharmaceutical solution is an injectable drug-containing solution.

The pharmaceutical package of any embodiment, wherein the pharmaceutical package is a pre-filled syringe, a vial, or a cartridge, optionally a pre-filled syringe, optionally a vial, optionally a cartridge.

The pharmaceutical package of any embodiment, wherein the pharmaceutical package is a vial and wherein the wave-shifting crystals are present in or on the bottom wall of the vial.

The pharmaceutical package of any embodiment, wherein the pharmaceutical package has been subjected to sterilization, optionally sterilization by irradiation, optionally sterilization by gas. The pharmaceutical package of any embodiment, wherein the wave-shifting crystals are configured to withstand sterilization of the pharmaceutical package, optionally sterilization by irradiation, optionally sterilization by gas.

The pharmaceutical package of any embodiment, wherein the pharmaceutical package has been subjected to autoclaving at a temperature of 120° C. or higher. The pharmaceutical package of any embodiment, wherein the wave-shifting crystals are configured to withstand autoclaving at a temperature of 120° C. or higher.

The pharmaceutical package of any embodiment, wherein the pharmaceutical package has been subjected to a lyophilization freeze-drying cycle. The pharmaceutical package of any embodiment, wherein the wave-shifting crystals are configured to withstand the lyophilization freeze-drying cycle.

The pharmaceutical package of any embodiment, wherein the pharmaceutical package has been subjected to a temperature at or below −20° C., optionally a temperature at or below −30° C., optionally a temperature at or below −40° C., optionally a temperature at or below −50° C., optionally a temperature at or below −60° C., optionally a temperature at or below −70° C. The pharmaceutical package of any embodiment, wherein the wave-shifting crystals are configured to withstand being subjected to a temperature at or below −20° C., optionally a temperature at or below −30° C., optionally a temperature at or below −40° C., optionally a temperature at or below −50° C., optionally a temperature at or below −60° C., optionally a temperature at or below −70° C.

The pharmaceutical package of any embodiment, wherein the wave-shifting crystals are configured to operate as a temperature indicator, a pressure sensor, or both.

The pharmaceutical package of any embodiment, wherein the pharmaceutical solution contained within the lumen comprises a member selected from the group consisting of:

### Biologic Drugs

abatacept; abciximab; abobotulinumtoxinA; adalimumab; adalimumab-adaz; adalimumab-adbm; adalimumab-afzb; adalimumab-atto; adalimumab-bwwd; ado-trastuzumab emtansine; aflibercept; agalsidase beta; albiglutide; albumin chromated CR-51 serum; aldesleukin; alefacept; alemtuzumab; alglucosidase alfa; alirocumab; alteplase; anakinra; aprotinin; asfotas alfa; asparaginase; asparaginase Erwinia chrysanthemi; atezolizumab; avelumab; basiliximab; becaplermin; belatacept; belimumab; benralizumab; beractant; bevacizumab; bevacizumab-awwb; bevacizumab-bvzr; bezlotoxumab; blinatumomab; brentuximab vedotin; brodalumab; brolucizumab-dbll; burosumab-twza; calaspargase pegol-mknl; calfactant; canakinumab; caplacizumab-yhdp; capromab pendetide; cemiplimab-rwlc; cenegermin-bkbj; cerliponase alfa; certolizumab pegol; cetuximab; choriogonadotropin alfa; chorionic gonadotropin; chymopapain; collagenase; collagenase clostridium histolyticum; corticorelin ovine triflutate; crizanlizumab-tmca; daclizumab; daratumumab; daratumumab and hyaluronidase-fihj; darbepoetin alpha; denileukin diftitox; denosumab; desirudin; dinutuximab; dornase alfa; drotrecogin alfa; dulaglutide; dupilumab; durvalumab; ecallantide; eculizumab; efalizumab; elapegademase-Ivir; elosulfase alfa; elotuzumab; emapalumab-lzsg; emicizumab-kxwh; enfortumab vedotin-ejfv; epoetin alfa; epoetin alfa-epbx; erenumab-aooe; etanercept; etanercept-szzs; etanercept-ykro; evolocumab; fam-trastuzumab deruxetecan-nxki; fibrinolysin and desoxyribonuclease combined [bovine], with chloramphenicol; filgrastim; filgrastim-aafi; filgrastim-sndz; follitropin alfa; follitropin beta; fremanezumab-vfrm; galcanezumab-gnlm; galsulfase; gemtuzumab ozogamicin; glucarpidase; golimumab; guselkumab; hyaluronidase; hyaluronidase human; ibalizumab-uiyk; ibritumomab tiuxetan; idarucizumab; idursulfase; imiglucerase; incobotulinumtoxinA; inebilizumab-cdon; infliximab; infliximab-abda; infliximab-axxq; infliximab-dyyb; infliximab-qbtx; inotuzumab ozogamicin; insulin aspart; insulin aspart protamine and insulin aspart; insulin degludec; insulin degludec and insulin aspart; insulin degludec and liraglutide; insulin detemir; insulin glargine; insulin glargine and lixisenatide; insulin glulisine; insulin human; insulin isophane human; insulin isophane human and insulin human; insulin lispro; insulin lispro protamine and insulin lispro; insulin lispro-aabc; interferon alfa-2a; interferon alfa-2b; interferon alfacon-1; interferon alfa-n3 (human leukocyte derived); interferon beta-1a; interferon beta-1b; interferon gamma-1b; ipilimumab; isatuximab-irfc; ixekizumab; lanadelumab-flyo; laronidase; lixisenatide; luspatercept-aamt; mecasermin; mecasermin rinfabate; menotropins; mepolizumab; methoxy polyethylene glycol-epoetin beta; metreleptin; mogamulizumab-kpkc; moxetumomab pasudotox-tdfk; muromanab-CD3; natalizumab; necitumumab; nivolumab; nofetumomab; obiltoxaximab; obinutuzumab; ocrelizumab; ocriplasmin; ofatumumab; olaratumab; omalizumab; onabotulinumtoxinA; oprelvekin; palifermin; palivizumab; pancrelipase; panitumumab; parathyroid hormone; pegademase bovine; pegaspargase; pegfilgrastim; pegfilgrastim-apgf; pegfilgrastim-bmez; pegfilgrastim-cbqv; pegfilgrastim-jmdb; peginterferon alfa-2a; peginterferon alfa-2a and ribavirin; peginterferon alfa-2b; peginterferon alfa-2b and ribavirin; peginterferon beta-1a; pegloticase; pegvaliase-pqpz; pegvisomant; pembrolizumab; pertuzumab; polatuzumab vedotin-piiq; poractant alfa; prabotulinumtoxinA-xvfs; radiolabeled albumin technetium Tc-99m albumin colloid kit; ramucirumab; ranibizumab; rasburicase; ravulizumab-cwvz; raxibacumab; reslizumab; reteplase; rilonacept; rimabotulinumtoxinB; risankizumab-rzaa; rituximab; rituximab and hyaluronidase human; rituximab-abbs; rituximab-pvvr; romiplostim; romosozumab-aqqg; sacituzumab govitecan-hziy; sacrosidase; sargramostim; sarilumab; sebelipase alfa; secukinumab; siltuximab; somatropin; tagraxofusp-erzs; taliglucerase alfa; tbo-filgrastim; technetium 99m tc fanolesomab; tenecteplase; teprotumumab-trbw; tesamorelin acetate; thyrotropin alfa; tildrakizumab-asmn; tocilizumab; tositumomab and iodine I-131 tositumomab; trastuzumab; trastuzumab and hyaluronidase-oysk; trastuzumab-anns; trastuzumab-dkst; trastuzumab-dttb; trastuzumab-pkrb; trastuzumab-qyyp; urofollitropin; urokinase; ustekinumab; vedolizumab; velaglucerase alfa; vestronidase alfa-vjbk; Ziv-Aflibercept; Amjevita (adalimumab-atto); Dupixent (dupilumab); Fulphila (pegfilgrastim-jmdb); Ilaris (canakinumab); Ixifi (infliximab-qbtx); Lyumjev (insulin lispro-aabc); Nyvepria (pegfilgrastim-apgf); Ogivri (trastuzumab-dkst); Semglee (insulin glargine); Uplizna (inebilizumab-cdon); A.P.L. (chorionic gonadotropin); Abrilada (adalimumab-afzb); Accretropin (somatropin); Actemra (tocilizumab); Acthrel (corticorelin ovine triflutate); Actimmune (interferon gamma-1b); Activase (alteplase); Adagen (pegademase bovine); Adakveo (crizanlizumab-tmca); Adcetris (brentuximab vedotin); Adlyxin (lixisenatide); Admelog (insulin lispro); Afrezza (insulin human); Aimovig (erenumab-aooe); Ajovy (fremanezumab-vfrm); Aldurazyme (laronidase); Alferon N Injection (interferon alfa-n3 (human leukocyte derived)); Amevive (alefacept); Amphadase (hyaluronidase); Anthim (obiltoxaximab); Apidra (insulin glulisine); Aranesp (darbepoetin alpha); Arcalyst (rilonacept); Arzerra (ofatumumab); Asparlas (calaspargase pegol-mknl); Avastin (bevacizumab); Avonex (interferon beta-1a); Avsola (infliximab-axxq); Basaglar (insulin glargine); Bavencio (avelumab); Benlysta (belimumab); Beovu (brolucizumab-dbll); Besponsa (inotuzumab ozogamicin); Betaseron (interferon beta-1 b); Bexxar (tositumomab and iodine I-131 tositumomab); Blincyto (blinatumomab); Botox (onabotulinumtoxinA); Botox Cosmetic (onabotulinumtoxinA); Bravelle (urofollitropin); Brineura (cerliponase alfa); Cablivi (caplacizumab-yhdp); Campath (alemtuzumab); Cathflo Activase (alteplase); Cerezyme (imiglucerase); Chorionic Gonadotropin (chorionic gonadotropin); Chromalbin (albumin chromated CR-51 serum); Chymodiactin (chymopapain); Cimzia (certolizumab pegol); Cinqair (reslizumab); Cosentyx (secukinumab); Cotazym (pancrelipase); Creon (pancrelipase); Crysvita (burosumab-twza); Curosurf (poractant alfa); Cyltezo (adalimumab-adbm); Cyramza (ramucirumab); Darzalex (daratumumab); Darzalex Faspro (daratumumab and hyaluronidase-fihj); Draximage MAA (kit for the preparation of technetium Tc-99m albumin aggregated); Dysport (abobotulinumtoxinA); Egrifta (tesamorelin acetate); Egrifta SV (tesamorelin acetate); Elaprase (idursulfase); Elase-chloromycetin (fibrinolysin and desoxyribonuclease combined [bovine], with chloramphenicol); Elelyso (taliglucerase alfa); Elitek (rasburicase); Elspar (asparaginase); Elzonris (tagraxofusp-erzs); Emgality (galcanezumab-gnlm); Empliciti (elotuzumab); Enbrel (etanercept); Enbrel Mini (etanercept); Enhertu (fam-trastuzumab deruxetecan-nxki); Entyvio (vedolizumab); Epogen/Procrit (epoetin alfa); Erbitux (cetuximab); Erelzi (etanercept-szzs); Erelzi Sensoready (etanercept-szzs); Erwinaze (asparaginase Erwinia chrysanthemi); Eticovo (etanercept-ykro); Evenity (romosozumab-aqqg); Extavia (interferon beta-1 b); Eylea (aflibercept); Fabrazyme (agalsidase beta); Fasenra (benralizumab); Fiasp (insulin aspart); Follistim (follitropin beta); Follistim AQ (follitropin beta); Follistim AQ Cartridge (follitropin beta); Gamifant (emapalumab-Izsg); Gazyva (obinutuzumab); Genotropin (somatropin); Gonal-f (follitropin alfa); Gonal-f RFF (follitropin alfa); Gonal-f RFF RediJect (follitropin alfa); Granix (tbo-filgrastim); Hadlima (adalimumab-bwwd); Hemlibra (emicizumab-kxwh); Herceptin (trastuzumab); Herceptin Hylecta (trastuzumab and hyaluronidase-oysk); Herzuma (trastuzumab-pkrb); Humalog (insulin lispro); Humalog Mix 50/50 (insulin lispro protamine and insulin lispro); Humalog Mix 75/25 (insulin lispro protamine and insulin lispro); Humatrope (somatropin); Humegon (menotropins); Humira (adalimumab); Humulin 70/30 (insulin isophane human and insulin human); Humulin N (insulin isophane human); Humulin R U-100 (insulin human); Humulin R U-500 (insulin human); Hydase (hyaluronidase); Hylenex recombinant (hyaluronidase human); Hyrimoz (adalimumab-adaz); Ilumya (tildrakizumab-asmn); Imfinzi (durvalumab); Increlex (mecasermin); Infasurf (calfactant); Infergen (interferon alfacon-1); Inflectra (infliximab-dyyb); Intron A (interferon alfa-2b); Iplex (mecasermin rinfabate); Iprivask (desirudin); Jeanatope (kit for iodinated 1-125 albumin); Jetrea (ocriplasmin); Jeuveau (prabotulinumtoxinA-xvfs); Kadcyla (ado-trastuzumab emtansine); Kalbitor (ecallantide); Kanjinti (trastuzumab-anns); Kanuma (sebelipase alfa); Kepivance (palifermin); Kevzara (sarilumab); Keytruda (pembrolizumab); Kineret (anakinra); Kinlytic (urokinase); Krystexxa (pegloticase); Lantus (insulin glargine); Lartruvo (olaratumab); Lemtrada (alemtuzumab); Leukine (sargramostim); Levemir (insulin detemir); Libtayo (cemiplimab-rwlc); Lucentis (ranibizumab); Lumizyme (alglucosidase alfa); Lumoxiti (moxetumomab pasudotox-tdfk); Macrotec (kit for the preparation of technetium Tc-99m albumin aggregated); Megatope (kit for iodinated 1-131 albumin); Menopur (menotropins); Mepsevii (vestronidase alfa-vjbk); Microlite (radiolabeled albumin technetium Tc-99m albumin colloid kit); Mircera (methoxy polyethylene glycol-epoetin beta); Mvasi (bevacizumab-awwb); Myalept (metreleptin); Mylotarg (gemtuzumab ozogamicin); Myobloc (rimabotulinumtoxinB); Myozyme (alglucosidase alfa); Myxredlin (insulin human); N/A (raxibacumab); Naglazyme (galsulfase); Natpara (parathyroid hormone); Neulasta (pegfilgrastim); Neulasta Onpro (pegfilgrastim); Neumega (oprelvekin); Neupogen (filgrastim); NeutroSpec (technetium 99m tc fanolesomab); Nivestym (filgrastim-aafi); Norditropin (somatropin); Novarel (chorionic gonadotropin); Novolin 70/30 (insulin isophane human and insulin human); Novolin N (insulin isophane human); Novolin R (insulin human); Novolog (insulin aspart); Novolog Mix 50/50 (insulin aspart protamine and insulin aspart); Novolog Mix 70/30 (insulin aspart protamine and insulin aspart); Nplate (romiplostim); Nucala (mepolizumab); Nulojix (belatacept); Nutropin (somatropin); Nutropin AQ (somatropin); Ocrevus (ocrelizumab); Omnitrope (somatropin); Oncaspar (pegaspargase); Ontak (denileukin diftitox); Ontruzant (trastuzumab-dttb); Opdivo (nivolumab); Orencia (abatacept); Orthoclone OKT3 (muromanab-CD3); Ovidrel (choriogonadotropin alfa); Oxervate (cenegermin-bkbj); Padcev (enfortumab vedotin-ejfv); Palynziq (pegvaliase-pqpz); Pancreaze (pancrelipase); Pegasys (peginterferon alfa-2a); Pegasys Copegus Combination Pack (peginterferon alfa-2a and ribavirin); Pegintron (peginterferon alfa-2b); Pegintron/Rebetol Combo Pack (peginterferon alfa-2b and ribavirin); Pergonal (menotropins); Perjeta (pertuzumab); Pertzye (pancrelipase); Plegridy (peginterferon beta-1a); Polivy (polatuzumab vedotin-piiq); Portrazza (necitumumab); Poteligeo (mogamulizumab-kpkc); Praluent (alirocumab); Praxbind (idarucizumab); Pregnyl (chorionic gonadotropin); Procrit (epoetin alfa); Proleukin (aldesleukin); Prolia (denosumab); ProstaScint (capromab pendetide); Pulmolite (kit for the preparation of technetium Tc-99m albumin aggregated); Pulmotech MAA (kit for the preparation of technetium Tc-99m albumin aggregated); Pulmozyme (dornase alfa); Raptiva (efalizumab); Rebif (interferon beta-1a); Reblozyl (luspatercept-aamt); Regranex (becaplermin); Remicade (infliximab); Renflexis (infliximab-abda); Reopro (abciximab); Repatha (evolocumab); Repronex (menotropins); Retacrit (epoetin alfa-epbx); Retavase (reteplase); Revcovi (elapegademase-Ivir); Rituxan (rituximab); Rituxan Hycela (rituximab and hyaluronidase human); Roferon-A (interferon alfa-2a); Ruxience (rituximab-pvvr); Ryzodeg 70/30 (insulin degludec and insulin aspart); Saizen (somatropin); Santyl (collagenase); Sarclisa (isatuximab-irfc); Serostim (somatropin); Siliq (brodalumab); Simponi (golimumab); Simponi Aria (golimumab); Simulect (basiliximab); Skyrizi (risankizumab-rzaa); Soliqua 100/33 (insulin glargine and lixisenatide); Soliris (eculizumab); Somavert (pegvisomant); Stelara (ustekinumab); Strensiq (asfotas alfa); Sucraid (sacrosidase); Survanta (beractant); Sylvant (siltuximab); Synagis (palivizumab); Takhzyro (lanadelumab-flyo); Taltz (ixekizumab); Tanzeum (albiglutide); Tecentriq (atezolizumab); Tepezza (teprotumumab-trbw); Thyrogen (thyrotropin alfa); TNKase (tenecteplase); Toujeo (insulin glargine); Trasylol (aprotinin); Trazimera (trastuzumab-qyyp); Tremfya (guselkumab); Tresiba (insulin degludec); Trodelvy (sacituzumab govitecan-hziy); Trogarzo (ibalizumab-uiyk); Trulicity (dulaglutide); Truxima (rituximab-abbs); Tysabri (natalizumab); Udenyca (pegfilgrastim-cbqv); Ultomiris (ravulizumab-cwvz); Unituxin (dinutuximab); Vectibix (panitumumab); Verluma (nofetumomab); Vimizim (elosulfase alfa); Viokace (pancrelipase); Vitrase (hyaluronidase); Voraxaze (glucarpidase); VPRIV (velaglucerase alfa); Xeomin (incobotulinumtoxinA); Xgeva (denosumab); Xiaflex (collagenase clostridium histolyticum); Xigris (drotrecogin alfa); Xolair (omalizumab); Xultophy 100/3.6 (insulin degludec and liraglutide); Yervoy (ipilimumab); Zaltrap (Ziv-Aflibercept); Zarxio (filgrastim-sndz); Zenapax (daclizumab); Zenpep (pancrelipase); Zevalin (ibritumomab tiuxetan); Ziextenzo (pegfilgrastim-bmez); Zinbryta (daclizumab); Zinplava (bezlotoxumab); Zirabev (bevacizumab-bvzr); Zomacton (somatropin); Zorbtive/Serostim (somatropin);

### Inhalation Anesthetics

Aliflurane; Chloroform; Cyclopropane; Desflurane (Suprane); Diethyl Ether; Enflurane (Ethrane); Ethyl Chloride; Ethylene; Halothane (Fluothane); Isoflurane (Forane, Isoflo); Isopropenyl vinyl ether; Methoxyflurane; methoxyflurane; Methoxypropane; Nitrous Oxide; Roflurane; Sevoflurane (Sevorane, Ultane, Sevoflo); Teflurane; Trichloroethylene; Vinyl Ether; Xenon;

### Injectable Drugs

Ablavar (Gadofosveset Trisodium Injection); Abarelix Depot; Abobotulinumtoxin A Injection (Dysport); ABT-263; ABT-869; ABX-EFG; Accretropin (Somatropin Injection); Acetadote (Acetylcysteine Injection); Acetazolamide Injection (Acetazolamide Injection); Acetylcysteine Injection (Acetadote); Actemra (Tocilizumab Injection); Acthrel (Corticorelin Ovine Triflutate for Injection); Actummune; Activase; Acyclovir for Injection (Zovirax Injection); Adacel; Adalimumab; Adenoscan (Adenosine Injection); Adenosine Injection (Adenoscan); Adrenaclick; AdreView (lobenguane I 123 Injection for Intravenous Use); Afluria; Ak-Fluor (Fluorescein Injection); Aldurazyme (Laronidase); Alglucerase Injection (Ceredase); Alkeran Injection (Melphalan Hcl Injection); Allopurinol Sodium for Injection (Aloprim); Aloprim (Allopurinol Sodium for Injection); Alprostadil; Alsuma (Sumatriptan Injection); ALTU-238; Amino Acid Injections; Aminosyn; Apidra; Apremilast; Alprostadil Dual Chamber System for Injection (Caverject Impulse); AMG 009; AMG 076; AMG 102; AMG 108; AMG 114; AMG 162; AMG 220; AMG 221; AMG 222; AMG 223; AMG 317; AMG 379; AMG 386; AMG 403; AMG 477; AMG 479; AMG 517; AMG 531; AMG 557; AMG 623; AMG 655; AMG 706; AMG 714; AMG 745; AMG 785; AMG 811; AMG 827; AMG 837; AMG 853; AMG 951; Amiodarone HCl Injection (Amiodarone HCl Injection); Amobarbital Sodium Injection (Amytal Sodium); Amytal Sodium (Amobarbital Sodium Injection); Anakinra; Anti-Abeta; Anti-Beta7; Anti-Beta20; Anti-CD4; Anti-CD20; Anti-CD40; Anti-IFNalpha; Anti-IL13; Anti-OX40L; Anti-oxLDS; Anti-NGF; Anti-NRP1; Arixtra; Amphadase (Hyaluronidase Inj); Ammonul (Sodium Phenylacetate and Sodium Benzoate Injection); Anaprox; Anzemet Injection (Dolasetron Mesylate Injection); Apidra (Insulin Glulisine [rDNA origin] Inj); Apomab; Aranesp (darbepoetin alfa); Argatroban (Argatroban Injection); Arginine Hydrochloride Injection (R-Gene 10); Aristocort; Aristospan; Arsenic Trioxide Injection (Trisenox); Articane HCl and Epinephrine Injection (Septocaine); Arzerra (Ofatumumab Injection); Asclera (Polidocanol Injection); Ataluren; Ataluren-DMD; Atenolol Inj (Tenormin I.V. Injection); Atracurium Besylate Injection (Atracurium Besylate Injection); Avastin; Azactam Injection (Aztreonam Injection); Azithromycin (Zithromax Injection); Aztreonam Injection (Azactam Injection); Baclofen Injection (Lioresal Intrathecal); Bacteriostatic Water (Bacteriostatic Water for Injection); Baclofen Injection (Lioresal Intrathecal); Bal in Oil Ampules (Dimercarprol Injection); BayHepB; BayTet; Benadryl; Bendamustine Hydrochloride Injection (Treanda); Benztropine Mesylate Injection (Cogentin); Betamethasone Injectable Suspension (Celestone Soluspan); Bexxar; Bicillin C-R 900/300 (Penicillin G Benzathine and Penicillin G Procaine Injection); Blenoxane (Bleomycin Sulfate Injection); Bleomycin Sulfate Injection (Blenoxane); Boniva Injection (lbandronate Sodium Injection); Botox Cosmetic (OnabotulinumtoxinA for Injection); BR3-FC; Bravelle (Urofollitropin Injection); Bretylium (Bretylium Tosylate Injection); Brevital Sodium (Methohexital Sodium for Injection); Brethine; Briobacept; BTT-1023; Bupivacaine HCl; Byetta; Ca-DTPA (Pentetate Calcium Trisodium Inj); Cabazitaxel Injection (Jevtana); Caffeine Alkaloid (Caffeine and Sodium Benzoate Injection); Calcijex Injection (Calcitrol); Calcitrol (Calcijex Injection); Calcium Chloride (Calcium Chloride Injection 10%); Calcium Disodium Versenate (Edetate Calcium Disodium Injection); Campath (Altemtuzumab); Camptosar Injection (Irinotecan Hydrochloride); Canakinumab Injection (Ilaris); Capastat Sulfate (Capreomycin for Injection); Capreomycin for Injection (Capastat Sulfate); Cardiolite (Prep kit for Technetium Tc99 Sestamibi for Injection); Carticel; Cathflo; Cefazolin and Dextrose for Injection (Cefazolin Injection); Cefepime Hydrochloride; Cefotaxime; Ceftriaxone; Cerezyme; Carnitor Injection; Caverject; Celestone Soluspan; Celsior; Cerebyx (Fosphenytoin Sodium Injection); Ceredase (Alglucerase Injection); Ceretec (Technetium Tc99m Exametazime Injection); Certolizumab; CF-101; Chloramphenicol Sodium Succinate (Chloramphenicol Sodium Succinate Injection); Chloramphenicol Sodium Succinate Injection (Chloramphenicol Sodium Succinate); Cholestagel (Colesevelam HCL); Choriogonadotropin Alfa Injection (Ovidrel); Cimzia; Cisplatin (Cisplatin Injection); Clolar (Clofarabine Injection); Clomiphine Citrate; Clonidine Injection (Duraclon); Cogentin (Benztropine Mesylate Injection); Colistimethate Injection (Coly-Mycin M); Coly-Mycin M (Colistimethate Injection); Compath; Conivaptan Hcl Injection (Vaprisol); Conjugated Estrogens for Injection (Premarin Injection); Copaxone; Corticorelin Ovine Triflutate for Injection (Acthrel); Corvert (Ibutilide Fumarate Injection); Cubicin (Daptomycin Injection); CF-101; Cyanokit (Hydroxocobalamin for Injection); Cytarabine Liposome Injection (DepoCyt); Cyanocobalamin; Cytovene (ganciclovir); D.H.E. 45; Dacetuzumab; Dacogen (Decitabine Injection); Dalteparin; Dantrium IV (Dantrolene Sodium for Injection); Dantrolene Sodium for Injection (Dantrium IV); Daptomycin Injection (Cubicin); Darbepoietin Alfa; DDAVP Injection (Desmopressin Acetate Injection); Decavax; Decitabine Injection (Dacogen); Dehydrated Alcohol (Dehydrated Alcohol Injection); Denosumab Injection (Prolia); Delatestryl; Delestrogen; Delteparin Sodium; Depacon (Valproate Sodium Injection); Depo Medrol (Methylprednisolone Acetate Injectable Suspension); DepoCyt (Cytarabine Liposome Injection); DepoDur (Morphine Sulfate XR Liposome Injection); Desmopressin Acetate Injection (DDAVP Injection); Depo-Estradiol; Depo-Provera 104 mg/ml; Depo-Provera 150 mg/ml; Depo-Testosterone; Dexrazoxane for Injection, Intravenous Infusion Only (Totect); Dextrose/Electrolytes; Dextrose and Sodium Chloride Inj (Dextrose 5% in 0.9% Sodium Chloride); Dextrose; Diazepam Injection (Diazepam Injection); Digoxin Injection (Lanoxin Injection); Dilaudid-HP (Hydromorphone Hydrochloride Injection); Dimercarprol Injection (Bal in Oil Ampules); Diphenhydramine Injection (Benadryl Injection); Dipyridamole Injection (Dipyridamole Injection); DMOAD; Docetaxel for Injection (Taxotere); Dolasetron Mesylate Injection (Anzemet Injection); Doribax (Doripenem for Injection); Doripenem for Injection (Doribax); Doxercalciferol Injection (Hectorol Injection); Doxil (Doxorubicin Hcl Liposome Injection); Doxorubicin Hcl Liposome Injection (Doxil); Duraclon (Clonidine Injection); Duramorph (Morphine Injection); Dysport (Abobotulinumtoxin A Injection); Ecallantide Injection (Kalbitor); EC-Naprosyn (naproxen); Edetate Calcium Disodium Injection (Calcium Disodium Versenate); Edex (Alprostadil for Injection); Engerix; Edrophonium Injection (Enlon); Eliglustat Tartate; Eloxatin (Oxaliplatin Injection); Emend Injection (Fosaprepitant Dimeglumine Injection); Enalaprilat Injection (Enalaprilat Injection); Enlon (Edrophonium Injection); Enoxaparin Sodium Injection (Lovenox); Eovist (Gadoxetate Disodium Injection); Enbrel (etanercept); Enoxaparin; Epicel; Epinepherine; Epipen; Epipen Jr.; Epratuzumab; Erbitux; Ertapenem Injection (Invanz); Erythropoieten; Essential Amino Acid Injection (Nephramine); Estradiol Cypionate; Estradiol Valerate; Etanercept; Exenatide Injection (Byetta); Evlotra; Fabrazyme (Adalsidase beta); Famotidine Injection; FDG (Fludeoxyglucose F 18 Injection); Feraheme (Ferumoxytol Injection); Feridex I.V. (Ferumoxides Injectable Solution); Fertinex; Ferumoxides Injectable Solution (Feridex I.V.); Ferumoxytol Injection (Feraheme); Flagyl Injection (Metronidazole Injection); Fluarix; Fludara (Fludarabine Phosphate); Fludeoxyglucose F 18 Injection (FDG); Fluorescein Injection (Ak-Fluor); Follistim AQ Cartridge (Follitropin Beta Injection); Follitropin Alfa Injection (Gonal-f RFF); Follitropin Beta Injection (Follistim AQ Cartridge); Folotyn (Pralatrexate Solution for Intravenous Injection); Fondaparinux; Forteo (Teriparatide (rDNA origin) Injection); Fostamatinib; Fosaprepitant Dimeglumine Injection (Emend Injection); Foscarnet Sodium Injection (Foscavir); Foscavir (Foscarnet Sodium Injection); Fosphenytoin Sodium Injection (Cerebyx); Fospropofol Disodium Injection (Lusedra); Fragmin; Fuzeon (enfuvirtide); GA101; Gadobenate Dimeglumine Injection (Multihance); Gadofosveset Trisodium Injection (Ablavar); Gadoteridol Injection Solution (ProHance); Gadoversetamide Injection (OptiMARK); Gadoxetate Disodium Injection (Eovist); Ganirelix (Ganirelix Acetate Injection); Gardasil; GC1008; GDFD; Gemtuzumab Ozogamicin for Injection (Mylotarg); Genotropin; Gentamicin Injection; GENZ-112638; Golimumab Injection (Simponi Injection); Gonal-f RFF (Follitropin Alfa Injection); Granisetron Hydrochloride (Kytril Injection); Gentamicin Sulfate; Glatiramer Acetate; Glucagen; Glucagon; HAE1; Haldol (Haloperidol Injection); Havrix; Hectorol Injection (Doxercalciferol Injection); Hedgehog Pathway Inhibitor; Heparin; Herceptin; hG-CSF; Humalog; Human Growth Hormone; Humatrope; HuMax; Humegon; Humira; Humulin; Ibandronate Sodium Injection (Boniva Injection); Ibuprofen Lysine Injection (NeoProfen); Ibutilide Fumarate Injection (Corvert); Idamycin PFS (Idarubicin Hydrochloride Injection); Idarubicin Hydrochloride Injection (Idamycin PFS); Ilaris (Canakinumab Injection); Imipenem and Cilastatin for Injection (Primaxin I.V.); Imitrex; Incobotulinumtoxin A for Injection (Xeomin); Increlex (Mecasermin [rDNA origin] Injection); Indocin IV (Indomethacin Inj); Indomethacin Inj (Indocin IV); Infanrix; Innohep; Insulin; Insulin Aspart [rDNA origin] Inj (NovoLog); Insulin Glargine [rDNA origin] Injection (Lantus); Insulin Glulisine [rDNA origin] Inj (Apidra); Interferon alfa-2b, Recombinant for Injection (Intron A); Intron A (Interferon alfa-2b, Recombinant for Injection); Invanz (Ertapenem Injection); Invega Sustenna (Paliperidone Palmitate Extended-Release Injectable Suspension); Invirase (saquinavir mesylate); lobenguane I 123 Injection for Intravenous Use (AdreView); lopromide Injection (Ultravist); loversol Injection (Optiray Injection); Iplex (Mecasermin Rinfabate [rDNA origin] Injection); Iprivask; Irinotecan Hydrochloride (Camptosar Injection); Iron Sucrose Injection (Venofer); Istodax (Romidepsin for Injection); Itraconazole Injection (Sporanox Injection); Jevtana (Cabazitaxel Injection); Jonexa; Kalbitor (Ecallantide Injection); KCL in D5NS (Potassium Chloride in 5% Dextrose and Sodium Chloride Injection); KCL in D5W; KCL in NS; Kenalog 10 Injection (Triamcinolone Acetonide Injectable Suspension); Kepivance (Palifermin); Keppra Injection (Levetiracetam); Keratinocyte; KFG; Kinase Inhibitor; Kineret (Anakinra); Kinlytic (Urokinase Injection); Kinrix; Klonopin (clonazepam); Kytril Injection (Granisetron Hydrochloride); lacosamide Tablet and Injection (Vimpat); Lactated Ringer's; Lanoxin Injection (Digoxin Injection); Lansoprazole for Injection (Prevacid I.V.); Lantus; Leucovorin Calcium (Leucovorin Calcium Injection); Lente (L); Leptin; Levemir; Leukine Sargramostim; Leuprolide Acetate; Levothyroxine; Levetiracetam (Keppra Injection); Lovenox; Levocarnitine Injection (Carnitor Injection); Lexiscan (Regadenoson Injection); Lioresal Intrathecal (Baclofen Injection); Liraglutide [rDNA] Injection (Victoza); Lovenox (Enoxaparin Sodium Injection); Lucentis (Ranibizumab Injection); Lumizyme; Lupron (Leuprolide Acetate Injection); Lusedra (Fospropofol Disodium Injection); Maci; Magnesium Sulfate (Magnesium Sulfate Injection); Mannitol Injection (Mannitol IV); Marcaine (Bupivacaine Hydrochloride and Epinephrine Injection); Maxipime (Cefepime Hydrochloride for Injection); MDP Multidose Kit of Technetium Injection (Technetium Tc99m Medronate Injection); Mecasermin [rDNA origin] Injection (Increlex); Mecasermin Rinfabate [rDNA origin] Injection (Iplex); Melphalan Hcl Injection (Alkeran Injection); Methotrexate; Menactra; Menopur (Menotropins Injection); Menotropins for Injection (Repronex); Methohexital Sodium for Injection (Brevital Sodium); Methyldopate Hydrochloride Injection, Solution (Methyldopate Hcl); Methylene Blue (Methylene Blue Injection); Methylprednisolone Acetate Injectable Suspension (Depo Medrol); MetMab; Metoclopramide Injection (Reglan Injection); Metrodin (Urofollitropin for Injection); Metronidazole Injection (Flagyl Injection); Miacalcin; Midazolam (Midazolam Injection); Mimpara (Cinacalet); Minocin Injection (Minocycline Inj); Minocycline Inj (Minocin Injection); Mipomersen; Mitoxantrone for Injection Concentrate (Novantrone); Morphine Injection (Duramorph); Morphine Sulfate XR Liposome Injection (DepoDur); Morrhuate Sodium (Morrhuate Sodium Injection); Motesanib; Mozobil (Plerixafor Injection); Multihance (Gadobenate Dimeglumine Injection); Multiple Electrolytes and Dextrose Injection; Multiple Electrolytes Injection; Mylotarg (Gemtuzumab Ozogamicin for Injection); Myozyme (Alglucosidase alfa); Nafcillin Injection (Nafcillin Sodium); Nafcillin Sodium (Nafcillin Injection); Naltrexone XR Inj (Vivitrol); Naprosyn (naproxen); NeoProfen (lbuprofen Lysine Injection); Nandrol Decanoate; Neostigmine Methylsulfate (Neostigmine Methylsulfate Injection); NEO-GAA; NeoTect (Technetium Tc 99m Depreotide Injection); Nephramine (Essential Amino Acid Injection); Neulasta (pegfilgrastim); Neupogen (Filgrastim); Novolin; Novolog; NeoRecormon; Neutrexin (Trimetrexate Glucuronate Inj); NPH (N); Nexterone (Amiodarone HCl Injection); Norditropin (Somatropin Injection); Normal Saline (Sodium Chloride Injection); Novantrone (Mitoxantrone for Injection Concentrate); Novolin 70/30 Innolet (70% NPH, Human Insulin Isophane Suspension and 30% Regular, Human Insulin Injection); NovoLog (Insulin Aspart [rDNA origin] Inj); Nplate (romiplostim); Nutropin (Somatropin (rDNA origin) for Inj); Nutropin AQ; Nutropin Depot (Somatropin (rDNA origin) for Inj); Octreotide Acetate Injection (Sandostatin LAR); Ocrelizumab; Ofatumumab Injection (Arzerra); Olanzapine Extended Release Injectable Suspension (Zyprexa Relprevv); Omnitarg; Omnitrope (Somatropin [rDNA origin] Injection); Ondansetron Hydrochloride Injection (Zofran Injection); OptiMARK (Gadoversetamide Injection); Optiray Injection (loversol Injection); Orencia; Osmitrol Injection in Aviva (Mannitol Injection in Aviva Plastic Vessel); Osmitrol Injection in Viaflex (Mannitol Injection in Viaflex Plastic Vessel); Osteoprotegrin; Ovidrel (Choriogonadotropin Alfa Injection); Oxacillin (Oxacillin for Injection); Oxaliplatin Injection (Eloxatin); Oxytocin Injection (Pitocin); Paliperidone Palmitate Extended-Release Injectable Suspension (Invega Sustenna); Pamidronate Disodium Injection (Pamidronate Disodium Injection); Panitumumab Injection for Intravenous Use (Vectibix); Papaverine Hydrochloride Injection (Papaverine Injection); Papaverine Injection (Papaverine Hydrochloride Injection); Parathyroid Hormone; Paricalcitol Injection Fliptop Vial (Zemplar Injection); PARP Inhibitor; Pediarix; PEGIntron; Peginterferon; Pegfilgrastim; Penicillin G Benzathine and Penicillin G Procaine; Pentetate Calcium Trisodium Inj (Ca-DTPA); Pentetate Zinc Trisodium Injection (Zn-DTPA); Pepcid Injection (Famotidine Injection); Pergonal; Pertuzumab; Phentolamine Mesylate (Phentolamine Mesylate for Injection); Physostigmine Salicylate (Physostigmine Salicylate (injection)); Physostigmine Salicylate (injection) (Physostigmine Salicylate); Piperacillin and Tazobactam Injection (Zosyn); Pitocin (Oxytocin Injection); Plasma-Lyte 148 (Multiple Electrolytes Inj); Plasma-Lyte 56 and Dextrose (Multiple Electrolytes and Dextrose Injection in Viaflex Plastic Vessel); PlasmaLyte; Plerixafor Injection (Mozobil); Polidocanol Injection (Asclera); Potassium Chloride; Pralatrexate Solution for Intravenous Injection (Folotyn); Pramlintide Acetate Injection (Symlin); Premarin Injection (Conjugated Estrogens for Injection); Prep kit for Technetium Tc99 Sestamibi for Injection (Cardiolite); Prevacid I.V. (Lansoprazole for Injection); Primaxin I.V. (Imipenem and Cilastatin for Injection); Prochymal; Procrit; Progesterone; ProHance (Gadoteridol Injection Solution); Prolia (Denosumab Injection); Promethazine HCl Injection (Promethazine Hydrochloride Injection); Propranolol Hydrochloride Injection (Propranolol Hydrochloride Injection); Quinidine Gluconate Injection (Quinidine Injection); Quinidine Injection (Quinidine Gluconate Injection); R-Gene 10 (Arginine Hydrochloride Injection); Ranibizumab Injection (Lucentis); Ranitidine Hydrochloride Injection (Zantac Injection); Raptiva; Reclast (Zoledronic Acid Injection); Recombivarix HB; Regadenoson Injection (Lexiscan); Reglan Injection (Metoclopramide Injection); Remicade; Renagel; Renvela (Sevelamer Carbonate); Repronex (Menotropins for Injection); Retrovir IV (Zidovudine Injection); rhApo2L/TRAIL; Ringer's and 5% Dextrose Injection (Ringers in Dextrose); Ringer's Injection (Ringers Injection); Rituxan; Rituximab; Rocephin (ceftriaxone); Rocuronium Bromide Injection (Zemuron); Roferon-A (interferon alfa-2a); Romazicon (flumazenil); Romidepsin for Injection (Istodax); Saizen (Somatropin Injection); Sandostatin LAR (Octreotide Acetate Injection); Sclerostin Ab; Sensipar (cinacalcet); Sensorcaine (Bupivacaine HCl Injections); Septocaine (Articane HCl and Epinephrine Injection); Serostim LQ (Somatropin (rDNA origin) Injection); Simponi Injection (Golimumab Injection); Sodium Acetate (Sodium Acetate Injection); Sodium Bicarbonate (Sodium Bicarbonate 5% Injection); Sodium Lactate (Sodium Lactate Injection in AVIVA); Sodium Phenylacetate and Sodium Benzoate Injection (Ammonul); Somatropin (rDNA origin) for Inj (Nutropin); Sporanox Injection (Itraconazole Injection); Stelara Injection (Ustekinumab); Stemgen; Sufenta (Sufentanil Citrate Injection); Sufentanil Citrate Injection (Sufenta); Sumavel; Sumatriptan Injection (Alsuma); Symlin; Symlin Pen; Systemic Hedgehog Antagonist; Synvisc-One (Hylan G-F 20 Single Intra-articular Injection); Tarceva; Taxotere (Docetaxel for Injection); Technetium Tc 99m; Telavancin for Injection (Vibativ); Temsirolimus Injection (Torisel); Tenormin I.V. Injection (Atenolol Inj); Teriparatide (rDNA origin) Injection (Forteo); Testosterone Cypionate; Testosterone Enanthate; Testosterone Propionate; Tev-Tropin (Somatropin, rDNA Origin, for Injection); tgAAC94; Thallous Chloride; Theophylline; Thiotepa (Thiotepa Injection); Thymoglobulin (Anti-Thymocyte Globulin (Rabbit); Thyrogen (Thyrotropin Alfa for Injection); Ticarcillin Disodium and Clavulanate Potassium Galaxy (Timentin Injection); Tigan Injection (Trimethobenzamide Hydrochloride Injectable); Timentin Injection (Ticarcillin Disodium and Clavulanate Potassium Galaxy); TNKase; Tobramycin Injection (Tobramycin Injection); Tocilizumab Injection (Actemra); Torisel (Temsirolimus Injection); Totect (Dexrazoxane for Injection, Intravenous Infusion Only); Trastuzumab-DM1; Travasol (Amino Acids (Injection)); Treanda (Bendamustine Hydrochloride Injection); Trelstar (Triptorelin Pamoate for Injectable Suspension); Triamcinolone Acetonide; Triamcinolone Diacetate; Triamcinolone Hexacetonide Injectable Suspension (Aristospan Injection 20 mg); Triesence (Triamcinolone Acetonide Injectable Suspension); Trimethobenzamide Hydrochloride Injectable (Tigan Injection); Trimetrexate Glucuronate Inj (Neutrexin); Triptorelin Pamoate for Injectable Suspension (Trelstar); Twinject; Trivaris (Triamcinolone Acetonide Injectable Suspension); Trisenox (Arsenic Trioxide Injection); Twinrix; Typhoid Vi; Ultravist (lopromide Injection); Urofollitropin for Injection (Metrodin); Urokinase Injection (Kinlytic); Ustekinumab (Stelara Injection); Ultralente (U); Valium (diazepam); Valproate Sodium Injection (Depacon); Valtropin (Somatropin Injection); Vancomycin Hydrochloride (Vancomycin Hydrochloride Injection); Vancomycin Hydrochloride Injection (Vancomycin Hydrochloride); Vaprisol (Conivaptan Hcl Injection); VAQTA; Vasovist (Gadofosveset Trisodium Injection for Intravenous Use); Vectibix (Panitumumab Injection for Intravenous Use); Venofer (Iron Sucrose Injection); Verteporfin Inj (Visudyne); Vibativ (Telavancin for Injection); Victoza (Liraglutide [rDNA] Injection); Vimpat (lacosamide Tablet and Injection); Vinblastine Sulfate (Vinblastine Sulfate Injection); Vincasar PFS (Vincristine Sulfate Injection); Victoza; Vincristine Sulfate (Vincristine Sulfate Injection); Visudyne (Verteporfin Inj); Vitamin B-12; Vivitrol (Naltrexone XR Inj); Voluven (Hydroxyethyl Starch in Sodium Chloride Injection); Xeloda; Xenical (orlistat); Xeomin (Incobotulinumtoxin A for Injection); Xolair; Zantac Injection (Ranitidine Hydrochloride Injection); Zemplar Injection (Paricalcitol Injection Fliptop Vial); Zemuron (Rocuronium Bromide Injection); Zenapax (daclizumab); Zevalin; Zidovudine Injection (Retrovir IV); Zithromax Injection (Azithromycin); Zn-DTPA (Pentetate Zinc Trisodium Injection); Zofran Injection (Ondansetron Hydrochloride Injection); Zingo; Zoledronic Acid for Inj (Zometa); Zoledronic Acid Injection (Reclast); Zometa (Zoledronic Acid for Inj); Zosyn (Piperacillin and Tazobactam Injection); Zyprexa Relprevv (Olanzapine Extended Release Injectable Suspension);

### Liquid Drugs (Non-Injectable)

Abilify; AccuNeb (Albuterol Sulfate Inhalation Solution); Actidose Aqua (Activated Charcoal Suspension); Activated Charcoal Suspension (Actidose Aqua); Advair; Agenerase Oral Solution (Amprenavir Oral Solution); Akten (Lidocaine Hydrochloride Ophthalmic Gel); Alamast (Pemirolast Potassium Ophthalmic Solution); Albumin (Human) 5% Solution (Buminate 5%); Albuterol Sulfate Inhalation Solution; Alinia; Alocril; Alphagan; Alrex; Alvesco; Amprenavir Oral Solution; Analpram-HC; Arformoterol Tartrate Inhalation Solution (Brovana); Aristospan Injection 20 mg (Triamcinolone Hexacetonide Injectable Suspension); Asacol; Asmanex; Astepro; Astepro (Azelastine Hydrochloride Nasal Spray); Atrovent Nasal Spray (Ipratropium Bromide Nasal Spray); Atrovent Nasal Spray 0.06; Augmentin ES-600; Azasite (Azithromycin Ophthalmic Solution); Azelaic Acid (Finacea Gel); Azelastine Hydrochloride Nasal Spray (Astepro); Azelex (Azelaic Acid Cream); Azopt (Brinzolamide Ophthalmic Suspension); Bacteriostatic Saline; Balanced Salt; Bepotastine; Bactroban Nasal; Bactroban; Beclovent; Benzac W; Betimol; Betoptic S; Bepreve; Bimatoprost Ophthalmic Solution; Bleph 10 (Sulfacetamide Sodium Ophthalmic Solution 10%); Brinzolamide Ophthalmic Suspension (Azopt); Bromfenac Ophthalmic Solution (Xibrom); Bromhist; Brovana (Arformoterol Tartrate Inhalation Solution); Budesonide Inhalation Suspension (Pulmicort Respules); Cambia (Diclofenac Potassium for Oral Solution); Capex; Carac; Carboxine-PSE; Carnitor; Cayston (Aztreonam for Inhalation Solution); Cellcept; Centany; Cerumenex; Ciloxan Ophthalmic Solution (Ciprofloxacin HCL Ophthalmic Solution); Ciprodex; Ciprofloxacin HCL Ophthalmic Solution (Ciloxan Ophthalmic Solution); Clemastine Fumarate Syrup (Clemastine Fumarate Syrup); CoLyte (PEG Electrolytes Solution); Combiven; Comtan; Condylox; Cordran; Cortisporin Ophthalmic Suspension; Cortisporin Otic Suspension; Cromolyn Sodium Inhalation Solution (Intal Nebulizer Solution); Cromolyn Sodium Ophthalmic Solution (Opticrom); Crystalline Amino Acid Solution with Electrolytes (Aminosyn Electrolytes); Cutivate; Cuvposa (Glycopyrrolate Oral Solution); Cyanocobalamin (CaloMist Nasal Spray); Cyclosporine Oral Solution (Gengraf Oral Solution); Cyclogyl; Cysview (Hexaminolevulinate Hydrochloride Intravesical Solution); DermOtic Oil (Fluocinolone Acetonide Oil Ear Drops); Desmopressin Acetate Nasal Spray; DDAVP; Derma-Smoothe/FS; Dexamethasone Intensol; Dianeal Low Calcium; Dianeal PD; Diclofenac Potassium for Oral Solution (Cambia); Didanosine Pediatric Powder for Oral Solution (Videx); Differin; Dilantin 125 (Phenytoin Oral Suspension); Ditropan; Dorzolamide Hydrochloride Ophthalmic Solution (Trusopt); Dorzolamide Hydrochloride-Timolol Maleate Ophthalmic Solution (Cosopt); Dovonex Scalp (Calcipotriene Solution); Doxycycline Calcium Oral Suspension (Vibramycin Oral); Efudex; Elaprase (Idursulfase Solution); Elestat (Epinastine HCl Ophthalmic Solution); Elocon; Epinastine HCl Ophthalmic Solution (Elestat); Epivir HBV; Epogen (Epoetin alfa); Erythromycin Topical Solution 1.5% (Staticin); Ethiodol (Ethiodized Oil); Ethosuximide Oral Solution (Zarontin Oral Solution); Eurax; Extraneal (Icodextrin Peritoneal Dialysis Solution); Felbatol; Feridex I.V. (Ferumoxides Injectable Solution); Flovent; Floxin Otic (Ofloxacin Otic Solution); Flo-Pred (Prednisolone Acetate Oral Suspension); Fluoroplex; Flunisolide Nasal Solution (Flunisolide Nasal Spray 0.025%); Fluorometholone Ophthalmic Suspension (FML); Flurbiprofen Sodium Ophthalmic Solution (Ocufen); FML; Foradil; Formoterol Fumarate Inhalation Solution (Perforomist); Fosamax; Furadantin (Nitrofurantoin Oral Suspension); Furoxone; Gammagard Liquid (Immune Globulin Intravenous (Human) 10%); Gantrisin (Acetyl Sulfisoxazole Pediatric Suspension); Gatifloxacin Ophthalmic Solution (Zymar); Gengraf Oral Solution (Cyclosporine Oral Solution); Glycopyrrolate Oral Solution (Cuvposa); Halcinonide Topical Solution (Halog Solution); Halog Solution (Halcinonide Topical Solution); HEP-LOCK U/P (Preservative-Free Heparin Lock Flush Solution); Heparin Lock Flush Solution (Hepflush 10); Hexaminolevulinate Hydrochloride Intravesical Solution (Cysview); Hydrocodone Bitartrate and Acetaminophen Oral Solution (Lortab Elixir); Hydroquinone 3% Topical Solution (Melquin-3 Topical Solution); IAP Antagonist; Isopto; Ipratropium Bromide Nasal Spray (Atrovent Nasal Spray); Itraconazole Oral Solution (Sporanox Oral Solution); Ketorolac Tromethamine Ophthalmic Solution (Acular LS); Kaletra; Lanoxin; Lexiva; Leuprolide Acetate for Depot Suspension (Lupron Depot 11.25 mg); Levobetaxolol Hydrochloride Ophthalmic Suspension (Betaxon); Levocarnitine Tablets, Oral Solution, Sugar-Free (Carnitor); Levofloxacin Ophthalmic Solution 0.5% (Quixin); Lidocaine HCl Sterile Solution (Xylocaine MPF Sterile Solution); Lok Pak (Heparin Lock Flush Solution); Lorazepam Intensol; Lortab Elixir (Hydrocodone Bitartrate and Acetaminophen Oral Solution); Lotemax (Loteprednol Etabonate Ophthalmic Suspension); Loteprednol Etabonate Ophthalmic Suspension (Alrex); Low Calcium Peritoneal Dialysis Solutions (Dianeal Low Calcium); Lumigan (Bimatoprost Ophthalmic Solution 0.03% for Glaucoma); Lupron Depot 11.25 mg (Leuprolide Acetate for Depot Suspension); Megestrol Acetate Oral Suspension (Megestrol Acetate Oral Suspension); MEK Inhibitor; Mepron; Mesnex; Mestinon; Mesalamine Rectal Suspension Enema (Rowasa); Melquin-3 Topical Solution (Hydroquinone 3% Topical Solution); MetMab; Methyldopate Hcl (Methyldopate Hydrochloride Injection, Solution); Methylin Oral Solution (Methylphenidate HCl Oral Solution 5 mg/5 mL and 10 mg/5 mL); Methylprednisolone Acetate Injectable Suspension (Depo Medrol); Methylphenidate HCl Oral Solution 5 mg/5 mL and 10 mg/5 mL (Methylin Oral Solution); Methylprednisolone sodium succinate (Solu Medrol); Metipranolol Ophthalmic Solution (Optipranolol); Migranal; Miochol-E (Acetylcholine Chloride Intraocular Solution); Micro-K for Liquid Suspension (Potassium Chloride Extended Release Formulation for Liquid Suspension); Minocin (Minocycline Hydrochloride Oral Suspension); Nasacort; Neomycin and Polymyxin B Sulfates and Hydrocortisone; Nepafenac Ophthalmic Suspension (Nevanac); Nevanac (Nepafenac Ophthalmic Suspension); Nitrofurantoin Oral Suspension (Furadantin); Noxafil (Posaconazole Oral Suspension); Nystatin (oral) (Nystatin Oral Suspension); Nystatin Oral Suspension (Nystatin (oral)); Ocufen (Flurbiprofen Sodium Ophthalmic Solution); Ofloxacin Ophthalmic Solution (Ofloxacin Ophthalmic Solution); Ofloxacin Otic Solution (Floxin Otic); Olopatadine Hydrochloride Ophthalmic Solution (Pataday); Opticrom (Cromolyn Sodium Ophthalmic Solution); Optipranolol (Metipranolol Ophthalmic Solution); Patanol; Pediapred; PerioGard; Phenytoin Oral Suspension (Dilantin 125); Phisohex; Posaconazole Oral Suspension (Noxafil); Potassium Chloride Extended Release Formulation for Liquid Suspension (Micro-K for Liquid Suspension); Pataday (Olopatadine Hydrochloride Ophthalmic Solution); Patanase Nasal Spray (Olopatadine Hydrochloride Nasal Spray); PEG Electrolytes Solution (CoLyte); Pemirolast Potassium Ophthalmic Solution (Alamast); Penlac (Ciclopirox Topical Solution); PENNSAID (Diclofenac Sodium Topical Solution); Perforomist (Formoterol Fumarate Inhalation Solution); Peritoneal Dialysis Solution; Phenylephrine Hydrochloride Ophthalmic Solution (Neo-Synephrine); Phospholine Iodide (Echothiophate Iodide for Ophthalmic Solution); Podofilox (Podofilox Topical Solution); Pred Forte (Prednisolone Acetate Ophthalmic Suspension); Pralatrexate Solution for Intravenous Injection (Folotyn); Pred Mild; Prednisone Intensol; Prednisolone Acetate Ophthalmic Suspension (Pred Forte); Prevacid; PrismaSol Solution (Sterile Hemofiltration Hemodiafiltration Solution); ProAir; Proglycem; ProHance (Gadoteridol Injection Solution); Proparacaine Hydrochloride Ophthalmic Solution (Alcaine); Propine; Pulmicort; Pulmozyme; Quixin (Levofloxacin Ophthalmic Solution 0.5%); QVAR; Rapamune; Rebetol; Relacon-HC; Rotarix (Rotavirus Vaccine, Live, Oral Suspension); Rotavirus Vaccine, Live, Oral Suspension (Rotarix); Rowasa (Mesalamine Rectal Suspension Enema); Sabril (Vigabatrin Oral Solution); Sacrosidase Oral Solution (Sucraid); Sandimmune; Sepra; Serevent Diskus; Solu Cortef (Hydrocortisone Sodium Succinate); Solu Medrol (Methylprednisolone sodium succinate); Spiriva; Sporanox Oral Solution (Itraconazole Oral Solution); Staticin (Erythromycin Topical Solution 1.5%); Stalevo; Starlix; Sterile Hemofiltration Hemodiafiltration Solution (PrismaSol Solution); Stimate; Sucralfate (Carafate Suspension); Sulfacetamide Sodium Ophthalmic Solution 10% (Bleph 10); Synarel Nasal Solution (Nafarelin Acetate Nasal Solution for Endometriosis); Taclonex Scalp (Calcipotriene and Betamethasone Dipropionate Topical Suspension); Tamiflu; Tobi; TobraDex; Tobradex ST (Tobramycin/Dexamethasone Ophthalmic Suspension 0.3%/0.05%); Tobramycin/Dexamethasone Ophthalmic Suspension 0.3%/0.05% (Tobradex ST); Timolol; Timoptic; Travatan Z; Treprostinil Inhalation Solution (Tyvaso); Trusopt (Dorzolamide Hydrochloride Ophthalmic Solution); Tyvaso (Treprostinil Inhalation Solution); Ventolin; Vfend; Vibramycin Oral (Doxycycline Calcium Oral Suspension); Videx (Didanosine Pediatric Powder for Oral Solution); Vigabatrin Oral Solution (Sabril); Viokase; Viracept; Viramune; Vitamin K1 (Fluid Colloidal Solution of Vitamin K1); Voltaren Ophthalmic (Diclofenac Sodium Ophthalmic Solution); Zarontin Oral Solution (Ethosuximide Oral Solution); Ziagen; Zyvox; Zymar (Gatifloxacin Ophthalmic Solution); Zymaxid (Gatifloxacin Ophthalmic Solution);

### Drug Classes

5-alpha-reductase inhibitors; 5-aminosalicylates; 5HT3 receptor antagonists; adamantane antivirals; adrenal cortical steroids; adrenal corticosteroid inhibitors; adrenergic bronchodilators; agents for hypertensive emergencies; agents for pulmonary hypertension; aldosterone receptor antagonists; alkylating agents; alpha-adrenoreceptor antagonists; alpha-glucosidase inhibitors; alternative medicines; amebicides; aminoglycosides; aminopenicillins; aminosalicylates; amylin analogs; Analgesic Combinations; Analgesics; androgens and anabolic steroids; angiotensin converting enzyme inhibitors; angiotensin II inhibitors; anorectal preparations; anorexiants; antacids; anthelmintics; anti-angiogenic ophthalmic agents; anti-CTLA-4 monoclonal antibodies; anti-infectives; antiadrenergic agents, centrally acting; antiadrenergic agents, peripherally acting; antiandrogens; antianginal agents; antiarrhythmic agents; antiasthmatic combinations; antibiotics/antineoplastics; anticholinergic antiemetics; anticholinergic antiparkinson agents; anticholinergic bronchodilators; anticholinergic chronotropic agents; anticholinergics/antispasmodics; anticoagulants; anticonvulsants; antidepressants; antidiabetic agents; antidiabetic combinations; antidiarrheals; antidiuretic hormones; antidotes; antiemetic/antivertigo agents; antifungals; antigonadotropic agents; antigout agents; antihistamines; antihyperlipidemic agents; antihyperlipidemic combinations; antihypertensive combinations; antihyperuricemic agents; antimalarial agents; antimalarial combinations; antimalarial quinolines; antimetabolites; antimigraine agents; antineoplastic detoxifying agents; antineoplastic interferons; antineoplastic monoclonal antibodies; antineoplastics; antiparkinson agents; antiplatelet agents; antipseudomonal penicillins; antipsoriatics; antipsychotics; antirheumatics; antiseptic and germicides; antithyroid agents; antitoxins and antivenins; antituberculosis agents; antituberculosis combinations; antitussives; antiviral agents; antiviral combinations; antiviral interferons; anxiolytics, sedatives, and hypnotics; aromatase inhibitors; atypical antipsychotics; azole antifungals; bacterial vaccines; barbiturate anticonvulsants; barbiturates; BCR-ABL tyrosine kinase inhibitors; benzodiazepine anticonvulsants; benzodiazepines; beta-adrenergic blocking agents; beta-lactamase inhibitors; bile acid sequestrants; biologicals; bisphosphonates; bone resorption inhibitors; bronchodilator combinations; bronchodilators; calcitonin; calcium channel blocking agents; carbamate anticonvulsants; carbapenems; carbonic anhydrase inhibitor anticonvulsants; carbonic anhydrase inhibitors; cardiac stressing agents; cardioselective beta blockers; cardiovascular agents; catecholamines; CD20 monoclonal antibodies; CD33 monoclonal antibodies; CD52 monoclonal antibodies; central nervous system agents; cephalosporins; cerumenolytics; chelating agents; chemokine receptor antagonist; chloride channel activators; cholesterol absorption inhibitors; cholinergic agonists; cholinergic muscle stimulants; cholinesterase inhibitors; CNS stimulants; coagulation modifiers; colony stimulating factors; contraceptives; corticotropin; coumarins and indandiones; cox-2 inhibitors; decongestants; dermatological agents; diagnostic radiopharmaceuticals; dibenzazepine anticonvulsants; digestive enzymes; dipeptidyl peptidase 4 inhibitors; diuretics; dopaminergic antiparkinsonism agents; drugs used in alcohol dependence; echinocandins; EGFR inhibitors; estrogen receptor antagonists; estrogens; expectorants; factor Xa inhibitors; fatty acid derivative anticonvulsants; fibric acid derivatives; first generation cephalosporins; fourth generation cephalosporins; functional bowel disorder agents; gallstone solubilizing agents; gamma-aminobutyric acid analogs; gamma-aminobutyric acid reuptake inhibitors; gamma-aminobutyric acid transaminase inhibitors; gastrointestinal agents; general anesthetics; genitourinary tract agents; GI stimulants; glucocorticoids; glucose elevating agents; glycopeptide antibiotics; glycoprotein platelet inhibitors; glycylcyclines; gonadotropin releasing hormones; gonadotropin-releasing hormone antagonists; gonadotropins; group I antiarrhythmics; group II antiarrhythmics; group III antiarrhythmics; group IV antiarrhythmics; group V antiarrhythmics; growth hormone receptor blockers; growth hormones; H. pylori eradication agents; H2 antagonists; hematopoietic stem cell mobilizer; heparin antagonists; heparins; HER2 inhibitors; herbal products; histone deacetylase inhibitors; hormone replacement therapy; hormones; hormones/antineoplastics; hydantoin anticonvulsants; illicit (street) drugs; immune globulins; immunologic agents; immunosuppressive agents; impotence agents; in vivo diagnostic biologicals; incretin mimetics; inhaled anti-infectives; inhaled corticosteroids; inotropic agents; insulin; insulin-like growth factor; integrase strand transfer inhibitor; interferons; intravenous nutritional products; iodinated contrast media; ionic iodinated contrast media; iron products; ketolides; laxatives; leprostatics; leukotriene modifiers; lincomycin derivatives; lipoglycopeptides; local injectable anesthetics; loop diuretics; lung surfactants; lymphatic staining agents; lysosomal enzymes; macrolide derivatives; macrolides; magnetic resonance imaging contrast media; mast cell stabilizers; medical gas; meglitinides; metabolic agents; methylxanthines; mineralocorticoids; minerals and electrolytes; miscellaneous agents; miscellaneous analgesics; miscellaneous antibiotics; miscellaneous anticonvulsants; miscellaneous antidepressants; miscellaneous antidiabetic agents; miscellaneous antiemetics; miscellaneous antifungals; miscellaneous antihyperlipidemic agents; miscellaneous antimalarials; miscellaneous antineoplastics; miscellaneous antiparkinson agents; miscellaneous antipsychotic agents; miscellaneous antituberculosis agents; miscellaneous antivirals; miscellaneous anxiolytics, sedatives and hypnotics; miscellaneous biologicals; miscellaneous bone resorption inhibitors; miscellaneous cardiovascular agents; miscellaneous central nervous system agents; miscellaneous coagulation modifiers; miscellaneous diuretics; miscellaneous genitourinary tract agents; miscellaneous GI agents; miscellaneous hormones; miscellaneous metabolic agents; miscellaneous ophthalmic agents; miscellaneous otic agents; miscellaneous respiratory agents; miscellaneous sex hormones; miscellaneous topical agents; miscellaneous uncategorized agents; miscellaneous vaginal agents; mitotic inhibitors; monoamine oxidase inhibitors; monoclonal antibodies; mouth and throat products; mTOR inhibitors; mTOR kinase inhibitors; mucolytics; multikinase inhibitors; muscle relaxants; mydriatics; narcotic analgesic combinations; narcotic analgesics; nasal anti-infectives; nasal antihistamines and decongestants; nasal lubricants and irrigations; nasal preparations; nasal steroids; natural penicillins; neuraminidase inhibitors; neuromuscular blocking agents; next generation cephalosporins; nicotinic acid derivatives; nitrates; NNRTIs; non-cardioselective beta blockers; non-iodinated contrast media; non-ionic iodinated contrast media; non-sulfonylureas; nonsteroidal anti-inflammatory agents; norepinephrine reuptake inhibitors; norepinephrine-dopamine reuptake inhibitors; nucleoside reverse transcriptase inhibitors (NRTIs); nutraceutical products; nutritional products; ophthalmic anesthetics; ophthalmic anti-infectives; ophthalmic anti-inflammatory agents; ophthalmic antihistamines and decongestants; ophthalmic diagnostic agents; ophthalmic glaucoma agents; ophthalmic lubricants and irrigations; ophthalmic preparations; ophthalmic steroids; ophthalmic steroids with anti-infectives; ophthalmic surgical agents; oral nutritional supplements; otic anesthetics; otic anti-infectives; otic preparations; otic steroids; otic steroids with anti-infectives; oxazolidinedione anticonvulsants; parathyroid hormone and analogs; penicillinase resistant penicillins; penicillins; peripheral opioid receptor antagonists; peripheral vasodilators; peripherally acting antiobesity agents; phenothiazine antiemetics; phenothiazine antipsychotics; phenylpiperazine antidepressants; plasma expanders; platelet aggregation inhibitors; platelet-stimulating agents; polyenes; potassium-sparing diuretics; probiotics; progesterone receptor modulators; progestins; prolactin inhibitors; prostaglandin D2 antagonists; protease inhibitors; proton pump inhibitors; psoralens; psychotherapeutic agents; psychotherapeutic combinations; purine nucleosides; pyrrolidine anticonvulsants; quinolones; radiocontrast agents; radiologic adjuncts; radiologic agents; radiologic conjugating agents; radiopharmaceuticals; RANK ligand inhibitors; recombinant human erythropoietins; renin inhibitors; respiratory agents; respiratory inhalant products; rifamycin derivatives; salicylates; sclerosing agents; second generation cephalosporins; selective estrogen receptor modulators; selective serotonin reuptake inhibitors; serotonin-norepinephrine reuptake inhibitors; serotoninergic neuroenteric modulators; sex hormone combinations; sex hormones; skeletal muscle relaxant combinations; skeletal muscle relaxants; smoking cessation agents; somatostatin and somatostatin analogs; spermicides; statins; sterile irrigating solutions; streptomyces derivatives; succinimide anticonvulsants; sulfonamides; sulfonylureas; synthetic ovulation stimulants; tetracyclic antidepressants; tetracyclines; therapeutic radiopharmaceuticals; thiazide diuretics; thiazolidinediones; thioxanthenes; third generation cephalosporins; thrombin inhibitors; thrombolytics; thyroid drugs; tocolytic agents; topical acne agents; topical agents; topical anesthetics; topical anti-infectives; topical antibiotics; topical antifungals; topical antihistamines; topical antipsoriatics; topical antivirals; topical astringents; topical debriding agents; topical depigmenting agents; topical emollients; topical keratolytics; topical steroids; topical steroids with anti-infectives; toxoids; triazine anticonvulsants; tricyclic antidepressants; trifunctional monoclonal antibodies; tumor necrosis factor (TNF) inhibitors; tyrosine kinase inhibitors; ultrasound contrast media; upper respiratory combinations; urea anticonvulsants; urinary anti-infectives; urinary antispasmodics; urinary pH modifiers; uterotonic agents; vaccine; vaccine combinations; vaginal anti-infectives; vaginal preparations; vasodilators; vasopressin antagonists; vasopressors; VEGF/VEGFR inhibitors; viral vaccines; viscosupplementation agents; vitamin and mineral combinations; vitamins; protein-based vaccines; DNA-based vaccines; mRNA-based vaccines;

### Diagnostic Tests

17-Hydroxyprogesterone; ACE (Angiotensin I converting enzyme); Acetaminophen; Acid phosphatase; ACTH; Activated clotting time; Activated protein C resistance; Adrenocorticotropic hormone (ACTH); Alanine aminotransferase (ALT); Albumin; Aldolase; Aldosterone; Alkaline phosphatase; Alkaline phosphatase (ALP); Alpha1—antitrypsin; Alpha-fetoprotein; Alpha-fetoprotien; Ammonia levels; Amylase; ANA (antinuclear antbodies); ANA (antinuclear antibodies); Angiotensin-converting enzyme (ACE); Anion gap; Anticardiolipin antibody; Anticardiolipin antivbodies (ACA); Anti-centromere antibody; Antidiuretic hormone; Anti-DNA; Anti-Dnase-B; Anti-Gliadin antibody; Anti-glomerular basement membrane antibody; Anti-HBc (Hepatitis B core antibodies; Anti-HBs (Hepatitis B surface antibody; Antiphospholipid antibody; Anti-RNA polymerase; Anti-Smith (Sm) antibodies; Anti-Smooth Muscle antibody; Antistreptolysin O (ASO); Antithrombin III; Anti-Xa activity; Anti-Xa assay; Apolipoproteins; Arsenic; Aspartate aminotransferase (AST); B12; Basophil; Beta-2-Microglobulin; Beta-hydroxybutyrate; B-HCG; Bilirubin; Bilirubin, direct; Bilirubin, indirect; Bilirubin, total; Bleeding time; Blood gases (arterial); Blood urea nitrogen (BUN); BUN; BUN (blood urea nitrogen); CA 125; CA 15-3; CA 19-9; Calcitonin; Calcium; Calcium (ionized); Carbon monoxide (CO); Carcinoembryonic antigen (CEA); CBC; CEA; CEA (carcinoembryonic antigen); Ceruloplasmin; CH50Chloride; Cholesterol; Cholesterol, HDL; Clot lysis time; Clot retraction time; CMP; CO2; Cold agglutinins; Complement C3; Copper; Corticotrophin releasing hormone (CRH) stimulation test; Cortisol; Cortrosyn stimulation test; C-peptide; CPK (Total); CPK-MB; C-reactive protein; Creatinine; Creatinine kinase (CK); Cryoglobulins; DAT (Direct antiglobulin test); D-Dimer; Dexamethasone suppression test; DHEA-S; Dilute Russell viper venom; Elliptocytes; Eosinophil; Erythrocyte sedimentation rate (ESR); Estradiol; Estriol; Ethanol; Ethylene glycol; Euglobulin lysis; Factor V Leiden; Factor VIII inhibitor; Factor VIII level; Ferritin; Fibrin split products; Fibrinogen; Folate; Folate (serum; Fractional excretion of sodium (FENA); FSH (follicle stimulating factor); FTA-ABS; Gamma glutamyl transferase (GGT); Gastrin; GGTP (Gamma glutamyl transferase); Glucose; Growth hormone; Haptoglobin; HBeAg (Hepatitis Be antigen); HBs-Ag (Hepatitis B surface antigen); Helicobacter pylori; Hematocrit; Hematocrit (HCT); Hemoglobin; Hemoglobin AlC; Hemoglobin electrophoresis; Hepatitis A antibodies; Hepatitis C antibodies; IAT (Indirect antiglobulin test); Immunofixation (IFE); Iron; Lactate dehydrogenase (LDH); Lactic acid (lactate); LDH; LH (Leutinizing hormone; Lipase; Lupus anticoagulant; Lymphocyte; Magnesium; MCH (mean corpuscular hemoglobin; MCHC (mean corpuscular hemoglobin concentration); MCV (mean corpuscular volume); Methylmalonate; Monocyte; MPV (mean platelet volume); Myoglobin; Neutrophil; Parathyroid hormone (PTH); Phosphorus; Platelets (pit); Potassium; Prealbumin; Prolactin; Prostate specific antigen (PSA); Protein C; Protein S; PSA (prostate specific antigen); PT (Prothrombin time); PTT (Partial thromboplastin time); RDW (red cell distribution width); Renin; Rennin; Reticulocyte count; reticulocytes; Rheumatoid factor (RF); Sed Rate; Serum glutamic-pyruvic transaminase (SGPT; Serum protein electrophoresis (SPEP); Sodium; T3-resin uptake (T3RU); T4, Free; Thrombin time; Thyroid stimulating hormone (TSH); Thyroxine (T4); Total iron binding capacity (TIBC); Total protein; Transferrin; Transferrin saturation; Triglyceride (TG); Troponin; Uric acid; Vitamin B12; White blood cells (WBC); Widal test.

A plurality of pharmaceutical packages of any embodiment, in which the wave-shifting crystals in a first package or first plurality of packages has a first optical property when interrogated and the wave-shifting crystals in a second package or second plurality of packages has a second optical property when interrogated, the second optical property being different from the first optical property such that the first package or plurality of packages and the second package or plurality of packages can be distinguished from one another.

The plurality of pharmaceutical packages of any embodiment, in which the wave-shifting crystals in a third package or third plurality of packages has a third optical property when interrogated, the third optical property being different from the first optical property and the second optical property such that the third package or plurality of packages can be distinguished from the first and second package or plurality of packages.

The plurality of pharmaceutical packages of any embodiment, in which the wave-shifting crystals in a fourth package or fourth plurality of packages has a fourth optical property when interrogated, the fourth optical property being different from the first optical property, the second optical property, and the third optical property such that the fourth package or plurality of packages can be distinguished from the first, second, and third package or plurality of packages.

The plurality of pharmaceutical packages of any embodiment, in which the wave-shifting crystals in a fifth package or fifth plurality of packages has a fifth optical property when interrogated, the fifth optical property being different from the first, second, third, and fourth optical property such that the fifth package or plurality of packages can be distinguished from the first, second, third, and fourth package or plurality of packages.

The plurality of pharmaceutical packages of any embodiment, in which the first and second; optionally the first, second, and third; optionally the first, second, third, and fourth; optionally the first, second, third, fourth, and fifth optical properties is each associated with a nation or region of the world.

The plurality of pharmaceutical packages of any embodiment, in which the wave-shifting crystals in each of the first and second; optionally the first, second, and third; optionally the first, second, third, and fourth; optionally the first, second, third, fourth, and fifth packages or plurality of packages can be interrogated and the emission read by a smartphone, such that the associated packages or plurality of packages can be distinguished by the smartphone.

The plurality of pharmaceutical packages of any embodiment, wherein each of the wave-shifting crystals is a rare earth doped nanoparticle crystal.

The plurality of pharmaceutical packages of any embodiment, wherein a lattice for each rare earth doped nanoparticle crystal comprises NaYF₄.

The plurality of pharmaceutical packages of any embodiment, wherein a dopant for each rare earth doped nanoparticle comprises Yb and a second rare earth element.

The pharmaceutical package of any embodiment, wherein a dopant for each rare earth doped nanoparticle comprises one of the following combinations: Er and Yb; Tm and Yb, Nd and Yb, Ho and Yb, or Pr and Yb.

The plurality of pharmaceutical packages of any embodiment, in which each of the first and second; optionally each of the first, second, and third; optionally each of the first, second, third, and fourth; optionally each of the first, second, third, fourth, and fifth optical properties is selected from one of the following: a wavelength of an emission; a size (i.e., dimensions) of an emission; a power or intensity of an emission; a rise time of an emission; a decay time of an emission; a wavelength and/or source of excitation light; or any combination thereof.

Embodiments of the present disclosure are directed to a vessel configured to contain a pharmaceutical solution within a lumen thereof and to be authenticated and/or traced by way of producing a light emission having one or more predetermined characteristics, comprising a vessel defining a lumen, in which the vessel comprises wave-shifting crystals, optionally in which the wave-shifting crystals are rare earth doped crystals, optionally in which the wave-shifting crystals are nanoparticle crystals, optionally in which the wave-shifting crystals are rare earth doped nanoparticle crystals, configured to emit light having one or more characteristics by which the package may be identified.

The vessel of any embodiment, in which the wave-shifting crystals are nanoparticle crystals.

The vessel of any embodiment, in which the wave-shifting crystals are rare earth doped crystals.

The vessel of any embodiment, in which the wave-shifting crystals are rare earth doped nanoparticle crystals.

The vessel of any embodiment, wherein the vessel is a syringe barrel, a cartridge, a vial, or a blister pack.

The vessel of any embodiment, wherein the wave-shifting crystals are incorporated into a wall of the vessel.

The vessel of any embodiment, wherein the vessel comprises at least one wall made of a thermoplastic material. The vessel of any embodiment, wherein the thermoplastic material comprises one or more of the following: polypropylene, polyethylene, COP, COC, or CBC.

The vessel of any embodiment, in which the wave-shifting crystals are embedded in the at least one wall made of a thermoplastic material.

The vessel of any embodiment, in which the wave-shifting crystals do not refract light.

The vessel of any embodiment, in which the wall containing the wave-shifting crystals is transparent. The vessel of any embodiment, in which the wall containing the wave-shifting crystals, optionally wave-shifting nanoparticle crystals, optionally rare earth doped nanoparticle crystals has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The vessel of any embodiment, wherein the vessel is blow molded, optionally injection stretch blow molded, from a preform comprising a thermoplastic resin that contains the wave-shifting crystals.

The vessel of any embodiment, in which the vessel is a vial, optionally a 2 ml vial, a 6 ml vial, a 10 ml vial, or a 20 ml vial (fill volume).

The vessel of any embodiment, wherein the vessel is injection molded from a thermoplastic resin that contains the wave-shifting crystals.

The vessel of any embodiment, in which the vessel is a syringe barrel.

The vessel of any embodiment, in which the wave-shifting crystals have dimensions/diameters 10 microns or less, alternatively 8 microns or less, alternatively 5 microns or less, alternatively 2 microns or less, alternatively 1 micron or less, alternatively 800 nm or less, alternatively 600 nm or less, alternatively 500 nm or less, alternatively 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.

The vessel of any preceding embodiment, in which the wave-shifting crystals are present in the wall of the vessel in an amount of about 1000 ppm or less, alternatively about 750 ppm or less, alternatively about 500 ppm or less, alternatively about 250 ppm or less, alternatively about 100 ppm or less, alternatively about 50 ppm or less, alternatively about 40 ppm or less, alternatively about 30 ppm or less, alternatively about 25 ppm or less, alternatively about 20 ppm or less, alternatively about 15 ppm or less, alternatively about 10 ppm or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The vessel of any embodiment, in which the wave-shifting crystals do not leach from the vessel wall.

The vessel of any embodiment, in which at least a portion of the thermoplastic vessel wall comprises two or more layers, wherein at least one of the two or more layers is free of the wave-shifting crystals and at least one of the two or more layers contains the wave-shifting crystals.

The vessel of any embodiment, in which at least a portion of the thermoplastic wall includes an in-mold label or component containing the wave-shifting crystals.

The vessel of any embodiment, in which the wave-shifting crystals are configured and present in an amount sufficient such that, when excited, the emission is detectable/readable by a mobile reader.

The vessel of any embodiment, wherein the vessel comprises one or more non-transparent areas and wherein the wave-shifting crystals are present in at least one of the non-transparent areas.

The vessel of any embodiment, wherein the vessel is a vial and a base of the vial comprises the non-transparent area in which the wave-shifting crystals are present.

The vessel of any embodiment, wherein the vessel is a syringe barrel and a flange of the syringe barrel comprises the non-transparent area in which the wave-shifting crystals are present.

The vessel of any embodiment, wherein the vessel is a vial and the closure comprises a seal, optionally a flip-off seal, that is the non-transparent area in which the wave-shifting crystals are present.

The vessel of any embodiment, wherein the vessel is a syringe barrel and the vessel further comprises a plunger rod that is the non-transparent area in which the wave-shifting crystals are present and/or a needle shield or tip cap that is the non-transparent area in which the wave-shifting crystals are present.

The vessel of any embodiment, in which the wave-shifting crystals are applied to or embedded in at least one of the non-transparent areas.

The vessel of any embodiment, in which the wave-shifting crystals are blended into a thermoplastic material that makes up at least a portion of the non-transparent area.

The vessel of any embodiment, in which the wave-shifting crystals are blended into an ink and applied to a portion of the vessel to produce the non-transparent area.

The vessel of any embodiment, wherein the one or more non-transparent areas comprise text, a scannable code, or a geometric shape, optionally in which the scannable code is a bar code or QR code.

The vessel of any embodiment, wherein the one or more non-transparent areas are channels or recesses burned into the vessel wall by a laser. The vessel of any embodiment, wherein the wave-shifting crystals are applied to or embedded in the channels or recesses.

The vessel of any embodiment, wherein the one or more non-transparent areas are embossed on the vessel, optionally wherein the vessel is a vial and the one or more non-transparent areas are embossed on a base of the vial.

The vessel of any embodiment, wherein the one or more non-transparent areas provide sufficient contrast with the transparent vessel wall to be detected by the human eye, a camera of a smartphone or tablet, or a conventional scanner.

The vessel of any embodiment, wherein the one or more non-transparent areas are gray-scale or black.

The vessel of any embodiment, wherein the scannable code and the wave-shifting crystals are configured to be interrogated by a smart phone or tablet and capable of being detected by a camera of the smart phone or tablet.

The vessel of any embodiment, wherein the wave-shifting crystals have diameters less than 500 microns, optionally between about 1-500 microns, optionally from about 10-500 microns, optionally from about 50-500 microns, optionally from about 100-500 microns, optionally from about 1-200 microns, optionally from about 10-200 microns, optionally from about 50-200 microns, optionally from about 50-100 microns.

The vessel of any embodiment, wherein the vessel comprises at least one wall made of glass, optionally borosilicate glass or aluminosilicate glass, optionally borosilicate glass, optionally Type 1 borosilicate glass, optionally aluminosilicate glass, optionally Type 1 aluminosilicate glass. The vessel of any embodiment, in which the wave-shifting crystals are embedded in the at least one wall made of glass.

The vessel of any embodiment, in which the wall of the vessel in which the wave-shifting crystals are incorporated is transparent.

The vessel of any embodiment, further comprising a coating on at least a portion of at least one wall of the vessel.

The vessel of any embodiment, in which the coating is present on an interior surface of the at least one wall. The vessel of any embodiment, in which the coating is present on an exterior surface of the at least one wall.

The vessel of any embodiment, in which the coating is configured to provide the vessel with improved gas barrier properties.

The vessel of any embodiment, in which the coating is configured to provide the interior surface of the at least one wall with improved lubricity properties.

The vessel of any embodiment, in which the coating is applied by chemical vapor deposition (CVD) or atomic layer deposition (ALD), optionally CVD, optionally ALD.

The vessel of any embodiment, in which the coating comprises one or more layers having the composition Si_{w}OₓC_{y} or Si_{w}NₓC_{y}, where w is 1, x is from about 0.5 to 2.4, and y is from about 0.6 to about 3, as determined by XPS.

The vessel of any embodiment, in which the coating comprises one or more layers having the composition SiOₓ, wherein x is from 1.5 to 2.9.

The vessel of any embodiment, in which the coating comprises one or more metal oxide layers, optionally one or more metal oxide layers having the composition Al2O3, AlxTiyOz, HfO2, In2O3, MgO, SiO2, SrTiOx, Ta2O5, TiO2, Y2O3, ZnO, ZnO:Al, ZrO2, La2O3, or CeO2, optionally one or more metal oxide layers having the composition Al2O3.

The vessel of any embodiment, in which the coating is applied by wet solution deposition.

The vessel of any embodiment, in which the wave-shifting crystals are incorporated into the coating.

The vessel of any embodiment, in which the at least one wall of the vessel having the coating in which the wave-shifting crystals are incorporated is transparent. The vessel of any embodiment, in which the wall having the coating in which the wave-shifting crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The vessel of any embodiment, in which the wave-shifting crystals are present in the coating in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The vessel of any embodiment, in which the wave-shifting crystals are present in an ink, and at least a portion of a vessel wall comprises the ink.

The vessel of any embodiment, in which the ink is applied to an exterior wall of the vessel.

The vessel of any embodiment, in which the ink is transparent. The vessel of any embodiment, in which the wall having the ink in which the wave-shifting crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The vessel of any embodiment, in which the ink is holographic.

The vessel of any embodiment, in which the ink is applied to the at least a portion of the vessel in a predetermined pattern.

The vessel of any embodiment, in which the ink is applied in a scannable coded pattern, optionally a bar code or QR code.

The vessel of any embodiment in which the wave-shifting crystals are present in the ink in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The vessel of any embodiment, in which the coating or ink is applied to the vessel by inkjet or pad printing.

The vessel of any embodiment, in which the wave-shifting crystals are present in a label, optionally an adhesive label, and at least a portion of the vessel or closure comprises the label.

The vessel of any embodiment, in which the label is adhered to an exterior wall of the vessel.

The vessel of any embodiment, in which the label is transparent. The vessel of any embodiment, in which the wall having the label in which the wave-shifting crystals are present has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

The vessel of any embodiment, in which at least a portion of the label is holographic.

The vessel of any embodiment, in which the wave-shifting crystals are present in at least a portion of the label in a predetermined pattern.

The vessel of any embodiment, in which the wave-shifting crystals are present in the label in a scannable coded pattern, optionally a bar code or QR code.

The vessel of any embodiment, in which the wave-shifting crystals are present in a portion of the label in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The vessel of any embodiment, wherein a portion of the vessel or closure is etched, optionally laser etched, to produce a recess and the wave-shifting crystals are incorporated into at least a portion of a recess.

The vessel of any embodiment, wherein etching forms a recess having a predetermined pattern. The vessel of any embodiment, in which the predetermined pattern comprises a scannable coded pattern, optionally a bar code or QR code.

The vessel of any embodiment, in which a polymeric resin comprising the wave-shifting crystals is positioned in the recess. The vessel of any embodiment, in which the polymeric resin comprises an epoxy; optionally in which the polymeric resin is an epoxy.

The vessel of any embodiment, in which the vessel is a vial and the recess is located on a base of the vial.

The vessel of any embodiment, in which the vessel is a syringe barrel and the recess is located on a flange of the syringe barrel.

The vessel of any embodiment, in which the wave-shifting crystals are present in the polymeric resin in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

The vessel of any embodiment, in which the wave-shifting crystals are luminescent.

The vessel of any embodiment, in which the wave-shifting crystals are configured/tuned to react to one or more specific wavelengths of light.

The vessel of any embodiment, in which the wave-shifting crystals are configured/tuned to luminesce in response to light having a wavelength within the ultraviolet spectrum, light having a wavelength within the visible spectrum, light having a wavelength within the infrared spectrum, or any combination thereof.

The vessel of any embodiment, in which the wave-shifting crystals are configured/tuned to luminesce solely in response to light having a wavelength within the ultraviolet spectrum.

The vessel of any embodiment, in which the wave-shifting crystals are configured/tuned to luminesce solely in response to light having a wavelength within the visible spectrum.

The vessel of any embodiment, in which the wave-shifting crystals are configured/tuned to luminesce solely in response to light having a wavelength within the infrared spectrum.

The vessel of any embodiment, in which the wave-shifting crystals are configured/tuned to luminesce only in response to light having a wavelength within a defined wavelength range.

The vessel of any embodiment, in which the wave-shifting crystals are cathodoluminescent.

The vessel of any embodiment, in which the wave-shifting crystals are down-converting phosphors.

The vessel of any embodiment, in which the wave-shifting crystals are up-converting phosphors.

The vessel of any embodiment, in which the wave-shifting crystals are configured/tuned to produce an emission in one or more defined emission wavelength bands/ranges.

The vessel of any embodiment, in which the wave-shifting crystals are configured/tuned to have a defined rise time, decay time, or both.

The vessel of any embodiment, in which the wave-shifting crystals are configured/tuned to produce an emission having an intensity within a defined range.

The vessel of any embodiment, in which the wave-shifting crystals are configured/tuned to produce an emission having dimensions within a defined range.

The vessel of any embodiment, in which the wave-shifting crystals are configured and present in an amount sufficient such that their luminescence is detectable by a hand-held authentication device, an industrial authentication device, optionally a mobile authentication device, optionally a smartphone or similar device, or a combination of devices. The vessel of any embodiment, in which the authentication device interrogates the vessel using one or more discrete wavelengths.

The vessel of any embodiment, in which the wave-shifting crystals have diameters between about 10 nm and about 1,500 nm, alternatively between about 10 nm and about 1,000 nm, alternatively between about 10 nm and about 500 nm, alternatively between about 10 nm and about 250 nm, alternatively between about 10 nm and about 100 nm, alternatively between about 10 nm and about 50 nm, alternatively between about 100 and 1,500 nm, alternatively between about 100 and 1,000 nm, alternatively between about 200 and 1,500 nm, alternatively between about 200 and about 1,000 nm.

The vessel of any embodiment, in which the wave-shifting crystals have dimensions/diameters 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.

The vessel of any embodiment, in which the wave-shifting crystals are nanoparticle crystals.

The vessel of any embodiment, in which the wave-shifting crystals are rare earth doped crystals.

The vessel of any embodiment, in which the wave-shifting crystals are rare earth doped nanoparticle crystals.

The vessel of any embodiment, in which the rare earth doped crystals, optionally rare earth doped nanoparticles, comprise a rare earth element-containing lattice and a dopant.

The vessel of any embodiment, in which the dopant comprises a rare earth element, and wherein the rare earth element-containing lattice contains a first rare earth element and the dopant comprises a second rare earth element, whereby the second rare earth element differs from the first rare earth element.

The vessel of any embodiment, in which the first rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.

The vessel of any embodiment, in which the second rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.

The vessel of any embodiment, in which the dopant comprises two or more different rare earth elements.

The vessel of any embodiment, wherein the lattice comprises NaYF₄.

The vessel of any embodiment, wherein the dopant comprises Yb and a second rare earth element.

The vessel of any embodiment, wherein the dopant comprises one of the following combinations: Er and Yb; Tm and Yb, Nd and Yb, Ho and Yb, or Pr and Yb.

The vessel of any embodiment, in which the rare earth doped crystals, optionally rare earth doped nanoparticles, comprise a lattice and one or more rare earth element dopants.

The vessel of any embodiment, in which the lattice comprises NaLiF.

The vessel of any embodiment, in which the dopant comprises Nd or Pr.

The vessel of any embodiment, in which the lattice comprises Y2O3.

The vessel of any embodiment, in which the the dopant comprises Er and Yb.

The vessel of any embodiment, in which the lattice comprises Gd, optionally Gd₂SO₂ or Gd₂O₃.

The vessel of any embodiment, in which the wave-shifting crystal comprises one or more of Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er.

The vessel of any embodiment in which the rare earth doped crystals have a polyhedral morphology.

The vessel of any embodiment, in which the rare earth doped crystals have a uniform or substantially uniform morphology.

The vessel of any embodiment, in which the wave-shifting crystals are configured to produce an emission in response to interrogation by a device, optionally a smartphone, having an infrared (IR) illuminator, a VCSEL, an LED light, or a combination thereof.

The vessel of any embodiment, in which the wave-shifting crystals are configured and present in an amount to produce an emission that is readable by a device, optionally a smartphone, having a CMOS sensor or CMOS camera.

The vessel of any embodiment, in which the wave-shifting crystals are of a uniform or substantially uniform size, in which substantially uniform means within a tolerance of about 10 nm or less.

The vessel of any embodiment, wherein the vessel is a vial and wherein the wave-shifting crystals are present in or on the bottom wall of the vial.

The vessel of any embodiment, wherein the vessel has been subjected to sterilization, optionally sterilization by irradiation, optionally sterilization by gas. The vessel of any embodiment, wherein the wave-shifting crystals are configured to withstand sterilization of the vessel, optionally sterilization by irradiation, optionally sterilization by gas.

The vessel of any embodiment, wherein the vessel has been subjected to autoclaving at a temperature of 120° C. or higher. The vessel of any embodiment, wherein the wave-shifting crystals are configured to withstand autoclaving at a temperature of 120° C. or higher.

The vessel of any embodiment, wherein the wave-shifting crystals are configured to operate as a temperature indicator, a pressure sensor, or both.

Embodiments of the present disclosure are directed to methods of authenticating and/or tracing a pharmaceutical package or vessel, the method comprising providing a pharmaceutical package or vessel according to any embodiment described herein; interrogating the package or vessel to determine if the wave-shifting crystals, optionally wave-shifting nanoparticle crystals, optionally wave-shifting rare earth crystals, optionally wave-shifting rare earth doped nanoparticle crystals have one or more predetermined luminescence characteristics; and identifying the package based on the results of the interrogation.

The method of any embodiment, wherein the one or more predetermined luminescence characteristics comprises emission within one or more defined wavelength bands, emission having a defined rise time, emission having a defined decay time, emission having a defined intensity at a given time, emission in a defined spatial pattern, or any combination thereof.

The method of any embodiment, wherein the step of interrogating comprises applying light having one or more discrete wavelengths to the pharmaceutical package or vessel to excite the wave-shifting crystals, and detecting one or more luminescence characteristics of the light emitted by the wave-shifting crystals.

The method of any embodiment, wherein the one or more discrete wavelengths are selected from one or more wavelengths within the ultraviolet spectrum, one or more wavelengths within the visible spectrum, one or more wavelengths within the infrared spectrum, or any combination thereof. The method of any embodiment, wherein the one or more discrete wavelengths are selected from one or more wavelengths within the ultraviolet spectrum. The method of any embodiment, wherein the one or more discrete wavelengths are selected from one or more wavelengths within the visible spectrum. The method of any embodiment, wherein the one or more discrete wavelengths are selected from one or more wavelengths within the infrared spectrum.

The method of any embodiment, wherein the applying is performed by a hand-held device, optionally wherein the pharmaceutical package is a cartridge and the hand-held device is an auto-injector or injection pen.

The method of any embodiment, wherein the detecting is also performed by the hand-held device, optionally wherein the pharmaceutical package is a cartridge and the hand-held device is an auto-injector or injection pen.

The method of any embodiment, wherein the light emitted by the wave-shifting crystals has one or more discrete wavelengths selected from one or more wavelengths within the ultraviolet spectrum, one or more wavelengths within the visible spectrum, one or more wavelengths within the infrared spectrum, or any combination thereof. The method of any embodiment, wherein the light emitted by the wave-shifting crystals has one or more discrete wavelengths within the ultraviolet spectrum. The method of any embodiment, wherein the light emitted by the wave-shifting crystals has one or more discrete wavelengths within the visible spectrum. The method of any embodiment, wherein the light emitted by the wave-shifting crystals has one or more discrete wavelengths within the infrared spectrum.

The method of any embodiment, wherein applying the activating light and detecting the emitted light are performed by the same device.

The method of any embodiment, wherein the step of interrogating the package is performed using a smart phone or tablet computer.

Embodiments of the present disclosure are directed to methods for preparing a pharmaceutical package or vessel according to any of the embodiments described herein, the method comprising injecting a thermoplastic material comprising the wave-shifting crystals into a mold to form the vessel or at least a portion of the vessel.

Embodiments of the present disclosure are directed to methods for preparing a pharmaceutical package or vessel according to any of the embodiments described herein, the method comprising injecting a thermoplastic material comprising the wave-shifting crystals into a mold to form a preform, and blow molding or stretch blow molding the preform to form the vessel or at least a portion of the vessel.

Embodiments of the present disclosure are directed to methods for preparing a pharmaceutical package or vessel according to any of the embodiments described herein, the method comprising coating at least one wall of the vessel with a coating material comprising the wave-shifting crystals.

Embodiments of the present disclosure are directed to methods for preparing a pharmaceutical package or vessel according to any one of the embodiments described herein, the method comprising burning channels or recesses in the vessel wall with a laser, thereby forming one or more non-transparent areas; and coating at least one of the one or more non-transparent areas with a coating material comprising the wave-shifting crystals.

The method of any embodiment, wherein the coating is performed by CVD, ALD, or wet solution deposition, optionally wherein the coating is performed by CVD, optionally wherein the coating is performed by ALD, optionally wherein the coating is performed by wet solution deposition.

Embodiments of the present disclosure are directed to methods for preparing a pharmaceutical package or vessel according to any of the embodiments described herein, the method comprising applying an ink comprising the wave-shifting crystals to at least a portion of the vessel, optionally to an exterior wall of the vessel. The method of any embodiment, wherein the ink is applied to at least a portion of the vessel using an ink jet printer.

Embodiments of the present disclosure are directed to methods for preparing a pharmaceutical package or vessel according to any of the embodiments described herein, the method comprising applying a label comprising the wave-shifting crystals, to at least a portion of the vessel, optionally to an exterior wall of the vessel.

The method of any embodiment, further comprising, prior to filling the vessel with the pharmaceutical solution, inspecting the vessel to ensure the presence of the wave-shifting crystals, that the positioning of the wave-shifting crystals on the vessel is correct, that the light emitted by the wave-shifting crystals has one or more predetermined emission characteristics, or any combination thereof.

The method of any embodiment, wherein the one or more predetermined luminescence characteristics comprises: emission within one or more defined wavelength bands, emission having a defined rise time, emission having a defined decay time, emission having a defined intensity at a given time, emission in a defined spatial pattern, or any combination thereof.

The method of any embodiment, further comprising filling the lumen with the pharmaceutical solution and sealing the lumen with the closure.

Embodiments of the present disclosure are directed to a shipping case containing a plurality of pharmaceutical packages, comprising: a container comprising a bottom wall, one or more and optionally a plurality of side walls, and a top wall; a plurality of pharmaceutical packages, each of which contains a pharmaceutical formulation; and a tag configured to transmit data that includes the location of the shipping case, the temperature of the shipping case, or both.

The shipping case of any embodiment, wherein the tag is configured to transmit both the location and the temperature of the shipping case.

The shipping case of any embodiment, wherein the tag includes a power source, such as a battery. The shipping case of any embodiment, wherein the power source has an operating lifetime of at least one year, optionally at least two years, optionally at least three years, optionally at least four years, optionally at least five years.

The shipping case of any embodiment, wherein the tag is configured to transmit data by satellite network, Wi-Fi network, cellular phone network, short-range wireless technology (e.g. Bluetooth), or any combination thereof.

The shipping case of any embodiment, wherein the tag comprises a GPS or A-GPS element.

The shipping case of any embodiment, wherein the tag comprises a temperature sensor.

The shipping case of any embodiment, wherein the tag is configured to transmit the location data, the temperature data, or both at defined intervals.

The shipping case of any embodiment, wherein the tag is configured to transmit the location data, the temperature data, or both at least once per day, optionally at least once per 12 hours, optionally at least once per 8 hours, optionally at least once per 4 hours, optionally at least once per 2 hours, optionally at least once per hour.

The shipping case of any embodiment, wherein the tag is configured to transmit at least the location data any time the location of the shipping case changes.

The shipping case of any embodiment, wherein the tag is configured to transmit at least the temperature data any time the temperature of the shipping case changes.

The shipping case of any embodiment, wherein the tag is configured to transmit at least the temperature data if the temperature exceeds a predefined threshold value. The shipping case of any embodiment, wherein the predefined threshold value comprises an upper limit of permissible shelf-life temperatures for the pharmaceutical formulation, a lower limit of permissible shelf-life temperatures for the pharmaceutical formulation, or both.

The shipping case of any embodiment, wherein the location data, the temperature data, or both is available via mobile application installed on a laptop computer, tablet computer, or smartphone.

The shipping case of any embodiment, wherein the tag has a thickness less than 20 mm, optionally less than 15 mm, optionally less than 12 mm, optionally less than 10 mm, optionally less than 7 mm, optionally less than 5 mm, optionally less than 3 mm.

The shipping case of any embodiment, wherein the tag has a length dimension less than 25 mm, optionally less than 20 mm, optionally less than 15 mm, optionally less than 10 mm; and a width dimension less than 25 mm, optionally less than 20 mm, optionally less than 15 mm, optionally less than 10 mm.

The shipping case of any embodiment, wherein the tag has a weight less than 5 grams, optionally less than 4 grams, optionally less than 3 grams, optionally less than 2 grams.

The shipping case of any embodiment, wherein the tag is operable at temperatures as low as −20° C., optionally as low as −30° C., optionally as low as −40° C., optionally as low as −50° C., optionally as low as −60° C., optionally as low as −70° C.

The shipping case of any embodiment, wherein the pharmaceutical packages comprise vials or syringes, each of which contains an injectable pharmaceutical formulation.

The shipping case of any embodiment, wherein the pharmaceutical packages comprise one or more wave-shifting crystal-containing pharmaceutical packages of any of the embodiments described herein.

The shipping case of any embodiment, wherein the plurality of pharmaceutical packages comprises between about 200 and about 500 pharmaceutical packages.

The shipping case of any embodiment, wherein the pharmaceutical packages are contained in a plurality of boxes.

The shipping case of any embodiment, wherein the container holds the plurality of the boxes and wherein each of the boxes holds a portion of the plurality of pharmaceutical packages.

The shipping case of any embodiment, where each of the boxes holds between 20 and 40 pharmaceutical packages. The shipping case of any embodiment, wherein the container holds between 10 and 20 boxes.

The shipping case of any embodiment, wherein the top wall is removable, e.g. a removable cover.

The shipping case of any embodiment, wherein the top wall comprises a plurality of portions, each of which is hinged to the upper end of one of the plurality of sidewalls.

The shipping case of any embodiment, wherein the container is corrugated fiberboard. The shipping case of any embodiment, wherein the corrugated fiberboard has a coating that reduces particle attraction.

The shipping case of any embodiment, wherein the container is corrugated plastic.

The shipping case of any embodiment, wherein the container is a polymer-fiber composite.

The shipping case of any embodiment, wherein the tag is held within the container, optionally where the tag is held within the container beneath one or more of the plurality of boxes.

The shipping case of any embodiment, wherein the tag is contained by a pouch.

The shipping case of any embodiment, wherein the tag or pouch is affixed to an interior surface of the container.

The shipping case of any embodiment, where the tag or pouch is affixed to an interior surface of the container by a tamper-evident mechanism.

The shipping case of any embodiment, wherein the tag or pouch is affixed to an interior surface of the container by an adhesive label.

The shipping case of any embodiment, wherein an interior wall of the container comprises a pocket or recess in which the tag or pouch is positioned.

The shipping case of any embodiment, wherein the tag or pouch is integrated into the container. The shipping case of any embodiment, wherein the tag or pouch is integrated into the bottom wall, one of the plurality of sidewalls, or the top wall of the container.

The shipping case of any embodiment, wherein the tag or pouch is positioned between a first linerboard and a second linerboard of a corrugated fiberboard.

The shipping case of any embodiment, wherein the tag or pouch is positioned in a recess in the corrugated board.

The shipping case of any embodiment, wherein the shipping case is configured so that the tag is not visible when the container is closed.

The shipping case of any embodiment, wherein the shipping case is configured so that the tag is not visible when the container is opened.

The shipping case of any embodiment, wherein the tag is affixed to the container by a tamper-evident element.

Embodiments of the present disclosure are directed to methods for tracking the location, temperature, or both of pharmaceutical packages, the method comprising providing a shipping case of any of the embodiments described herein and tracking (i) the location of the shipping case, (ii) the temperature of the shipping case, or (iii) both (i) and (ii), at one or more, and optionally numerous, times throughout the supply chain of the pharmaceutical packages.

The method of any embodiment, comprising tracking the temperature of the shipping case to determine whether the temperature exceeds a predefined threshold temperature. The method of any embodiment, wherein the predefined threshold temperature is an upper limit of permissible shelf-life temperatures for the pharmaceutical formulation.

The method of any embodiment, comprising tracking the location of the shipping case. The method of any embodiment, further comprising identifying whether the shipping case is diverted.

The method of any embodiment, wherein the tag transmits the location data, the temperature data, or both at defined intervals.

The method of any embodiment, wherein the tag transmits the location data, the temperature data, or both at least once per day, optionally at least once per 12 hours, optionally at least once per 8 hours, optionally at least once per 4 hours, optionally at least once per 2 hours, optionally at least once per hour.

The method of any embodiment, wherein the tag transmits at least the location data any time the location of the shipping case changes.

The method of any embodiment, wherein the tag transmits at least the location data if the location of the shipping case corresponds with one or more predefined areas.

The method of any embodiment, wherein the tag transmits at least the temperature data any time the temperature of the shipping case changes.

The method of any embodiment, wherein the tag transmits at least the temperature data if the temperature of the shipping case exceeds a predefined threshold value, optionally wherein the predefined threshold temperature is an upper limit of permissible shelf-life temperatures for the pharmaceutical formulation, a lower limit of permissible shelf-life temperatures for the pharmaceutical formulation, or both.

The method of any embodiment, wherein the tag transmits the data by satellite network, Wi-Fi network, cellular phone network, short-range wireless technology (e.g. Bluetooth), or any combination thereof.

The method of any embodiment, wherein the tracking is performed via mobile application installed on a laptop computer, tablet computer, or smartphone.

The method of any embodiment, wherein the tracking is performed via the Internet.

The method of any embodiment, wherein the tracking comprising real-time tracking.

The method of any embodiment, further comprising receiving an alert if the shipping case enters one or more predefined areas, leaves one or more predefined areas, or both.

The method of any embodiment, further comprising receiving an alert if the temperature of the shipping case exceeds a predefined threshold value, optionally wherein the predefined threshold value is an upper limit of permissible shelf-life temperatures for the pharmaceutical formulation, a lower limit of permissible shelf-life temperatures for the pharmaceutical formulation, or both.

The method of any embodiment, wherein the alert is received via mobile phone text message.

The method of any embodiment, further comprising maintaining the location data in a database so that a location history of the shipping case is available.

The method of any embodiment, wherein the tracking is performed by an intended recipient of the shipping case.

The method of any embodiment, wherein the tracking is performed by a sender of the shipping case.

The method of any embodiment, further comprising diverting the shipping case if it is found that the temperature exceeded the predefined threshold, optionally if it is found that the temperature exceeded the predefined threshold for a predefined period of time.

The method of any embodiment, further comprising diverting the shipping case in response to an identified location of the shipping case.

### BRIEF DESCRIPTION OF THE DRAWINGS

FIG. 1 is a bottom plan view of an embodiment of a vial having a base portion that includes both a laser-inscribed identifier and wave-shifting crystals incorporated into a portion of the base.

FIG. 2A is an example of a light map image of an emission profile of an embodiment of a vessel containing wave-shifting crystals incorporated therein or thereon, as detected by a CMOS camera.

FIG. 2B is the example of the detected light map shown in FIG. 2A, with a software-generated grid applied thereon.

FIG. 3 is a photograph of sample pharmaceutical vials molded from a thermoplastic resin containing varying amounts of wave-shifting crystals, as is described in Example 1B.

FIG. 4 is a photograph of a sample pharmaceutical vial having a sidewall printed with a machine-scannable code using an ink containing wave-shifting crystals, shown with the wave-shifting crystals being excited by a an interrogating light source.

FIG. 5 is a cross-sectional view of embodiments of syringes, showing both a Luer tip syringe that includes a tip cap that contains wave-shifting crystals in accordance with an embodiment disclosed herein and a staked needle syringe that includes a rigid needle shield that contains wave-shifting crystals in accordance with an embodiment disclosed herein.

### DETAILED DESCRIPTION

The present invention will now be described more fully, with reference to the accompanying drawings, in which several embodiments are shown. This invention can, however, be embodied in many different forms and should not be construed as limited to the embodiments set forth here. Rather, these embodiments are examples of the invention, which has the full scope indicated by the language of the claims. Like numbers refer to like or corresponding elements throughout. The following disclosure relates to all embodiments unless specifically limited to a certain embodiment.

Wave-shifting crystals produce specific optical properties when excited by light within a defined wavelength (e.g. infrared, visible, ultraviolet). When excited, the crystals may up-convert the light, down-convert the light, or emit light having a similar wavelength to that with which it was excited but with visually and/or measurably different characteristics. Because the wave-shifting crystals may be configured to be excited by a light having one or more particular characteristics and/or to emit a light having one or more particular characteristics when excited, they are used in embodiments of the present disclosure to authenticate and/or track pharmaceutical products, and in particular pharmaceutical products comprising an injectable agent. By applying a light within the defined wavelength to excite the wave-shifting crystals and examining the light emitted by the crystals, one may identify the crystals as being associated with a particular pharmaceutical package or a particular set of pharmaceutical packages.

Rare earth doped crystals are a type of wave-shifting crystal that may be particularly suitable for one or more of the applications described herein, as each crystal may be tailored to have unique optical properties which allow for the identification of individual packages, subsets of packages, etc., across a set made up of a large number of total packages without risk of misidentification due to shared or overlapping properties.

In some embodiments, wave-shifting crystals may be incorporated into (a) the polymer resin used to manufacture the pharmaceutical vessel (in the case of a plastic container) or the borosilicate or aluminosilicate glass used to manufacture the pharmaceutical vessel (in the case of a glass container), a closure for the pharmaceutical vessel, or any other part of the packaging (e.g. needle shield or tip cap, vial cap, blood tube cap, secondary packaging, etc.), (b) an ink or adhesive, e.g. label, that is applied to the exterior of the pharmaceutical vessel, to a closure for the pharmaceutical vessel, or to any other part of the packaging (e.g. needle shield or tip cap, vial cap, blood tube cap, secondary packaging, etc.), (c) a coating that is applied to the interior and/or exterior of the pharmaceutical vessel, to a closure for the pharmaceutical vessel, or to any other part of the packaging (e.g. needle shield or tip cap, vial cap, blood tube cap, secondary packaging, etc.), including for example a coating applied by chemical vapor deposition (CVD) or atomic layer deposition (ALD) and a coating applied by wet deposition methods such as spray coating, spin coating, dip coating, and the like, or (d) a polymeric resin which is incorporated into the pharmaceutical vessel, into a closure for the pharmaceutical vessel, or to any other part of the packaging (e.g. needle shield or tip cap, vial cap, blood tube cap, secondary packaging, etc.), for instance by etching a recess in the vessel, closure, etc. and filling that recess with the polymeric resin.

In some embodiments the wave-shifting crystals may have dimensions less than 20 microns, alternatively less than 15 microns, alternatively less than 10 microns, alternatively less than 8 microns, alternatively less than 6 microns, alternatively less than 5 microns. For instance the D99 of the crystals may be less than 20 microns, alternatively less than 15 microns, alternatively less than 12 microns, alternatively less than 10 microns, alternatively less than 8 microns, alternatively less than 6 microns, alternatively less than 5 microns.

The wave-shifting crystals may be nanoparticles. For instance, the wave-shifting crystals may have dimensions less than 1000 nm (1 micron), alternatively less than 800 nm, alternatively less than 600 nm, alternatively less than 500 nm, alternatively less than 400 nm, alternatively less than 300 nm, alternatively less than 200 nm, alternatively less than 100 nm, alternatively less than 75 nm, alternatively 50 nm or less. In some embodiments, for instance, the wave-shifting nanoparticles may have dimensions between about 3 nm and about 50 nm.

Many pharmaceutical vessels, e.g. vials, syringe barrels, etc., are required to be transparent. Transparency is determined by UV spectrometry, also known as UV-Vis Spectrophotometry, using a conventional UV/Vis Spectrophotometer. In many embodiments, it is therefore important that the wave-shifting crystals are sized and present in an amount that does not refract light. By using wave-shifting crystals having appropriate dimensions in appropriate amounts (the smaller the crystals, the higher the concentration may be incorporated before the transparency of the vessel wall is impacted), wave-shifting crystals may be incorporated into or onto a pharmaceutical vessel while maintaining transparency. In some embodiments, the wave-shifting crystals may have dimensions of 10 microns or less and may be incorporated into a vessel wall made of a transparent thermoplastic resin such as COP or COC at a concentration of about 25 ppm or less, alternatively about 20 ppm or less, alternatively about 15 ppm or less, alternatively about 12 ppm or less, alternatively about 10 ppm or less, alternatively 5 ppm or less. For instance, the wave-shifting crystals may have a D99 less than 10 microns (meaning that 99% of all particles have dimensions less than 10 microns) and/or a D50 of 2 microns (meaning that 50% of all particles have dimensions less than 2 microns) or less. In some embodiments, the wave-shifting crystals may have a D99 less than 10 microns and a D50 of 1 micron or less.

In some embodiments, for example, the portion of the vessel that contains the wave-shifting crystals may have at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

In some embodiments, the wave-shifting crystals may be present in the matrix material, e.g. polymer, at a concentration of at least 5 ppm, alternatively at least 10 ppm, alternatively at least 25 ppm, alternatively at least 50 ppm, alternatively at least 100 ppm, alternatively at least 200 ppm, alternatively at least 300 ppm, alternatively at least 400 ppm, alternatively at least 500 ppm. Similarly the wave-shifting crystals may be present in the matrix material at a concentration of 1000 ppm or less, alternatively 750 ppm or less, alternatively 500 ppm or less, alternatively 250 ppm or less, alternatively 100 or less, alternatively 50 ppm or less, alternatively 25 ppm or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

In embodiments in which transparency is not a factor, the wave-shifting crystals may be present in the matrix material, e.g. polymer, in higher concentrations, e.g. at 0.2% or greater, alternatively 0.3% or greater, alternatively 0.4% or greater, alternatively 0.5% or greater, such that their optical signature can be more easily detected using relatively unsophisticated detection equipment. Similarly, the wave-shifting crystals may be present in the matrix material, e.g. polymer, at concentrations of 3.0% or less, optionally 2.5% or less, alternatively 2.0% or less.

The wave-shifting crystals may be luminescent particles such as down-converting phosphors or up-converting phosphors. A phosphor is a substance that exhibits the phenomenon of luminescence; it emits light when exposed to some type of radiant energy. The term is used both for fluorescent or phosphorescent substances which emit light on exposure to ultraviolet or visible light, and cathodoluminescent substances which emit light when struck by an electron beam (cathode rays) in a cathode ray tube. When a phosphor is exposed to radiation, the orbital electrons in its molecules are excited to a higher energy level; when they return to their former level, they emit the energy as light of a certain wavelength. The crystals can be configured and tuned to operate over any of a variety of wavelengths of light, including for example in the infrared, visual, and ultraviolet (UV) spectra.

Phosphors may generally be categorized as stokes (down-converting) phosphors or anti-stokes (up-converting) phosphors. Phosphors which absorb energy in the form of a photon and emit a lower frequency (lower energy, longer wavelength) band photon are down-converting phosphors. In contrast, phosphors which absorb energy in the form of two or more photons in a low frequency and emit in a higher frequency (higher energy, shorter wavelength) band are up-converting phosphors. Up-converting phosphors, for example, may be irradiated by near infrared light, a lower energy, longer wavelength light, and emit visible light which is of higher energy and a shorter wavelength. Phosphors may also be categorized according to the nature of the energy which excites the phosphor. For example, phosphors which are excited by low energy photons are called photoluminescent and phosphors which are excited by cathode rays are called cathodluminescent.

The wave-shifting particles of the invention may have different optical properties based on their composition, their size, and/or their morphology (or shape). The particles can be configured/tuned to react to, i.e. be excited by, one or more wavelengths of light. In that way, the particles can be configured to have a unique and specific set of light wavelengths by which they can be interrogated. The particles can also be configured/tuned to emit light having any of a variety of emission characteristics, including for example emission at a defined wavelength or within one or more defined wavelength ranges/bands, emission having a defined rise time, emission having a defined decay time, emission having a defined maximum intensity when interrogated by a light source of a defined intensity, emission having a defined intensity at a given time, emission having defined dimensions (e.g. by controlling the size of the particles), emission in a defined spatial pattern (e.g. by applying the crystals to the substrate in a defined pattern), or any combination thereof. Most of these optical properties can be tuned through alterations to the composition, size, and/or morphology of the particles.

In other embodiments, the particles need not have a customized optical property, but rather may be applied to the vessel/package in a unique pattern such that the pattern of their emission can be used to identify and/or authenticate the vessel/package when appropriately interrogated. Any combination of the above is also contemplated, making it possible to provide an almost infinite number of individual pharmaceutical vessels/packages or sets of pharmaceutical vessels/packages with crystals that produce a unique emission associated with that specific vessel/package or that specific set of vessels/packages.

In some embodiments, for example, sets of pharmaceutical vessels/packages may be provided with crystals having an emission profile that identifies a particular manufacturer, a particular pharmaceutical product (e.g., drug), a particular nation or region of the world in which the pharmaceutical product is approved for sale/use, or any combination thereof. Moreover, the crystals can be applied to the pharmaceutical vessels/packages discretely so as not to interfere with any regulations or requirements of the pharmaceutical vessels/packages, such as the need for transparent vessels for example.

The wave-shifting crystals are crystalline in structure. In some embodiments, the wave-shifting crystals may comprise a pure crystalline phase or lattice, e.g. a rare earth (RE)-containing lattice, a uniform or substantially uniform size, and/or a uniform polyhedral morphology.

Depending on their composition, monodisperse particles of the invention may have crystal symmetries of, but not limited to, tetragonal bipyramids, hexagonal prisms, rods, hexagonal plates, ellipsoids, trigonal prisms, and triangular plates which determine the uniform polyhedral morphologies of the particular particles. Due to their relatively uniform size and shape, the monodisperse particles may self-assemble into superlattices.

The rare-earth elements are a set of seventeen silvery-white soft heavy metals, the majority of which occur in the lanthanide family (lanthanum (La), cerium (Ce), praseodymium (Pr), neodymium (Ne), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu)). Scandium (Sc) and yttrium (Y) are also considered rare-earth elements because they tend to occur in the same ore deposits as the lanthanides and exhibit similar chemical properties, despite having different electronic and magnetic properties.

In some embodiments the lattice may contain yttrium (Y) or a lanthanide (Ln) in its +3 oxidation state. The charge is balanced in the lattice by the presence of an anion such as a halide (fluoride, F⁻, being preferred), an oxide, an oxysulfide, an oxyhalide (e.g., OCl), a sulfide, etc. Alkali metals, i.e., lithium (Li), sodium (Na), potassium (K), rubidium (Rb), and cesium (Cs) and/or alkali earth metals beryllium (Be), magnesium (Mg) calcium (Ca), strontium (Sr), and barium (Ba) may also be a component of the host lattice. The alkali metals or alkaline earth metals are often called “lattice modifiers.” For the synthesis of monodisperse particles of the invention, the alkali metal or alkaline earth metal present in the lattice may determine the crystal symmetry providing morphological control over the particles as well as independent tunability of a particle's other properties, such as the optical properties of a luminescent particle. For example, the crystal symmetry of LiYF₄, NaYF₄, and KYF₄ are tetragonal, hexagonal, and trigonal, respectively. The chemical composition of the particles of the invention provides unique polyhedral morphologies. Representative yttrium-containing lattices include, but are not limited to LiYF₄, BaYF₅, BaY₂F₈NaYF₄, KYF₄, Y₂O₂S, Y₂O₃, and the like. A lanthanide-containing lattice may be one having any element of the lanthanide series. Representative lanthanide-containing lattices include, but are not limited to, LaF₃, CeF₃, PrF₃, NeF₃, PmF₃, SmF₃, EuF₃, GdF₃, Tb F₃, DyF₃, HoF₃, ErF₃, TmF₃, YbF₃Lu F₃, NaGdF₃, Gd₂OS₂, LiHoF₄, LiErF₄, CeO, SrS, CaS, GdOCl, and the like.

In some embodiments, the host lattice may be combined with a light emitting dopant. For purposes of the present disclosure, a dopant is a substance that absorbs primary light energy originating from the light source and emits secondary light of a secondary wavelength in response to said primary light energy. When used in combination with a host lattice, the dopant typically is an elemental substitute in the host lattice crystal, serving as a substitute for another element. The element being replaced depends on the composition of the host lattice. For the yttrium-containing or lanthanide-containing lattices used in the particles of the invention, the dopant is often a rare earth metal, quite often a lanthanide or combination of lanthanides, such as Y, Gd, and La (although the dopant is different from the rare earth in host lattice). The dopant element is generally of the same charge and also generally at a small level compared to the element that it is replacing. For example, in a host lattice-dopant combination of NaYF₄:Yb,Er, ytterbium and erbium are the dopants and NaYF₄ is the host lattice material. The ytterbium ions and erbium ions are substituted in for the yttrium ions in the host lattice material. In a host lattice-dopant combination, the phosphor generally substitutes another element for one in the host lattice in a small percentage that gives optical emission properties. A phosphor serving this purpose can comprise a single dopant or can comprise multiple dopants, and one of the dopants might act as a sensitizer. When present, a sensitizer ion is the primary absorber for the phosphor, but is not the main emitter. The energy that the sensitizer absorbs is transferred to the main active emitter ion (main dopant) through non-radiative transfer.

Down-converting inorganic phosphors include rare earth element doped oxides, rare earth element doped oxysulfides, and rare earth element doped fluorides. Examples of down-converting phosphors include, but are not limited to Y₂O₃:Gd, Y₂O₃:Dy, Y₂O₃:Tb, Y₂O₃:Ho, Y₂O₃:Er, Y₂O₃:Tm, Gd₂O₃:Eu, Y₂O₂S:Pr, Y₂O₂S:Sm, Y₂O₂S:Eu, Y₂O₂S:Tb, Y₂O₂S:Ho, Y₂O₂S:Er, Y₂O₂S:Dy, Y₂O₂S:Tm, Y₂O₂S:Eu (red), Y₂O₃:Eu (red), and YVO₄:Eu (red). Other examples of down-converting phosphors are sodium gadolinium fluorides doped with other lanthanides, e.g., NaGdF₄:Tb, wherein the Tb can be replaced with Eu, Dy, Pr, Ce, etc. Lanthanide fluorides are also known as down-converting fluorides, e.g., TbF₃, EuF₃, PrF₃, and DyF₃.

Up-converting phosphors derived from rare earth-containing host lattices, such as described above, doped with at least one activator couple comprising a sensitizer (also known as an absorber) and an emitter. Examples of up-converting phosphor host lattices include: sodium yttrium fluoride (NaYF₄), lanthanum fluoride (LaF₃), lanthanum oxysulfide, RE oxysulfide (RE₂O₂S), RE oxyfluoride (RE₄O₃F₆), RE oxychloride (REOCI), yttrium fluoride (YF₃), yttrium gallate, gadolinium fluoride (GdF₃), barium yttrium fluoride (BaYF₅, BaY₂F₈), and gadolinium oxysulfide, wherein the RE can be Y, Gd, La, or other lanthanide elements. Examples of activator couples are selected from: ytterbium/erbium, ytterbium/thulium, and ytterbium/holmium. Other activator couples suitable for up-conversion may also be used. By combination of rare earth-containing host lattices with just these three activator couples, at least three phosphors with at least three different emission spectra (red, green, and blue visible light) are provided. Generally, the absorber is ytterbium and the emitting center can be selected from: erbium, holmium, terbium, and thulium; however, other up-converting phosphor particles of the invention may contain other absorbers and/or emitters.

The molar ratio of absorber:emitting center is typically at least about 1:1, more usually at least about 3:1 to 5:1, preferably at least about 8:1 to 10:1, more preferably at least about 11:1 to 20:1, and typically less than about 250:1, usually less than about 100:1, and more usually less than about 50:1 to 25:1, although various ratios may be selected by the practitioner on the basis of desired characteristics (e.g., chemical properties, manufacturing efficiency, excitation and emission wavelengths, quantum efficiency, or other considerations). For example, increasing the Yb concentration slightly alters the absorption properties, which may be useful for some applications. For instance, by increasing the Yb concentration, one example of a phosphor particle can be configured to be excited at 915 nm instead of 980 nm. The ratio(s) chosen will generally also depend upon the particular absorber-emitter couple(s) selected, and can be calculated from reference values in accordance with the desired characteristics. It is also possible to control over particle morphologies by drastically changing the ratio of the activators without the emission properties changing drastically for most of the ratios but quenching may occur at some point.

The optimum ratio of absorber (e.g., ytterbium) to the emitting center (e.g., erbium, thulium, or holmium) varies, depending upon the specific absorber/emitter couple. For example, the absorber:emitter ratio for Yb:Er couples is typically in the range of about 20:1 to about 100:1, whereas the absorber:emitter ratio for Yb:Tm and Yb:Ho couples is typically in the range of about 500:1 to about 2000:1. These different ratios are attributable to the different matching energy levels of the Er, Tm, or Ho with respect to the Yb level in the crystal. For most applications, up-converting phosphors may conveniently comprise about 10-30% Yb and either: about 1-2% Er, about 0.1-0.05% Ho, or about 0.1-0.05% Tm, although other formulations may be employed.

Some embodiments of the invention employ inorganic phosphors that are excited by infrared radiation of about 950 to 1000 nm, alternatively about 960 to 980 nm. For example, but not by limitation, a microcrystalline inorganic phosphor of the formula YF₃:Yb_{0.10}Er_{0.01} exhibits a luminescence intensity maximum at an excitation wavelength of about 980 nm.

Up-converting phosphors of some embodiments may have emission maxima that are in the visible range. For example, specific activator couples have characteristic emission spectra: ytterbium-erbium couples have emission maxima in the red or green portions of the visible spectrum, depending upon the phosphor host; ytterbium-holmium couples generally emit maximally in the green portion, ytterbium-thulium typically have an emission maximum in the blue range, and ytterbium-terbium usually emit maximally in the green range. For example, Y_{0.80}Yb_{0.19} Er_{0.01}F₂ emits maximally in the green portion of the spectrum.

In some embodiments, the wave-shifting crystals may be selected from amongst those described in U.S. Pat. No. 10,273,407 B2, the description of which is incorporated herein by reference.

Properties of the crystals can be tuned in a variety of ways. As discussed above, the characteristic absorption and emission spectra of the crystals may be tuned by adjusting their composition, e.g., by selecting a host lattice, and/or by doping. In addition to the characteristic absorption and emission spectra that can be obtained, the rise and decay times of the light emitted by the crystals can also be tuned by controlling particle size and morphology. The rise time is measured from the moment the first excitation photon is absorbed to when the first emission photon is observed. The decay time is measured by the slope of the emission decay, or the time it takes for the phosphor to stop emitting once the excitation source is turned off. This is also described as the time it takes for depletion of electrons from the excited energy levels.

Any of a variety of emission properties may be used to provide crystals having a unique, identifiable emission fingerprint. For instance, in some embodiments the power dependence of the crystals may be utilized. When interrogated at a first power density the crystals may produce a certain amount, i.e. intensity, of light and when interrogated at a second power density the crystals may produce a different amount, i.e. intensity, of light. The effect of interrogation power on some rare earth doped crystals is nonlinear. The difference between the emission intensities at different power densities can therefore provide a unique characteristic of the crystals. A number of rare-earth doped crystals have been developed and tested for their ability to provide unique optical emissions when incorporated into a pharmaceutical vessel/package. In one example, a NaYF₄ crystal lattice was doped with each of the following dopants to produce five unique crystals: Er and Yb; Tm and Yb; Nd and Yb; Ho and Yb; Pr and Yb. Each unique crystal was compounded into COC or COP resin at 500 ppm and then extruded during molding of a pharmaceutical vessel, e.g. a vial, with crystal-free COC or COP resin at a 100 to 1 ratio to produce a vessel having a 5 ppm loading of one of the unique crystals. The vessels containing the crystals were then excited with pulsed infrared (IR) light and the optical responses of the crystals were captured and analyzed. The optical properties of the emissions of each of the five different crystals were sufficiently different from one another to distinguish each vessel from one another.

In another example, a NaLiF crystal lattice was doped with Nd to produce substantially uniform crystal particles having a particle size of about 50 nm×30 nm. The crystals were then blended into a PMMA ink jet formulation and applied to the outer surface of a pharmaceutical vessel, e.g. a vial or syringe barrel. The ink coating is not visible on the resulting vessel and the vessel wall remains transparent. By changing the dimensions of the crystal and the concentration of the rare earth dopant, each unique uniform crystal set produces a unique optical signature, or fingerprint. This can be identified by a combination of rise time, decay time, and the power dependence of the crystal, e.g. when interrogated at a power density of 1 mW per mm² the crystals will produce a certain amount, i.e. intensity, of light and when interrogated at a power density of 2 mW per mm² the crystals will produce a different amount, i.e. intensity, of light. The effect of interrogation power on these rare earth doped crystals is nonlinear and the difference between the power densities can be utilized in the determination of the unique characteristics of the crystals.

In another example, a Y₂O₃ crystal lattice is doped with Er and Yb to produce substantially uniform crystals particles having a particle size of about 1000 nm. The crystals are then compounded into COC or COP at a 5% concentration. The crystal-containing COC or COP is then co-injected with crystal-free COC or COP to produce a 4 mm thick circle on the base of the vial. The vials may be interrogated with a smartphone containing an IR illuminator (used for facial recognition) and/or a Vertical-Cavity Surface-Emitting Laser (VCSEL), each of which may emit light having a wavelength of about 940 nm, which is absorbed by the crystals to produce a detectable optical response.

Embodiments of the present invention are directed to the use of wave-shifting crystals, such as rare earth doped crystals, in pharmaceutical packages to provide a discrete method to authenticate and track pharmaceutical drugs, and in particular injectable drugs (including e.g. vaccines, biologic drugs, and the like). The crystals may be incorporated as an additive to the pharmaceutical packaging materials during the manufacturing process. Once incorporated into the pharmaceutical package, the package may be interrogated with a light-emitting device and optionally a light-detecting device to authenticate the package. The packages include but are not limited to vials, pre-filled syringes, cartridges and other drug delivery packages.

In the case of pharmaceutical packages made of plastic, the crystals may be added to the plastic resin during a compounding process, prior to molding the package. Some of the materials used to manufacture thermoplastic vessels used as pharmaceutical packages include but are not limited to: polypropylene, polyethylene, a cyclic olefin polymer (COP), a cyclic olefin copolymer (COC), and a cyclic block copolymer (CBC). In some embodiments, e.g. for syringe barrels, the vessel may be made by injection molding using thermoplastic material containing the crystals. In other embodiments, e.g. for vials, the vessel may be made by injection molding a preform from thermoplastic material containing the crystals and then blow molding or stretch blow molding the preform to produce the vessel.

In the case of pharmaceutical packages made of glass, the crystals may be added to the molten glass prior to forming the glass into the vessel. In those embodiments, the crystals may need to withstand glass forming temperatures greater than 1,000° F.

When incorporating the crystals directly into the wall of many vessels, e.g. syringe barrels, vials, etc., the competing interests of emission intensity and wall clarity (transparency) must be balanced.

### Example 1A: Producing a Vial Having a Detectable Fingerprint by Compounding Rare-Earth Doped Nanoparticle Crystals into Resin

Small, light emitting crystals are compounded into a polymer resin used to mold vials and syringes. Different concentrations (loadings) of crystals are provided in the resin during molding of the vials/syringes in order to evaluate: (1) light intensity of the crystals emission (e.g. detectability of the emission) and (2) transparency of the vessel.

The crystal host is NaYF₄. The dopant is selected from the following: Er Yb; Tm Yb; Nd Yb; Ho Yb; Pr Yb. The crystal particles have dimensions (sizes) between about 500 nm and about 1000 nm. The crystal particles are compounded into a bulk COC resin (Topas 6013-S04) at a concentration between about 500 ppm and about 1000 ppm. The bulk COC resin is then blended with crystal-free COC resin in a defined ratio to produce a preform. The preform is then stretch blow molded to produce the vial.

The clarity, i.e. transparency, of the vials containing varying concentrations of the rare earth doped crystal nanoparticles is measured using UV spectroscopy. The emission profiles of the vials containing varying concentrations of the rare earth doped crystal nanoparticles, and in particular the intensity of the emissions, are measured using a hand-held reader and a conventional smartphone (iphone 12).

It is contemplated that a suitable combination of crystal size and loading that both (a) maintains acceptable vessel transparency and (b) produces an emission that is detectable by the smartphone may be determined.

### Example 1B

Vials were molded from a COC (cyclic olefin copolymer) thermoplastic resin containing one of the following crystals: Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er. Note that each of the preceding is described as lattice material: one or more dopant materials. Each crystal type was measured for sizes and found to have a D50 of either about 1 micron or about 2 microns. Each crystal type also has a D99 less than 10 microns. Each vial was molded from a COC thermoplastic resin containing one of two concentrations of one of the above crystal types: either about 50 ppm or about 5-10 ppm. The goal of the study was to maximize the signal from the crystals for purposes of detection while maintaining transparency of the vials.

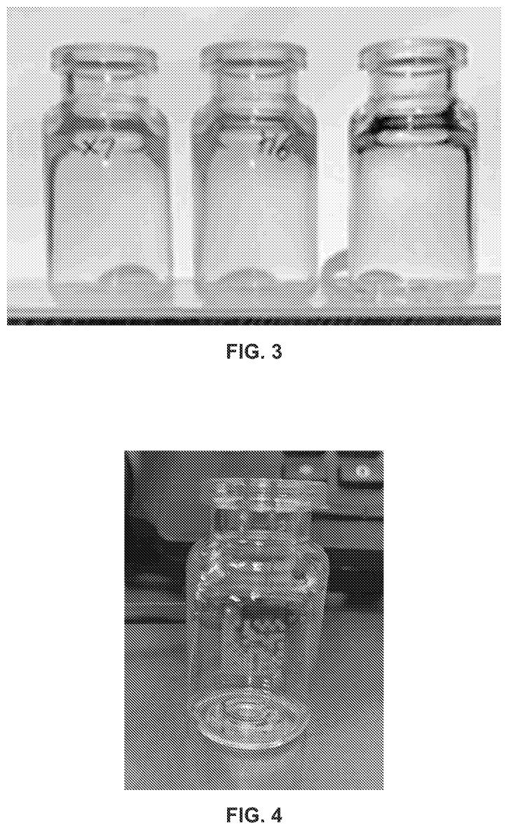

Referring to FIG. 3, the vessel on the left and the vessel in the center each were produced using 50 ppm of one of the above crystals (specifically Gd₂SO₂:Yb in the vial shown on the left and NaYF₄:Yb, Nd in the vial shown in the center). The vessel on the right was produced using from 5 to 10 ppm of one of the above crystals (specifically NaYF₄:Yb, Er). As can be seen in FIG. 3, the vial prepared with 5 to 10 ppm of the wave-shifting crystals is transparent while the vials prepared with 50 ppm of the wave-shifting crystals are not. Accordingly, for a crystal having a median crystal size between about 1 and about 2 microns, this testing shows that a concentration of 50 ppm in a COC matrix is too high to maintain transparency whereas a loading of 5-10 ppm is sufficient to maintain transparency. Additional testing will determine whether higher loadings too (e.g. 15 ppm, 20 ppm, 25 ppm, 30 ppm) are sufficient to maintain transparency.

In some embodiments, the vessel may be molded out of two polymers, a first transparent polymer and a second polymer which contains the wave-shifting crystals. A first portion/region of the vessel, optionally the main body of the vessel, e.g. the sidewalls which define the vessel lumen, may be molded of the transparent first polymer. A second portion/region of the vessel, optionally the base of a vial or the flange of a syringe barrel, may be molded of the second, crystal-containing polymer or a combination of the first and second polymers. This may be achieved by a two-shot molding process of either the vessel itself (e.g. if the vessel is injection molded, as is typically the case for a syringe barrel) or a preform (e.g. during injection molding of the preform) which is blow molded into the vessel (as is typically the case for a vial). The portion/region of the vessel containing the second polymer or a combination of the first and second polymers may not be transparent, but may be positioned strategically where transparency is not required, e.g. the base of a vial, the flange of a syringe barrel, or the like. In other embodiments, the vessel may be molded with an in-mold label or component containing the crystals. The in-mold label or component may also be strategically positioned as described above.

In other embodiments, the crystals may be incorporated in a coating system applied to one or more interior walls and/or one or more exterior walls of the vessel. The coating system may be applied using any of a variety of techniques, including for example wet coating techniques, chemical vapor deposition (CVD), or atomic layer deposition (ALD).

In some embodiments, the coating may be transparent or substantially transparent.

In other embodiments, the coating system may be applied to one or more non-transparent areas formed by using a laser to burn away material from the vessel wall, leaving channels or recesses. The channels or recesses may be gray-scale or, optionally, may be black.

In some embodiments, the non-transparent areas may be human readable text, may be alphanumeric, a scannable code, or a geometric shape. In some embodiments the scannable code may optionally be a bar code or QR code.

In some embodiments, the crystals may be incorporated into a polymeric resin which is applied to one or more channels or recesses in the vessel, closure, or other packaging component. The recess may be formed by laser etching. The polymeric resin may or may not be transparent. In some embodiments, the polymeric resin may comprise an epoxy or be an epoxy.

In some embodiments, the coating may contain crystals at a suitable loading to be read with a mobile reader, optionally a smartphone as described herein.

The crystals can be added in parts per billion (ppb) but may be more desirably added in a parts per million concentration or higher. Desirably, vessel walls molded with the crystals may remain transparent. Similarly, it may be desirable that vessel walls having an interior or exterior coating comprising the crystals may remain transparent.

In some embodiments, the crystals can be incorporated into an ink and then applied, e.g. printed, to the vessel or pharmaceutical package. In some embodiments, the ink may be transparent or substantially transparent. In some embodiments, the coating may contain crystals at a suitable loading to be read with a mobile reader, optionally a smartphone as described herein. In one embodiment, for example, the crystals may be blended into an ink at a concentration of 5-10 ppm. The ink can be applied to the pharmaceutical package using an ink jet printer, e.g. by loading in an HP25 ink cartridge or equivalent, or a pad printing.

The ink may be applied in a defined pattern. In some embodiments, the pattern may be alphanumeric, a scannable code, or a geometric shape. In some embodiments, the scannable code may optionally be a bar code or QR code.

### Example 2: Applying Crystals to Exterior of Vessel Using Ink

Small, light emitting crystals are blended into an ink that is compatible with COP/COC used to mold vials and syringes. Different concentrations (loadings) of crystals are provided in the ink in order to evaluate: (1) light intensity of the crystals emission (e.g. detectability of the emission) and (2) transparency of the vessel.

The crystal host is NaYF₄. The dopant is selected from the following: Er Yb; Tm Yb; Nd Yb; Ho Yb; Pr Yb. The crystal particles have dimensions (sizes) between about 500 nm and about 1000 nm. The crystal particles are blended into the ink and COP/COC vials and syringe barrels are printed with the crystal-containing ink.

The clarity, i.e. transparency, of the vials containing varying concentrations of the rare earth doped crystals is measured using UV spectroscopy. The emission profiles of the vials containing varying concentrations of the rare earth doped crystals, and in particular the intensity of the emissions, are measured using a hand-held reader and a conventional smartphone (iphone 12).

It was contemplated that a suitable combination of crystal size and loading that both (a) maintains acceptable vessel transparency and (b) produces an emission that is detectable by the smartphone may be determined.

A pharmaceutical vial having a sidewall printed with a defined pattern—here a machine scannable code—using an ink containing wave-shifting crystal nanoparticles is shown in FIG. 4. The ink contained NaYF₄:Yb, Er having a crystal size distribution D50 of about 50 nm. The wave-shifting crystals were present in the ink at a concentration of about 100 ppm. FIG. 4 shows the illumination of the printed pattern when interrogated with a light source that excites the wave-shifting crystal nanoparticles. When not being so interrogated, the printed pattern would not be visible on the wall of the vial. Rather, the vial wall maintains transparency. As such, at least one combination of crystal size and loading has been shown to maintain acceptable vessel transparency.

In some embodiments, the vessel or pharmaceutical package can be printed with a scannable code, e.g. a barcode or QR code, that may then be interrogated using a reader at one or more discrete wavelengths based on the specific emission characteristics of the crystals. In other embodiments, the ink can be printed in a specific pattern to create a unique light map when interrogated by a reader. In other embodiments, the crystals can be supplied in a holographic label that can be used for tamper evidence and authentication.

Where it is not necessary to maintain transparency of the wave-shifting crystal loaded matrix material, the wave-shifting crystals used may have larger sizes than those used when incorporated into a vial or syringe barrel sidewall and/or may be loaded into the matrix material at a significantly higher concentration, thereby rendering detection possible or easier using equipment having relatively low sensitivity, including for instance the equipment found on a conventional smartphone.

In some embodiments, for instance, the wave-shifting crystals may be incorporated into the thermoplastic resin used to produce the base (bottom wall) of a vial, e.g. using a two-shot process such as that described above, which does not need to be transparent.

In some embodiments, the wave-shifting crystals may be incorporated into the thermoplastic material used to make the outer casing of a needle shield or tip cap which is then applied to a syringe, e.g. a pre-filled syringe. Similar, the wave-shifting crystals may be incorporated into the thermoplastic material used to make a vial cap, e.g. a tamper-evident and/or flip-off seal, which is then applied to a filled vial. These components can be made from a variety of different polymers, including for instance polypropylene or acrylonitrile butadiene styrene (ABS). A needle shield casing, tip cap, and vial cap/seal does not need to be transparent and, in fact, are typically not transparent. Accordingly, the wave-shifting crystals used may have larger sizes than those used when incorporated into a vial or syringe barrel sidewall and/or may be loaded into the matrix material at a significantly higher concentration, thereby rendering detection possible or easier using equipment having relatively low sensitivity, including for instance the equipment found on a conventional smartphone.

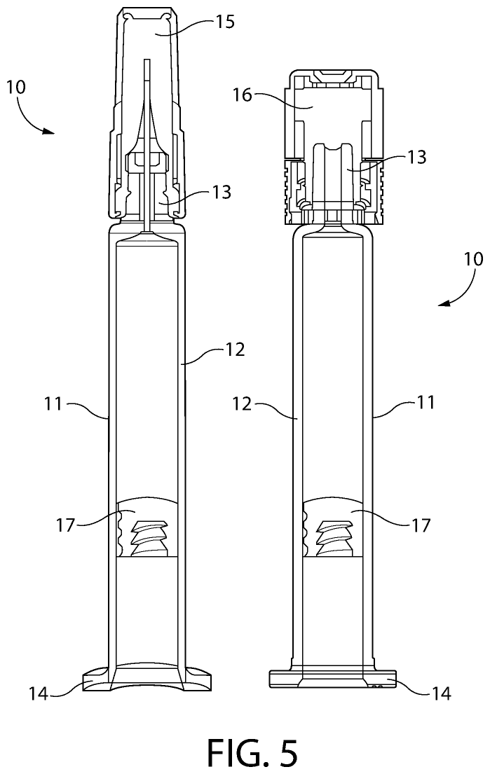

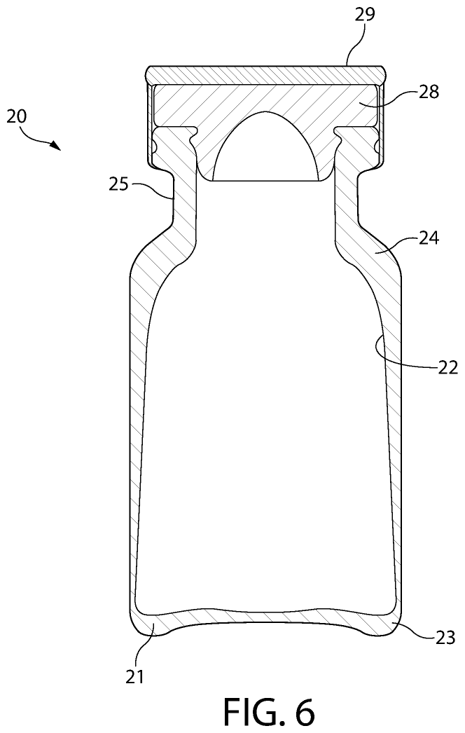

FIG. 5 shows examples of pharmaceutical packages, namely pre-filled syringes 10, having wave-shifting crystals incorporated into or onto a portion of the syringe by any of the embodiments described herein. The illustrated examples of the pre-filled syringes 10 each comprise a syringe barrel 11 having a main body portion 12, a needle hub or Luer lock hub 13, and a rear flange 14. The example pre-filled syringes 10 also include an injectable pharmaceutical composition contained within the lumen of the syringe barrel, a plunger 17 inserted into the rear opening of the syringe barrel to provide a rear seal, and either a rigid needle shield 15 or a Luer cap 16, depending on whether the syringe is a staked needle syringe or a Luer lock syringe. In some embodiments, a plunger rod may also be inserted into the rear opening of the syringe barrel and into communication with the plunger 17.

FIG. 6 shows an example of a pharmaceutical package comprising a vial 20 and having wave-shifting crystals incorporated into or onto a portion of the package by any of the embodiments described herein. Vials 20 of the present disclosure may include a bottom wall 21, a side wall 22 extending upward from the bottom wall, a curved lower edge joining the bottom wall and the side wall 23, a radially inwardly extending shoulder 24 formed at the top of the side wall, and a neck 25 extending upwardly from the shoulder, the neck defining an opening at the top thereof, the opening leading to the vial interior, i.e. lumen.

Once filled with a pharmaceutical product, typically an injectable pharmaceutical product, the vial 20 is sealed. Typically a pharmaceutical vial 20 is sealed with a two-part closure comprising a rubber stopper 28 and a cap 29, such as an crimp cap, a Flip-Off® Seal of the sort produced by West Pharmaceutical, or the like. A crimp cap is typically made of a metal such as aluminium and is crimped over the top of the stopper 28 and the neck flange of the vial. The combination of filled vial 20, stopper 28, and cap 29, may be referred to as a pharmaceutical vial or vial package.

In some embodiments, the wave-shifting crystals can be added to secondary packaging or a label that is applied to the vessel. Again, because transparency is not necessary, the wave-shifting crystals may be larger, present at higher concentrations, etc.

### Example 3

Gd₂SO₂:Yb,Er crystals having a particle size distribution D50 of about 2 microns are added to the thermoplastic material used to form the base of a vial at a concentration between 0.5 and 2.0%.

### Example 4

Gd₂SO₂:Yb,Er crystals having a particle size distribution D50 of about 2 microns are added to the thermoplastic material used to form the outer casing of a needle shield and the outer casing of a tip cap, such as those shown in FIG. 5, at a concentration between 0.5 and 2.0%.

### Example 5

Gd₂SO₂:Yb,Er crystals having a particle size distribution D50 of about 2 microns are added to a label for a pharmaceutical product or secondary packaging for a pharmaceutical product at a concentration between 0.5 and 2.0%.

In various embodiments, the pharmaceutical package can be interrogated by a hand-held or industrial device, such as those disclosed in U.S. Pat. No. 11,138,612 B2 for example, to track and/or authenticate the vessel and/or filled pharmaceutical package.

In some embodiments, vessel and pharmaceutical packages comprising crystals are configured such that the crystals withstand certain treatment conditions, such as cold temperature storage of pharmaceutical packages down to about −20 degrees Celsius or colder, alternatively down to about −196 degrees Celsius. In some embodiments, vessel and pharmaceutical packages comprising crystals are configured such that the crystals withstand certain treatment conditions, such as lyophilization freeze-drying cycles. In some embodiments, vessel and pharmaceutical packages comprising crystals are configured such that the crystals withstand certain treatment conditions, such as autoclaving at 120 degrees Celsius or greater for up to 60 minutes.

The vessel and pharmaceutical packages comprising crystals may be configured such that the crystals withstand sterilization of the vessel or pharmaceutical package, such as sterilization by irradiation (e.g., e-beam or gamma) and gas (e.g., ethylene oxide (EtO), vaporized hydrogen peroxide (VHP), etc.). In some embodiments, for example, the vessel or pharmaceutical package, and hence the crystals, may be configured to withstand multiple cycles of 2×25 kGy of e-beam or gamma irradiation.

In some embodiments, the crystals may be configured to act as a temperature or pressure sensor.

In some embodiments, for instance, the crystals may emit light having a first characteristic, e.g. a first wavelength or plurality of wavelengths, intensity, etc., when the crystals are at a first temperature and may emit light having a second characteristic, e.g. a second wavelength, intensity, etc., when the crystals are at a second temperature, in which the first and second temperatures are different from one another and the first and second characteristics, e.g. wavelength(s), intensities, etc., are detectably different from one another. Similarly, in some embodiments, the crystals may emit light having a first characteristic, e.g. a first wavelength or plurality of wavelengths, intensity, etc., when the crystals are at a first pressure and may emit light having a second characteristic, e.g. a second wavelength or plurality of wavelengths, intensity, etc., when the crystals are at a second pressure, in which the first and second pressures are different from one another and the first and second characteristics, e.g. wavelengths, intensities, etc. are detectably different from one another.

In some embodiments, the crystals may be charged to emit light having a first characteristic, e.g. a first wavelength or plurality of wavelengths, intensity, etc. The charged crystals may remain configured to emit light having the first characteristic as long as the crystals are maintained within a defined range of temperatures and/or pressures. If, however, the crystals are brought to a temperature and/or pressure outside of the defined range of temperatures and/or pressures, the crystals may lose the charge and instead emit light having a second characteristic, e.g. a second wavelength, intensity, etc.

In the case of a pharmaceutical package, the crystals may be charged and configured to maintain the charge within a defined temperature and/or pressure range after the drug is filled in the vessel, e.g. vial or syringe. As the pharmaceutical package moves through its supply chain, the pharmaceutical package may be subjected to pressure and/or temperature changes. If the temperature and/or pressure changes are such that they bring the crystals outside of the defined temperature and/or pressure range, the energy level of the crystal will change. Accordingly, when the crystal is interrogated, e.g. prior to use by a doctor, pharmacist, patient, etc., the characteristic of the light that is emitted by the crystals will identify whether or not the package was maintained within a defined temperature and/or pressure range. This can be particularly valuable for cold chain drugs, such as many DNA or mRNA vaccines, which must be maintained at defined low temperature ranges throughout their supply chain.

Aspects of the present disclosure are also directed to methods for tracing and/or authenticating a pharmaceutical package and/or vessel that is filled, e.g. with a drug-containing solution, and sealed to produce the pharmaceutical package. A vessel and/or pharmaceutical package as described herein may be provided with rare earth doped crystals having one or more predetermined luminescence characteristics. At any of a variety of stages of the life cycle of the vessel and/or pharmaceutical package, the vessel or package may be interrogated to determine if the rare earth doped crystals are present and whether the one or more predetermined luminescence characteristics are satisfied. If the rare earth doped crystals are present and satisfy the one or more predetermined luminescence characteristics, than the vessel and/or package will be positively identified.

The vessel and/or package can be interrogated by applying light having one or more wavelengths that are known to excite the rare earth doped crystals that are incorporated into the vessel and/or pharmaceutical package, thereby exciting the rare earth doped crystals and causing them to luminesce. The luminescence characteristics of the light emitted by the rare earth doped crystals is then detected and compared against the predetermined characteristics to ensure that they match.

In some embodiments, the detection and comparison may be done manually. For instance where the light emitted by the rare earth doped crystals is in the visible spectrum and a user can determine whether the one or more predetermined luminescence characteristics that correspond with the vessel and/or pharmaceutical package is present. In other embodiments, the detection and comparison may be performed—at least in part—using a device that has light detection and analysis elements. The use of a detector device may be necessary for instance where an important component of the light emitted by the rare earth doped crystals is not in the visible spectrum, e.g. where at least one of the relevant luminescence characteristics that correspond with the vessel and/or pharmaceutical package is in the ultraviolet or infrared spectrum.

In some embodiments, the vessel/package may be configured so that the crystals can be interrogated and the emission detected by a smartphone, for instance a smartphone containing an IR illuminator (commonly used for facial recognition) and/or a Vertical-Cavity Surface-Emitting Laser (VCSEL) to excite the crystals and/or a CMOS camera to capture the emission profile of the crystals. For example, the VL53L0X Time-of-Flight (ToF) laser ranging and gesture detection sensor/module, which may be incorporated into a mobile device such as a smartphone, utilizes a VCSEL emitter. The sensor/module, e.g. the VL53L0X or similar sensor/module, may be programmed to detect/read wave-shifting crystals present in a vessel/pharmaceutical package wall at concentrations as low as 5-10 ppm, which are low enough to maintain the transparency of the vessel wall.

A sample light map image of an emission profile captured by a CMOS camera is shown in FIGS. 2A (raw) and 2B (with an applied grid). The captured light map image may be analyzed by one or more processors, such as within the smartphone, having appropriate software to convert the captured emission into the data associated with that specific optical emission profile, e.g. to identify a vessel/package or confirm/deny a previous identification of a vessel/package for authentication purposes.

In some embodiments, interrogation may be by CW or pulsed laser diodes of various (one or more) wavelengths ranging from UV to Mid Infrared. In some embodiments, interrogation may be by CW or pulsed LED of various (one or more) wavelengths ranging from UV to Mid Infrared. In some embodiments, interrogation may be by Pulsed LED light or laser currently used in smart phone devices. In some embodiments, filtration of an excitation source will be utilized by modulation of the sources and/or optical filtration of the excitation light.

In some embodiments, detection may be by a hyperspectral imaging camera capable of pixel by pixel analysis of both spectral emission as well as rise and decay times. In some embodiments, detection may be by Avalanche Photodiode (APD), which may provide analysis of both spectral emission as well as rise and decay times. In some embodiments, detection may be by a standard CMOS camera, such as those utilized in smart phone devices.

Any of a variety of predetermined luminescence characteristics may be used to identify the vessel and/or pharmaceutical package. For instance, it may simply be required that the light emitted by the rare earth doped crystals falls within one or more defined wavelength ranges/bands. Using a visible light wavelength as an example, it may simply be required that the light emitted by the rare earth doped crystals has a certain color or combination of colors, each of which can be quantified. Additionally or alternatively, it may be required that the light emitted by the rare earth doped crystals has a rise time falling within a predetermined and defined range and/or a decay time falling within a predetermined and defined range (typically on the scale of microseconds to milliseconds). Additionally or alternatively, it may be required that the light emitted by the rare earth doped crystals falls within a predetermined and defined maximum intensity range. Additionally or alternatively, it may be required that the light emitted by the rare earth doped crystals falls within a predetermined and defined intensity range after a defined period of time. Additionally or alternatively, it may be required that the light emitted by the rare earth doped crystals is in a defined spatial pattern, e.g. forms a specific shape, letter, or word or forms a scannable code (which may then be scanned as a further confirmation step). Additionally or alternatively, it may be required that the wave-shifting crystals are excited by light within one or more predetermined and defined wavelengths. In some examples, in fact, a wave-shifting crystal may need to be interrogated by a light of a first wavelength followed by a light of a second wavelength in order to excite the crystal and cause an optical conversion. Because the rare earth doped crystals may be tuned to have a variety of different light emitting properties, the particular luminescence characteristic(s) and/or the number of different characteristics to be detected may be selected for a desired application.

As described above, the wave shifting crystals may each have a specific optical signature, or fingerprint, that can be programmed by precise compositional control of the particle structure. To ensure proper analysis of the light map and the different optical signatures from each of the compositions, the particle-to-particle variation for a single composition should be minimal allowing for multiplexed signatures of high levels. Accordingly, in some embodiments it is important for the crystals to have uniform or substantially uniform (within a range of uniformity that the emission profile of the crystals can be detected and determined to be associated with the correct data with which that emission profile is associated) compositions, sizes, etc., or a combination thereof. For example, by controlling the amount of one or more dopants in a given crystal, the decay time may be customized; however, it is important that the decay time of each particle within that crystal set has a substantially uniform amount of the one or more dopants in order to ensure that the decay time is consistent throughout the individual crystal particles.

The wave shifting crystals may themselves have multiple optical signatures which may be used to provide multiple layers of authentication or data recovery. Accordingly, a pharmaceutical package may thus be provided with wave shifting crystals having precisely engineered optical properties that allow for multiple layers of authentication or data recovery.

A first example layer of data identification and/or authentication may focus on the unique spectral (absorption and/or emission) properties of the wave shifting crystals. When the crystals are subsequently exposed to the appropriate excitation wavelength(s), they will emit a distinct optical profile that may be associated with a point or set of data, e.g. identification data. Encryption algorithms may be applied to the light map to associate the distinct optical profile with the point or set of data.

A second example layer of data identification and/or authentication may focus on the positioning of the crystals within a light map. For example, one or more unique crystals can be applied to a pharmaceutical package in a method that enables random dispersion of the crystals. When the crystals are subsequently exposed to the appropriate excitation wavelength(s), they may also be mapped based on the location of each crystal in the light map, such that the locations of the crystals is associated with a point or set of data, e.g. identification data. A random distribution of particles allows for a unique pattern to each substrate. This pattern will be stored as an image file and encrypted for future analysis once the substrate leaves the manufacturing facility. Encryption algorithms may be applied to the light map to associate the positioning of the crystals within the light map with the point or set of data.

A third example layer of data identification and/or authentication may focus on the unique emission lifetime of the crystals. For example, the same light map captured above may be used to localize, and subsequently measure, the unique lifetime properties of the wave shifting crystals. The lifetimes of the crystals are defined as the rise and decay times at a particular emission wavelength. Each emission spectra can be programmed to have distinct rise and decay times that may be associated with a data point or set of data, e.g. identification data. Encryption algorithms may be applied to the light map to associate the distinct lifetime profile with the point or set of data.

A fourth example layer of data identification and/or authentication may focus on the excitation power dependent emission properties of the crystals. For instance, the composition of NaYF₄:Yb,Er can have significantly different spectral profiles and peak ratios depending on the power density applied to the crystals. This power density dependence can be controlled via a variety of approaches such as direct composition changes, morphologies, and hetero-structures such as core-shell or core-shell-shell. The power density dependence profile may be associated with a data point or set of data, e.g. identification data. Encryption algorithms may be applied to the light map to associate the distinct power density profile with the point or set of data.

Another example layer of data identification and/or authentication may be provided by a 2D readable or scannable code. For instance, an alphanumeric or machine-scannable code may be engraved, e.g. laser inscribed, into a portion of the vessel/pharmaceutical package or printed on a portion of the vessel/pharmaceutical package (including secondary packaging). Wave-shifting crystals may be incorporated, e.g. filled, into the engraved code or added to the ink that is used to form the code. In one example, a barcode or QR code is provided with wave shifting crystals, wherein the barcode or QR code is readable upon excitation and detection of unique optical properties of the crystals incorporated in the barcode.

If multiple different crystals and/or multiple optical signatures, such as those described above, are present in the package and generating unique light maps for each optical signature/crystal is desirable, the device that reads the light maps can be modified via software or hardware updates to selectively generate light maps based on precise optical excitation parameters such as wavelength, power density, and laser pulse width.

For instance, a package may include a combination of 3 (A, B, C) rare earth particles each with an identifiable optical signature such as lifetime (rise and decay). All samples A, B, C are excited using the same laser source at 980 nm, each of the three A, B, C samples can have the same spectral emission profiles (peak of ˜540 nm) but when measured by rise and decay time each of the spectral samples will have distinguishable rise and decay times. By adjusting the pulse frequency of the laser and detector it is possible to selectively activate particles using only the programmed pulse rates.

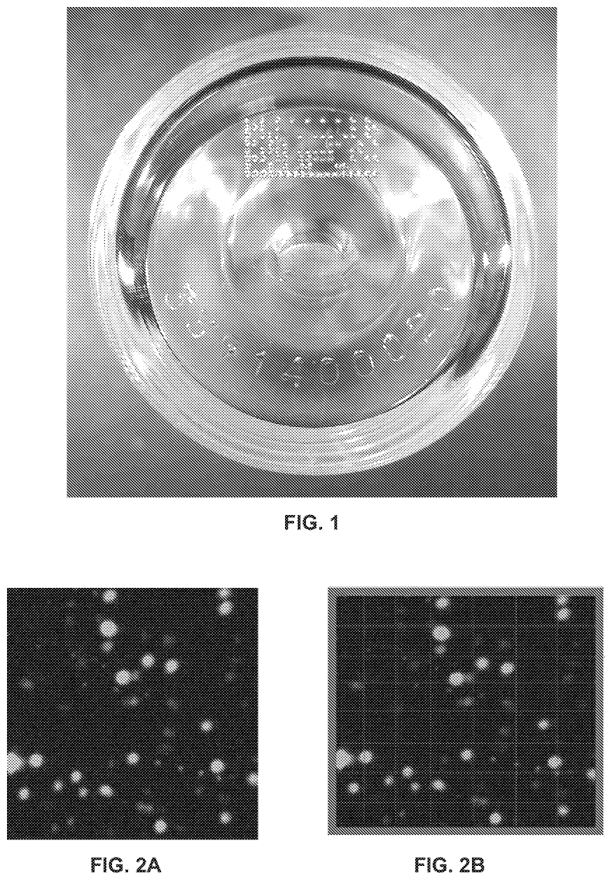

The wave shifting crystals may also be used to provide only one (or more) of multiple layers of authentication. In one example, for instance, each of a plurality of vials may have a unique ID that is laser inscribed on to the bottom of the vial, e.g. as shown in FIG. 1. Similarly, each of a plurality of syringes may have a unique ID that is laser inscribed on the flange of the syringe barrel. Authentication crystals may then be applied to the bottom of the vial or the flange of the syringe barrel, e.g. through a coating or ink. The vials or syringes may then be placed in secondary packaging, e.g. a box, a shipping case, or both. The secondary packaging provided with a label, e.g. a tamper evident label. The secondary packaging may also be provided with an intelligent tag (as described herein), wave shifting crystals, RFID and/or NFC, or other tracking technology. Each vial or syringe may be linked to the secondary packaging label and/or tracking element. The secondary packaging may thus be tracked throughout the supply chain until it arrives at its final location, e.g. a pharmacy. In addition to the secondary packaging being scanned and authenticated by the pharmacist upon its arrival, each vial or syringe may independently be scanned and authenticated by the pharmacist, e.g. before its disbursement, use, etc. Moreover, the scanning and authentication of each pharmaceutical package may involve both reading and/or recording the laser inscribed ID and reading the emission fingerprint provided by the wave shifting crystals.

Tracking of Shipping Materials, e.g. Shipping Cases for Pharmaceutical Packages

Embodiments of the present disclosure also relate to the incorporation of intelligent tags in pharmaceutical packaging shipping materials, such as shipping cases used to transport a plurality of pharmaceutical packages (also referred to herein as a set of pharmaceutical packages). These intelligent tags, or sensors, can be covertly integrated into the shipping materials for pharmaceutical packages, e.g. a shipping case. These tags may be configured to detect and transmit the location, temperature, or both of the shipping case at various times, e.g. at pre-defined intervals, throughout the supply chain. Using these tags, pharmaceutical companies and/or the intended recipient of a set of pharmaceutical packages could quickly identify if a case of pharmaceutical products has been moved or diverted and/or if the case has exceeded the specified shelf-life temperature of the pharmaceutical formulation contained therein.

In some embodiments, the intelligent tag may be configured to detect and broadcast a location of the case, e.g. globally, at one or more times throughout the supply chain. The tag may thus be used to track the location of a set of pharmaceutical packages and identify when the set of pharmaceutical packages has been moved and/or diverted within the supply chain. In some embodiments, for instance, the tag may comprise a GPS or A-GPS device.

In some embodiments, the intelligent tag may include a temperature sensor. The tags may thus detect and broadcast a temperature of a set of pharmaceutical packages at one or more times throughout the supply chain. The tag may thus be used to track the storage temperature of a set of pharmaceutical packages and identify whether the temperature of the packages exceeded a specified temperature threshold, e.g. a shelf-life temperature of the pharmaceutical formulation contained therein.

Desirably, the intelligent tags may be configured to detect and broadcast both the location and the temperature of the set of pharmaceutical packages.

In some embodiments, the tag may incorporate a power source, for example a battery, and may be a self-contained device. The tag may be configured to use satellite, Wi-Fi network, short-range wireless technology (e.g. Bluetooth), and/or cellular phone signals to broadcast information, for example their global position and/or temperature.

Embodiments of the present disclosure are directed to shipping cases containing a plurality of pharmaceutical packages. The shipping cases may include a container comprising a bottom wall, one or more and optionally a plurality of side walls, and a top wall that together define an interior space; a plurality of pharmaceutical packages, each of which contains a pharmaceutical formulation, positioned within the interior space of the container; and a tag configured to transmit data that includes the location of the shipping case, the temperature of the shipping case, or both. The tag may be covertly positioned in, on, or within the shipping case. In some embodiments, for instance, the tag may not be readily accessible or visible when the shipping case is closed. Similarly, in some embodiments, the tag may not be readily accessible or visible when the shipping case is open. In some embodiments, the tag may not even be readily accessible or visible after the pharmaceutical packages are removed from the container.

In some embodiments, the tag may include a power source, such as a battery. The operating lifetime of the power device may be selected depending on the length of the supply chain. In some embodiments, for instance, the power source may desirably have an operating lifetime of at least one year, optionally at least two years, optionally at least three years, optionally at least four years, optionally at least five years.

The tag may be configured to transmit data by one or more systems. In some embodiments, for instance, the tag may be configured to transmit data by satellite network, Wi-Fi network, cellular phone network, short-range wireless technology (e.g. Bluetooth), or any combination thereof.

The tag may be configured to transmit the location data, the temperature data, or both at defined intervals. In some embodiments, for example, the tag may be configured to transmit the location data, the temperature data, or both at least once per day, optionally at least once per 12 hours, optionally at least once per 8 hours, optionally at least once per 4 hours, optionally at least once per 2 hours, optionally at least once per hour, optionally at least once per half-hour.

In some embodiments, the tag may be configured to transmit data when a substantial change in location, temperature, or both occurs. For instance, the tag may be configured to transmit at least the location data any time the location of the shipping case changes or anytime that the location of the shipping case changes by at least a minimum distance (e.g. at least 1 mile, at least 5 miles, etc.). Alternatively or additionally, the tag may be configured to transmit at the location data if the location of the shipping case corresponds with one or more predefined areas (e.g. if the shipping case is received at a predefined facility).

Similarly, the tag may be configured to transmit at least the temperature data any time the temperature of the shipping case changes or anytime that the temperature data changes by at least a minimum amount (e.g. at least 0.5° C., at least 1.0° C., at least 2.0° C., etc.). Alternatively or additionally, the tag may be configured to transmit at least the temperature data if the temperature exceeds a predefined threshold value, such as an upper limit of permissible shelf-life temperatures for the pharmaceutical formulation contained in the pharmaceutical packages, a lower limit of permissible shelf-life temperatures for the pharmaceutical formulation contained in the pharmaceutical packages, or both.

In some embodiments, the tag may be small, which helps give the tag the ability to be covertly positioned in or on the shipping case. In some embodiments, for instance, the tag may have a thickness less than 20 mm, optionally less than 15 mm, optionally less than 12 mm, optionally less than 10 mm, optionally less than 7 mm, optionally less than 5 mm, optionally less than 3 mm, optionally less than 2 mm. The tag may also have a length dimension less than 25 mm, optionally less than 20 mm, optionally less than 15 mm, optionally less than 10 mm; and a width dimension less than 25 mm, optionally less than 20 mm, optionally less than 15 mm, optionally less than 10 mm. The tag may also desirably be relatively lightweight. In some embodiments, for instance, the tag may have a weight less than 5 grams, optionally less than 4 grams, optionally less than 3 grams, optionally less than 2 grams.

Depending on the storage/shelf-life temperature of the pharmaceutical formulations contained in the pharmaceutical packages, the tag may be configured to maintain operability at extremely low temperatures, such as at temperatures as low as −20° C., optionally at temperatures as low as −30° C., optionally at temperatures as low as −40° C., optionally at temperatures as low as −50° C., optionally at temperatures as low as −60° C., optionally at temperatures as low as −70° C.

Example devices which may be useful in some (but not all) embodiments include the Sense Fit 400 from Omni-ID and the PinPoint Argos GPS.

The pharmaceutical packages may comprise vials or syringes, each of which contains an injectable pharmaceutical formulation. In some embodiments, the pharmaceutical packages may have one or more of the authentication and/or tracing technology described herein.

In some embodiments, the shipping case may hold between about 200 and about 500 vials or syringes (or cartridges). The vials or syringes may be contained within a plurality of boxes, which may then be contained within the shipping case. In some embodiments, each of the boxes may hold between about 20 and about 40 vials or syringes.

The container may include a bottom wall, one or more and optionally a plurality of sidewalls, and a top wall. The top wall may be removable. In other words, the top wall may be a removable cover or lid. Alternatively, the top wall may comprise a plurality of portions, e.g. flaps, each of which is hinged to the upper end of one of the plurality of sidewalls and which may be moved between closed and open positions.

The container may be made of corrugated fiberboard, also known as corrugated cardboard or corrugated paperboard. A panel of corrugated fiberboard is generally made up of a central fluted portion, an outer liner, and an inner liner. Because it is desirable to minimize particles from coming into contact with pharmaceutical packages of the sort described herein, in some embodiments the corrugated fiberboard may have
a coating or additive that reduces particle attraction. In other embodiments, the container may be made of corrugated plastic. In yet other embodiments, the container may be made of a polymer-fiber composite material.

The tag may be positioned in or on the shipping case in any of a variety of manners. In some embodiments, the tag may be directly positioned in or on the container while in other embodiments, the tag may be contained in a protective pouch which may then be positioned in or on the container. In some embodiments, the tag or pouch may simply be placed in the interior space of the container, such as beneath one or more of the plurality of boxes containing the vials or syringes. In other embodiments, the tag or pouch may be affixed to an interior surface of the container, such as an interior surface of one of the one or more sidewalls, an interior surface of the bottom wall, or an interior surface of the top wall. In some embodiments, for instance, the tag or pouch may be affixed to an interior surface of the container by an adhesive label. Additionally or alternatively, an interior surface of the container may comprise a pocket or recess in which the tag or pouch is positioned. In some embodiments, the tag or pouch may be affixed to the container, and desirably to an interior surface of the container, by a tamper-evident element. In that manner, removal of the tag or attempted removal of the tag would be evident. In some embodiments, the tag may be affixed to the container in such a manner that removal of the tag would result in the transmission of an alert.

In some embodiments, the tag or pouch may be integrated into the container, e.g. into the bottom wall, one of the one or more sidewalls, or the top wall of the container. For instance, the tag or pouch may be positioned, e.g. sandwiched, between the inner and outer liners of a corrugated fiberboard. For instance the central fluted portion may be provided with a recess into which the tag or pouch may be positioned before the inner and/or outer liner is applied. In other embodiments, a wall of the container may be provided with a recess into which the tag or pouch may be positioned. The tag or pouch may then optionally be covered, e.g. by a closure element having the same material as the wall, by an adhesive label, or the like.

Embodiments of the present disclosure are directed to methods of tracking the position, temperature, or both of pharmaceutical products. The method may include providing a shipping case having an intelligent tag as described herein, and using that tag to track the location of the shipping case, the temperature of the shipping case, or both (i) and (ii) at one or more times, and optionally a numerous times, throughout the supply chain of the pharmaceutical packages.

The method may include tracking the temperature of the shipping case to determine whether the temperature exceeds a predefined threshold temperature, such as an upper limit of permissible shelf-life temperatures for the pharmaceutical formulation contained within the plurality of pharmaceutical packages, a lower limit of permissible shelf-life temperatures for the pharmaceutical formulation, or both.

The method may include tracking the location of the shipping case, such as to identify whether and/or when a shipping case is relocated or diverted.

In some embodiments, the tag may transmit the location data, the temperature data, or both at predefined intervals of time. In some embodiments, for instance, the tag may transmit the location data, the temperature data, or both at least once per day, optionally at least once per 12 hours, optionally at least once per 8 hours, optionally at least once per 4 hours, optionally at least once per 2 hours, optionally at least once per hour, optionally at least once per half-hour.

In some embodiments, the tag may transmit at least the location data if the location of the shipping case changes or if the location of the shipping case changes by at least a minimum distance (e.g. at least 1 mile, at least 5 miles, etc.). In other embodiments, the tag may transmit at least the location data if the location of the shipping case corresponds with one or more predefined areas (e.g. if the shipping case is received at a predefined facility).

In some embodiments, the tag may transmit at least the temperature data any time the temperature of the shipping case changes or anytime the temperature of the shipping case changes by at least a minimum amount (e.g. at least 0.5° C., at least 1.0° C., at least 2.0° C., etc.). In other embodiments, the tag may transmit at least the temperature data if the temperature of the shipping case exceeds a predefined threshold value, optionally an upper limit of permissible shelf-life temperatures for the pharmaceutical formulation contained therein, a lower limit of permissible shelf-life temperatures for the pharmaceutical formulation, or both.

In some embodiments, the tracking may be performed in real time. For example, the location, temperature, or both of the shipping case may be detected and broadcast and the data may be viewed in real time to identify the current location and/or temperature of the pharmaceutical packages. In some embodiments, the real-time location data, temperature data, or both may be accessed and viewed at any time.

In some embodiments, the tag may transmit the data by satellite network, Wi-Fi network, cellular phone network, short-range wireless technology (e.g. Bluetooth), or any combination thereof. In some embodiments, the data may be viewed using a mobile application (“app”) installed on a laptop, tablet, and/or smartphone. In some embodiments, the data may be viewed using any Internet-accessible device.

In some embodiments, the method may further comprise receiving an alert if the shipping case enters one or more predefined areas, leaves one or more predefined areas, or both. Similarly, in some embodiments, the method may further comprise receiving an alert if the temperature of the shipping case exceeds a predefined threshold value, optionally an upper limit of permissible shelf-life temperatures for the pharmaceutical formulation contained therein, a lower limit of permissible shelf-life temperatures for the pharmaceutical formulation, or both. The alert may be received in any of a number of ways. In some embodiments, the alert may be received via mobile phone text message.

In some embodiments, the method may further comprise maintaining the location data in a database so that a location history of the shipping case is available.

In some embodiments, the tracking may be performed by an intended recipient of the shipping case, by a sender of the shipping case, or both. The method may further comprise diverting the shipping case if it is found that the temperature exceeded the predefined threshold, optionally if it is found that the temperature exceeded the predefined threshold for a predefined period of time. Similarly, the method may further comprise diverting the shipping case in response to an identified location of the shipping case.

### Example Embodiments

1. A pharmaceutical package comprising:
   a vessel defining a lumen,
   a pharmaceutical formulation, optionally a pharmaceutical solution, optionally an injectable pharmaceutical solution, within the lumen, a closure, and
   wave-shifting crystals, optionally rare earth doped crystals, optionally wave-shifting nanoparticle crystals, optionally rare earth doped nanoparticle crystals, configured to emit light having one or more characteristics by which the package may be identified.
2. The pharmaceutical package of any preceding embodiment, wherein the vessel is a syringe barrel, a cartridge, a vial, or a blister pack.
3. The pharmaceutical package of any preceding embodiment, wherein the wave-shifting crystals, optionally wave-shifting nanoparticle crystals, optionally rare earth doped nanoparticle crystals are incorporated into a wall of the vessel.
4. The pharmaceutical package of any preceding embodiment, wherein the vessel comprises at least one wall made of a thermoplastic material.
5. The pharmaceutical package of any preceding embodiment, wherein the thermoplastic material comprises one or more of the following: polypropylene, polyethylene, COP, COC, or CBC.

### Embedded in Wall of Thermoplastic Vessel

6. The pharmaceutical package of any preceding embodiment, in which the wave-shifting crystals, optionally wave-shifting nanoparticle crystals, optionally rare earth doped nanoparticle crystals are embedded in the at least one wall made of a thermoplastic material.
7. The pharmaceutical package of any preceding embodiment, in which the wave-shifting crystals, optionally wave-shifting nanoparticle crystals, optionally rare earth doped nanoparticle crystals do not refract light.
8. The pharmaceutical package of any preceding embodiment, in which the wall containing the wave-shifting crystals, optionally wave-shifting nanoparticle crystals, optionally rare earth doped nanoparticle crystals is transparent.
9. The pharmaceutical package of any preceding embodiment, in which the wall containing the wave-shifting crystals, optionally wave-shifting nanoparticle crystals, optionally rare earth doped nanoparticle crystals has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
10. The pharmaceutical package of any preceding embodiment, wherein the vessel is blow molded, optionally injection stretch blow molded, from a thermoplastic resin that contains the wave-shifting crystals, optionally wave-shifting nanoparticle crystals, optionally rare earth doped nanoparticle crystals.
11. The pharmaceutical package of any preceding embodiment, in which the vessel is a vial, optionally a 2 ml vial, a 6 ml vial, a 10 ml vial, or a 20 ml vial.
12. The pharmaceutical package of any preceding embodiment, wherein the vessel is injection molded from a thermoplastic resin that contains the wave-shifting crystals, optionally wave-shifting nanoparticle crystals, optionally rare earth doped nanoparticle crystals.
13. The pharmaceutical package of any preceding embodiment, in which the vessel is a syringe barrel.
14. The pharmaceutical package of any preceding embodiment, in which the wave-shifting crystals, optionally wave-shifting nanoparticle crystals, optionally rare earth doped nanoparticle crystals have dimensions/diameters 10 microns or less, alternatively 8 microns or less, alternatively 5 microns or less, alternatively 2 microns or less, alternatively 1 micron or less, alternatively 800 nm or less, alternatively 600 nm or less, alternatively 500 nm or less, alternatively 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.
15. The pharmaceutical package of any preceding embodiment, in which the wave-shifting crystals, optionally wave-shifting nanoparticle crystals, optionally rare earth doped nanoparticle crystals are present in the wall of the vessel in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
16. The pharmaceutical package of any preceding embodiment, in which the wave-shifting crystals, optionally wave-shifting nanoparticle crystals, optionally rare earth doped nanoparticle crystals do not leach from the vessel wall.
17. The pharmaceutical package of any preceding embodiment, in which at least a portion of the thermoplastic vessel wall comprises two or more layers, wherein at least one of the two or more layers is free of the wave-shifting crystals, optionally wave-shifting nanoparticle crystals, optionally rare earth doped nanoparticle crystals, and at least one of the two or more layers contains the wave-shifting crystals, optionally wave-shifting nanoparticle crystals, optionally rare earth doped nanoparticle crystals.
18. The pharmaceutical package of any preceding embodiment, in which at least a portion of the thermoplastic wall includes an in-mold label containing the wave-shifting crystals, optionally wave-shifting nanoparticle crystals, optionally rare earth doped nanoparticle crystals.
19. The pharmaceutical package of any preceding embodiment, in which at least a portion of the thermoplastic wall includes an in-mold component containing the wave-shifting crystals, optionally wave-shifting nanoparticle crystals, optionally rare earth doped nanoparticle crystals.
20. The pharmaceutical package of any preceding embodiment, in which the wave-shifting crystals, optionally wave-shifting nanoparticle crystals, optionally rare earth doped nanoparticle crystals are configured and present in an amount sufficient such that, when excited, the emission is detectable/readable by a mobile reader.

### Incorporation in Non-Transparent Area of Vessel/Package

21. The pharmaceutical package of any preceding embodiment, wherein the pharmaceutical package comprises one or more non-transparent areas and wherein the wave-shifting crystals, optionally wave-shifting nanoparticle crystals, optionally rare earth doped nanoparticle crystals are present in at least one of the non-transparent areas.
22. The pharmaceutical package of any preceding embodiment, wherein the vessel is a vial and a base of the vial comprises the non-transparent area in which the wave-shifting crystals, optionally wave-shifting nanoparticle crystals, optionally rare earth doped nanoparticle crystals are present.
23. The pharmaceutical package of any preceding embodiment, wherein the vessel is a syringe barrel and a flange of the syringe barrel comprises the non-transparent area in which the wave-shifting crystals, optionally wave-shifting nanoparticle crystals, optionally rare earth doped nanoparticle crystals are present.
24. The pharmaceutical package of any preceding embodiment, wherein the vessel is a vial and the closure comprises a seal, optionally a flip-off seal, that is the non-transparent area in which the wave-shifting crystals, optionally wave-shifting nanoparticle crystals, optionally rare earth doped nanoparticle crystals are present.
25. The pharmaceutical package of any preceding embodiment, wherein the vessel is a syringe barrel and the package further comprises:
   a. a plunger rod that is the non-transparent area in which the wave-shifting crystals, optionally wave-shifting nanoparticle crystals, optionally rare earth doped nanoparticle crystals are present, and/or
   b. a needle shield or tip cap that is the non-transparent area in which the wave-shifting crystals, optionally wave-shifting nanoparticle crystals, optionally rare earth doped nanoparticle crystals are present.
26. The pharmaceutical package of any preceding embodiment, in which the wave-shifting crystals, optionally wave-shifting nanoparticle crystals, optionally rare earth doped nanoparticle crystals are applied to or embedded in at least one of the non-transparent areas.
27. The pharmaceutical package of any preceding embodiment, in which the wave-shifting crystals, optionally wave-shifting nanoparticle crystals, optionally rare earth doped nanoparticle crystals are blended into a thermoplastic material that makes up at least a portion of the non-transparent area.
28. The pharmaceutical package of any preceding embodiment, in which the wave-shifting crystals, optionally wave-shifting nanoparticle crystals, optionally rare earth doped nanoparticle crystals are blended into an ink and applied to a portion of the package to produce the non-transparent area.
29. The pharmaceutical package of any preceding embodiment, wherein the one or more non-transparent areas comprise text, a scannable code, or a geometric shape, optionally in which the scannable code is a bar code or QR code.
30. The pharmaceutical package of any preceding embodiment, wherein the one or more non-transparent areas are channels or recesses burned into the vessel wall by a laser.
31. The pharmaceutical package of any preceding embodiment, wherein the one or more non-transparent areas are embossed on the vessel, optionally wherein the vessel is a vial and the one or more non-transparent areas are embossed on a base of the vial.
32. The pharmaceutical package of any preceding embodiment, wherein the one or more non-transparent areas provide sufficient contrast with the transparent vessel wall to be read by the human eye, a camera of a smartphone or tablet, or a conventional scanner.
33. The pharmaceutical package of any preceding embodiment, wherein the one or more non-transparent areas are gray-scale or black.
34. The pharmaceutical package of any preceding embodiment, wherein the wave-shifting crystals, optionally wave-shifting nanoparticle crystals, optionally rare earth doped nanoparticle crystals are applied to or embedded in the channels or recesses.
35. The pharmaceutical package of any preceding embodiment, wherein the scannable code and the wave-shifting crystals, optionally wave-shifting nanoparticle crystals, optionally rare earth doped nanoparticle crystals are configured to be interrogated by a smart phone or tablet, and capable of being detected by a camera of the smart phone or tablet.
36. The pharmaceutical package of any preceding embodiment, wherein the wave-shifting crystals, optionally wave-shifting nanoparticle crystals, optionally rare earth doped nanoparticle crystals have diameters less than 500 microns, optionally between about 1-500 microns, optionally from about 10-500 microns, optionally from about 50-500 microns, optionally from about 100-500 microns, optionally from about 1-200 microns, optionally from about 10-200 microns, optionally from about 50-200 microns, optionally from about 50-100 microns.

### Glass Vessels

37. The pharmaceutical package of any preceding embodiment, wherein the vessel comprises at least one wall made of glass, optionally borosilicate glass or aluminosilicate glass, optionally borosilicate glass, optionally Type 1 borosilicate glass, optionally aluminosilicate glass, optionally Type 1 aluminosilicate glass.
38. The pharmaceutical package of any preceding embodiment, in which the wave-shifting crystals, optionally wave-shifting nanoparticle crystals, optionally rare earth doped nanoparticle crystals are embedded in the at least one wall made of glass.

### Secondary Packaging

39. The pharmaceutical package of any preceding embodiment, wherein the package further comprises secondary packaging and the wave-shifting crystals, optionally wave-shifting nanoparticle crystals, optionally rare earth doped nanoparticle crystals are incorporated into the secondary packaging.
40. The pharmaceutical package of any preceding embodiment, wherein the secondary packaging comprises a film covering, a flexible pouch, a box, a carton, a tray, or the like.

### Coatings and Inks

41. The pharmaceutical package of any preceding embodiment, further comprising a coating on at least a portion of at least one wall of the vessel.
42. The pharmaceutical package of any preceding embodiment, in which the coating is present on an interior surface of the at least one wall.
43. The pharmaceutical package of any preceding embodiment, in which the coating is present on an exterior surface of the at least one wall.
44. The pharmaceutical package of any preceding embodiment, in which the coating is configured to provide the vessel with improved gas barrier properties.
45. The pharmaceutical package of any preceding embodiment, in which the coating is configured to provide the interior surface of the at least one wall with improved lubricity properties.
46. The pharmaceutical package of any preceding embodiment, in which the coating is configured to contact the pharmaceutical solution within the lumen.
47. The pharmaceutical package of any preceding embodiment, in which the coating is configured to reduce aggregation of one or more components of the pharmaceutical solution.
48. The pharmaceutical package of any preceding embodiment, in which the coating is applied by chemical vapor deposition (CVD) or atomic layer deposition (ALD), optionally CVD, optionally ALD.
49. The pharmaceutical package of any preceding embodiment, in which the coating comprises one or more layers having the composition Si_{w}OₓC_{y} or Si_{w}NₓC_{y}, where w is 1, x is from about 0.5 to 2.4, and y is from about 0.6 to about 3, as determined by XPS.
50. The pharmaceutical package of any preceding embodiment, in which the coating comprises one or more layers having the composition SiOₓ, wherein x is from 1.5 to 2.9.
51. The pharmaceutical package of any preceding embodiment, in which the coating comprises one or more metal oxide layers, optionally one or more metal oxide layers having the composition Al2O3, AlxTiyOz, HfO2, In2O3, MgO, SiO2, SrTiOx, Ta2O5, TiO2, Y2O3, ZnO, ZnO:Al, ZrO2, La2O3, or CeO2, optionally one or more metal oxide layers having the composition Al2O3.
52. The pharmaceutical package of any preceding embodiment, in which the coating is applied by wet solution deposition.
53. The pharmaceutical package of any preceding embodiment, in which the wave-shifting crystals, optionally wave-shifting nanoparticle crystals, optionally rare earth doped nanoparticle crystals are incorporated into the coating.
54. The pharmaceutical package of any preceding embodiment, in which the at least one wall of the vessel having the coating in which the wave-shifting crystals, optionally wave-shifting nanoparticle crystals, optionally rare earth doped nanoparticle crystals are incorporated is transparent.
55. The pharmaceutical package of any preceding embodiment, in which the wall having the coating in which the wave-shifting crystals, optionally wave-shifting nanoparticle crystals, optionally rare earth doped nanoparticle crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
56. The pharmaceutical package of any preceding embodiment, in which the wave-shifting crystals, optionally wave-shifting nanoparticle crystals, optionally rare earth doped nanoparticle crystals are present in the coating in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
57. The pharmaceutical package of any preceding embodiment, in which the wave-shifting crystals, optionally wave-shifting nanoparticle crystals, optionally rare earth doped nanoparticle crystals are present in an ink, and at least a portion of a vessel wall comprises the ink.
58. The pharmaceutical package of any preceding embodiment, in which the ink is applied to an exterior wall of the vessel.
59. The pharmaceutical package of any preceding embodiment, in which the ink is transparent.
60. The pharmaceutical package of any preceding embodiment, in which the wall having the ink in which the wave-shifting crystals, optionally wave-shifting nanoparticle crystals, optionally rare earth doped nanoparticle crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
61. The pharmaceutical package of any preceding embodiment, in which the ink is holographic.
62. The pharmaceutical package of any preceding embodiment, in which the ink is applied to the at least a portion of the vessel in a predetermined pattern.
63. The pharmaceutical package of any preceding embodiment, in which the ink is applied in a scannable coded pattern, optionally a bar code or QR code.
64. The pharmaceutical package of any preceding embodiment, in which the wave-shifting crystals, optionally wave-shifting nanoparticle crystals, optionally rare earth doped nanoparticle crystals are present in the ink in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
65. The pharmaceutical package of any preceding embodiment, in which the coating or ink is applied to the vessel by inkjet printing.
66. The pharmaceutical package of any preceding embodiment, in which the coating or ink is applied to the vessel by pad printing.

### Labels

67. The pharmaceutical package of any preceding embodiment, in which the wave-shifting crystals, optionally wave-shifting nanoparticle crystals, optionally rare earth doped nanoparticle crystals are present in a label, optionally an adhesive label, and at least a portion of the vessel or closure comprises the label.
68. The pharmaceutical package of any preceding embodiment, in which the label is adhered to an exterior wall of the vessel.
69. The pharmaceutical package of any preceding embodiment, in which the label is transparent.
70. The pharmaceutical package of any preceding embodiment, in which the wall having the label in which the wave-shifting crystals, optionally wave-shifting nanoparticle crystals, optionally rare earth doped nanoparticle crystals are present has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
71. The pharmaceutical package of any preceding embodiment, in which at least a portion of the label is holographic.
72. The pharmaceutical package of any preceding embodiment, in which the wave-shifting crystals, optionally wave-shifting nanoparticle crystals, optionally rare earth doped nanoparticle crystals are present in a portion of the label in a predetermined pattern.
73. The pharmaceutical package of any preceding embodiment, in which the wave-shifting crystals, optionally wave-shifting nanoparticle crystals, optionally rare earth doped nanoparticle crystals are present in a portion of the label in a scannable coded pattern, optionally a bar code or QR code.
74. The pharmaceutical package of any preceding embodiment, in which the wave-shifting crystals, optionally wave-shifting nanoparticle crystals, optionally rare earth doped nanoparticle crystals are present in a portion of the label in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

### Laser Inscribed

75. The pharmaceutical package of any preceding embodiment, wherein a portion of the vessel or closure is etched, optionally laser etched, to produce a recess and the wave-shifting crystals, optionally wave-shifting nanoparticle crystals, optionally rare earth doped nanoparticle crystals are incorporated into at least a portion of a recess.
76. The pharmaceutical package of any preceding embodiment, wherein etching forms a recess having a predetermined pattern.
77. The pharmaceutical package of any preceding embodiment, in which the predetermined pattern comprises a scannable coded pattern, optionally a bar code or QR code.
78. The pharmaceutical package of any preceding embodiment, in which a polymeric resin comprising the wave-shifting crystals, optionally wave-shifting nanoparticle crystals, optionally rare earth doped nanoparticle crystals is positioned in the recess.
79. The pharmaceutical package of any preceding embodiment, in which the polymeric resin comprises an epoxy; optionally in which the polymeric resin is an epoxy.
80. The pharmaceutical package of any preceding embodiment, in which the vessel is a vial and the recess is located on a base of the vial.
81. The pharmaceutical package of any preceding embodiment, in which the vessel is a syringe barrel and the recess is located on a flange of the syringe barrel.
82. The pharmaceutical package of any preceding embodiment, in which the wave-shifting crystals, optionally wave-shifting nanoparticle crystals, optionally rare earth doped nanoparticle crystals are present in the polymeric resin in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

### The Crystals

83. The pharmaceutical package of any preceding embodiment, in which the wave-shifting crystals, optionally wave-shifting nanoparticle crystals, optionally rare earth doped nanoparticle crystals are luminescent.
84. The pharmaceutical package of any preceding embodiment, in which the wave-shifting crystals, optionally wave-shifting nanoparticle crystals, optionally rare earth doped nanoparticle crystals are configured/tuned to react/luminesce to one or more specific wavelengths of light.
85. The pharmaceutical package of any preceding embodiment, in which the wave-shifting crystals, optionally wave-shifting nanoparticle crystals, optionally rare earth doped nanoparticle crystals are configured/tuned to luminesce in response to light having a wavelength within the ultraviolet spectrum, light having a wavelength within the visible spectrum, light having a wavelength within the infrared spectrum, or any combination thereof.
86. The pharmaceutical package of any preceding embodiment, in which the wave-shifting crystals, optionally wave-shifting nanoparticle crystals, optionally rare earth doped nanoparticle crystals are configured/tuned to luminesce solely in response to light having a wavelength within the ultraviolet spectrum.
87. The pharmaceutical package of any preceding embodiment, in which the wave-shifting crystals, optionally wave-shifting nanoparticle crystals, optionally rare earth doped nanoparticle crystals are configured/tuned to luminesce solely in response to light having a wavelength within the visible spectrum.
88. The pharmaceutical package of any preceding embodiment, in which the wave-shifting crystals, optionally wave-shifting nanoparticle crystals, optionally rare earth doped nanoparticle crystals are configured/tuned to luminesce solely in response to light having a wavelength within the infrared spectrum.
89. The pharmaceutical package of any preceding embodiment, in which the wave-shifting crystals, optionally wave-shifting nanoparticle crystals, optionally rare earth doped nanoparticle crystals are configured/tuned to luminesce only in response to light having a wavelength within a defined wavelength range.
90. The pharmaceutical package of any preceding embodiment, in which the wave-shifting crystals, optionally wave-shifting nanoparticle crystals, optionally rare earth doped nanoparticle crystals are cathodoluminescent.
91. The pharmaceutical package of any preceding embodiment, in which the wave-shifting crystals, optionally wave-shifting nanoparticle crystals, optionally rare earth doped nanoparticle crystals are down-converting phosphors.
92. The pharmaceutical package of any preceding embodiment, in which the wave-shifting crystals, optionally wave-shifting nanoparticle crystals, optionally rare earth doped nanoparticle crystals are up-converting phosphors.
93. The pharmaceutical package of any preceding embodiment, in which the wave-shifting crystals, optionally wave-shifting nanoparticle crystals, optionally rare earth doped nanoparticle crystals are configured/tuned to produce an emission in one or more defined wavelength bands/ranges.
94. The pharmaceutical package of any preceding embodiment, in which the wave-shifting crystals, optionally wave-shifting nanoparticle crystals, optionally rare earth doped nanoparticle crystals are configured/tuned to have a defined rise time, decay time, or both.
95. The pharmaceutical package of any preceding embodiment, in which the wave-shifting crystals, optionally wave-shifting nanoparticle crystals, optionally rare earth doped nanoparticle crystals are configured/tuned to produce an emission having an intensity within a defined range.
96. The pharmaceutical package of any preceding embodiment, in which the wave-shifting crystals, optionally wave-shifting nanoparticle crystals, optionally rare earth doped nanoparticle crystals are configured/tuned to produce an emission having dimensions within a defined range.
97. The pharmaceutical package of any preceding embodiment, in which the wave-shifting crystals, optionally wave-shifting nanoparticle crystals, optionally rare earth doped nanoparticle crystals are configured and present in an amount sufficient such that their luminescence is detectable by a hand-held pharmaceutical package authentication device, an industrial pharmaceutical package authentication device, optionally a mobile authentication device, optionally a smartphone or similar device, or any combination of devices.
98. The pharmaceutical package of any preceding embodiment, in which the authentication device interrogates the pharmaceutical package using one or more discrete wavelengths.
99. The pharmaceutical package of any preceding embodiment, in which the wave-shifting crystals, optionally wave-shifting nanoparticle crystals, optionally rare earth doped nanoparticle crystals have dimensions/diameters between about 10 nm and about 1,500 nm, alternatively between about 10 nm and about 1,000 nm, alternatively between about 10 nm and about 500 nm, alternatively between about 10 nm and about 250 nm, alternatively between about 10 nm and about 100 nm, alternatively between about 10 nm and about 50 nm, alternatively between about 100 and 1,500 nm, alternatively between about 100 and 1,000 nm, alternatively between about 200 and 1,500 nm, alternatively between about 200 and about 1,000 nm.
100. The pharmaceutical package of any preceding embodiment, in which the wave-shifting crystals, optionally wave-shifting nanoparticle crystals, optionally rare earth doped nanoparticle crystals have dimensions/diameters 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.
101. The pharmaceutical package of any preceding embodiment, in which the wave-shifting crystals are rare earth doped crystals.
102. The pharmaceutical package of any preceding embodiment, in which the wave-shifting crystals are wave-shifting nanoparticle crystals.
103. The pharmaceutical package of any preceding embodiment, in which the wave-shifting crystals are rare earth doped nanoparticle crystals.
104. The pharmaceutical package of any preceding embodiment, in which the rare earth doped crystals, optionally rare earth doped nanoparticle crystals, comprise a rare earth element-containing lattice and a dopant.
105. The pharmaceutical package of any preceding embodiment, in which the dopant comprises a rare earth element, and
   wherein the rare earth element-containing lattice contains a first rare earth element and the dopant comprises a second rare earth element, whereby the second rare earth element differs from the first rare earth element.
106. The pharmaceutical package of any preceding embodiment, in which the first rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.
107. The pharmaceutical package of any preceding embodiment, in which the second rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.
108. The pharmaceutical package of any preceding embodiment, in which the dopant comprises two or more different rare earth elements.
109. The pharmaceutical package of any preceding embodiment, wherein the lattice comprises NaYF₄.
110. The pharmaceutical package of any preceding embodiment, wherein the dopant comprises Yb and a second rare earth element.
111. The pharmaceutical package of any preceding embodiment, wherein the dopant comprises one of the following combinations: Er and Yb; Tm and Yb, Nd and Yb, Ho and Yb, or Pr and Yb.
112. The pharmaceutical package of any preceding embodiment, in which the rare earth doped crystals, optionally the rare earth doped nanoparticles, comprise a lattice and one or more rare earth element dopants.
113. The pharmaceutical package of any preceding embodiment, in which the lattice comprises NaLiF.
114. The pharmaceutical package of any preceding embodiment, in which the dopant comprises Nd or Pr.
115. The pharmaceutical package of any preceding embodiment, in which the lattice comprises Y2O3.
116. The pharmaceutical package of any preceding embodiment, in which the the dopant comprises Er and Yb.
117. The pharmaceutical package of any preceding embodiment, in which the lattice comprises Gd, optionally Gd₂SO₂ or Gd₂O₃.
118. The pharmaceutical package of any preceding embodiment, in which the wave-shifting crystal comprises one or more of Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er.
119. The pharmaceutical package of any preceding embodiment, in which the rare earth doped crystals have a polyhedral morphology.
120. The pharmaceutical package of any preceding embodiment, in which the rare earth doped crystals have a uniform morphology.
121. The pharmaceutical package of any preceding embodiment, in which the wave-shifting crystals, optionally wave-shifting nanoparticle crystals, optionally rare earth doped nanoparticle crystals are configured to produce an emission in response to interrogation by a device, optionally a smartphone, having an IR illuminator, a VCSEL, an LED light, or a combination thereof.
122. The pharmaceutical package of any preceding embodiment, in which the wave-shifting crystals, optionally wave-shifting nanoparticle crystals, optionally rare earth doped nanoparticle crystals are configured and present in an amount to produce an emission that is readable by a device, optionally a smartphone, having a CMOS sensor or CMOS camera.
123. The pharmaceutical package of any preceding embodiment, in which the wave-shifting crystals, optionally wave-shifting nanoparticle crystals, optionally rare earth doped nanoparticle crystals are of a uniform or substantially uniform size, in which substantially uniform means within a tolerance of about 10 nm or less.
124. The pharmaceutical package of any preceding embodiment, wherein the pharmaceutical solution is an injectable drug-containing solution.
125. The pharmaceutical package of any preceding embodiment, wherein the pharmaceutical package is a pre-filled syringe, a vial, or a cartridge, optionally a pre-filled syringe, optionally a vial, optionally a cartridge.
126. The pharmaceutical package of any preceding embodiment, wherein the pharmaceutical package is a vial and wherein the wave-shifting crystals, optionally wave-shifting nanoparticle crystals, optionally rare earth doped nanoparticle crystals are present in or on the bottom wall of the vial.
127. The pharmaceutical package of any preceding embodiment, wherein the pharmaceutical package has been subjected to sterilization, optionally sterilization by irradiation, optionally sterilization by gas.
128. The pharmaceutical package of any preceding embodiment, wherein the wave-shifting crystals, optionally wave-shifting nanoparticle crystals, optionally rare earth doped nanoparticle crystals are configured to withstand sterilization of the pharmaceutical package, optionally sterilization by irradiation, optionally sterilization by gas.
129. The pharmaceutical package of any preceding embodiment, wherein the pharmaceutical package has been subjected to autoclaving at a temperature of 120° C. or higher.
130. The pharmaceutical package of any preceding embodiment, wherein the wave-shifting crystals, optionally wave-shifting nanoparticle crystals, optionally rare earth doped nanoparticle crystals are configured to withstand autoclaving at a temperature of 120° C. or higher.
131. The pharmaceutical package of any preceding embodiment, wherein the pharmaceutical package has been subjected to a lyophilization freeze-drying cycle.
132. The pharmaceutical package of any preceding embodiment, wherein the wave-shifting crystals, optionally wave-shifting nanoparticle crystals, optionally rare earth doped nanoparticle crystals are configured to withstand a lyophilization freeze-drying cycle.
133. The pharmaceutical package of any preceding embodiment, wherein the pharmaceutical package has been subjected to a temperature at or below −20° C., optionally a temperature at or below −30° C., optionally a temperature at or below −40° C., optionally a temperature at or below −50° C., optionally a temperature at or below −60° C., optionally a temperature at or below −70° C.
134. The pharmaceutical package of any preceding embodiment, wherein the wave-shifting crystals, optionally wave-shifting nanoparticle crystals, optionally rare earth doped nanoparticle crystals are configured to withstand being subjected to a temperature at or below −20° C., optionally a temperature at or below −30° C., optionally a temperature at or below −40° C., optionally a temperature at or below −50° C., optionally a temperature at or below −60° C., optionally a temperature at or below −70° C.
135. The pharmaceutical package of any preceding embodiment, wherein the wave-shifting crystals, optionally wave-shifting nanoparticle crystals, optionally rare earth doped nanoparticle crystals are configured to operate as a temperature indicator, a pressure sensor, or both.
136. A plurality of pharmaceutical packages of any preceding embodiment, in which the wave-shifting crystals, optionally wave-shifting nanoparticle crystals, optionally rare earth doped nanoparticle crystals in a first package or first plurality of packages has a first optical property when interrogated and a second package or second plurality of packages has a second optical property when interrogated, the second optical property being different from the first optical property such that the first package or plurality of packages and the second package or plurality of packages can be distinguished from one another.
137. The plurality of pharmaceutical packages of any preceding embodiment, in which the wave-shifting crystals, optionally wave-shifting nanoparticle crystals, optionally rare earth doped nanoparticle crystals in a third package or third plurality of packages has a third optical property when interrogated, the third optical property being different from the first optical property and the second optical property such that the third package or plurality of packages can be distinguished from the first and second package or plurality of packages.
138. The plurality of pharmaceutical packages of any preceding embodiment, in which the wave-shifting crystals, optionally wave-shifting nanoparticle crystals, optionally rare earth doped nanoparticle crystals in a fourth package or fourth plurality of packages has a fourth optical property when interrogated, the fourth optical property being different from the first optical property, the second optical property, and the third optical property such that the fourth package or plurality of packages can be distinguished from the first, second, and third package or plurality of packages.
139. The plurality of pharmaceutical packages of any preceding embodiment, in which the wave-shifting crystals, optionally wave-shifting nanoparticle crystals, optionally rare earth doped nanoparticle crystals in a fifth package or fifth plurality of packages has a fifth optical property when interrogated, the fifth optical property being different from the first, second, third, and fourth optical property such that the fifth package or plurality of packages can be distinguished from the first, second, third, and fourth package or plurality of packages.
140. The plurality of pharmaceutical packages of any preceding embodiment, in which the first and second; optionally the first, second, and third; optionally the first, second, third, and fourth; optionally the first, second, third, fourth, and fifth optical properties is each associated with a nation or region of the world.
141. The plurality of pharmaceutical packages of any preceding embodiment, in which the wave-shifting crystals, optionally wave-shifting nanoparticle crystals, optionally rare earth doped nanoparticle crystals, in each of the first and second; optionally the first, second, and third; optionally the first, second, third, and fourth; optionally the first, second, third, fourth, and fifth packages or plurality of packages can be interrogated and the emission read by a smartphone, such that the associated packages or plurality of packages can be distinguished by the smartphone.
142. The plurality of pharmaceutical packages, wherein each of the wave-shifting crystals is a rare earth doped nanoparticle crystal.
143. The plurality of pharmaceutical packages, wherein a lattice for each rare earth doped nanoparticle crystal comprises NaYF₄.
144. The plurality of pharmaceutical packages of any preceding embodiment, wherein a dopant for each rare earth doped nanoparticle comprises Yb and a second rare earth element.
145. The pharmaceutical package of any preceding embodiment, wherein a dopant for each rare earth doped nanoparticle comprises one of the following combinations: Er and Yb; Tm and Yb, Nd and Yb, Ho and Yb, or Pr and Yb.
146. The plurality of pharmaceutical packages of any preceding embodiment, in which the first and second; optionally the first, second, and third; optionally the first, second, third, and fourth; optionally the first, second, third, fourth, and fifth optical properties is one of the following:
   a. a wavelength of an emission
   b. a size (i.e., dimensions) of an emission
   c. a power or intensity of an emission
   d. a rise time of an emission;
   e. a decay time of an emission;
   f. a wavelength and/or source of excitation light; or
   g. any combination thereof.

### Vessels (Prior to Filling)

147. A vessel configured to contain a pharmaceutical formulation, optionally a pharmaceutical solution, optionally an injectable pharmaceutical solution, within a lumen thereof and to be authenticated and/or traced by way of producing a light emission having one or more predetermined characteristics, comprising:
   a vessel defining a lumen,
   in which the vessel comprises wave-shifting crystals, optionally rare earth doped crystals, optionally wave-shifting nanoparticle crystals, optionally rare earth doped nanoparticle crystals configured to emit light having one or more characteristics by which the package may be identified.
148. The vessel of any preceding embodiment, wherein the vessel is a syringe barrel, a cartridge, a vial, or a blister pack.
149. The vessel of any preceding embodiment, wherein the wave-shifting crystals, optionally wave-shifting nanoparticle crystals, optionally rare earth doped nanoparticle crystals are incorporated into a wall of the vessel.
150. The vessel of any preceding embodiment, wherein the vessel comprises at least one wall made of a thermoplastic material.
151. The vessel of any preceding embodiment, wherein the thermoplastic material comprises one or more of the following: polypropylene, polyethylene, COP, COC, or CBC.
152. The vessel of any preceding embodiment, in which the wave-shifting crystals, optionally wave-shifting nanoparticle crystals, optionally rare earth doped nanoparticle crystals are embedded in the at least one wall made of a thermoplastic material.
153. The vessel of any preceding embodiment, in which the wave-shifting crystals, optionally wave-shifting nanoparticle crystals, optionally rare earth doped nanoparticle crystals do not refract light.
154. The vessel of any preceding embodiment, in which the wall containing the wave-shifting crystals, optionally wave-shifting nanoparticle crystals, optionally rare earth doped nanoparticle crystals is transparent.
155. The vessel of any preceding embodiment, in which the wall containing the wave-shifting crystals, optionally wave-shifting nanoparticle crystals, optionally rare earth doped nanoparticle crystals has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
156. The vessel of any preceding embodiment, wherein the vessel is blow molded, optionally injection stretch blow molded, from a thermoplastic resin that contains the wave-shifting crystals, optionally wave-shifting nanoparticle crystals, optionally rare earth doped nanoparticle crystals.
157. The vessel of any preceding embodiment, in which the vessel is a vial, optionally a 2 ml vial, a 6 ml vial, a 10 ml vial, or a 20 ml vial.
158. The vessel of any preceding embodiment, wherein the vessel is injection molded from a thermoplastic resin that contains the wave-shifting crystals, optionally wave-shifting nanoparticle crystals, optionally rare earth doped nanoparticle crystals.
159. The vessel of any preceding embodiment, in which the vessel is a syringe barrel.
160. The vessel of any preceding embodiment, in which the wave-shifting crystals, optionally wave-shifting nanoparticle crystals, optionally rare earth doped nanoparticle crystals have dimensions/diameters 10 microns or less, alternatively 8 microns or less, alternatively 5 microns or less, alternatively 2 microns or less, alternatively 1 micron or less, alternatively 800 nm or less, alternatively 600 nm or less, alternatively 500 nm or less, alternatively 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.
161. The vessel of any preceding embodiment, in which the wave-shifting crystals, optionally wave-shifting nanoparticle crystals, optionally rare earth doped nanoparticle crystals are present in the wall of the vessel in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
162. The vessel of any preceding embodiment, in which the wave-shifting crystals, optionally wave-shifting nanoparticle crystals, optionally rare earth doped nanoparticle crystals do not leach from the vessel wall.
163. The vessel of any preceding embodiment, in which at least a portion of the thermoplastic vessel wall comprises two or more layers, wherein at least one of the two or more layers is free of the wave-shifting crystals, optionally wave-shifting nanoparticle crystals, optionally rare earth doped nanoparticle crystals, and at least one of the two or more layers contains the wave-shifting crystals, optionally wave-shifting nanoparticle crystals, optionally rare earth doped nanoparticle crystals.
164. The vessel of any preceding embodiment, in which at least a portion of the thermoplastic wall includes an in-mold label containing the wave-shifting crystals, optionally wave-shifting nanoparticle crystals, optionally rare earth doped nanoparticle crystals.
165. The vessel of any preceding embodiment, in which at least a portion of the thermoplastic wall includes an in-mold component containing the wave-shifting crystals, optionally wave-shifting nanoparticle crystals, optionally rare earth doped nanoparticle crystals.
166. The vessel of any preceding embodiment, in which the wave-shifting crystals, optionally wave-shifting nanoparticle crystals, optionally rare earth doped nanoparticle crystals are configured and present in an amount sufficient such that, when excited, the emission is detectable/readable by a mobile reader.
167. The vessel of any preceding embodiment, wherein the vessel comprises one or more non-transparent areas and wherein the wave-shifting crystals, optionally wave-shifting nanoparticle crystals, optionally rare earth doped nanoparticle crystals are present in at least one of the non-transparent areas.
168. The vessel of any preceding embodiment, wherein the vessel is a vial and a base of the vial comprises the non-transparent area in which the wave-shifting crystals, optionally wave-shifting nanoparticle crystals, optionally rare earth doped nanoparticle crystals are present.
169. The vessel of any preceding embodiment, wherein the vessel is a syringe barrel and a flange of the syringe barrel comprises the non-transparent area in which the wave-shifting crystals, optionally wave-shifting nanoparticle crystals, optionally rare earth doped nanoparticle crystals are present.
170. The vessel of any preceding embodiment, wherein the vessel is a vial and the closure comprises a seal, optionally a flip-off seal, that is the non-transparent area in which the wave-shifting crystals, optionally wave-shifting nanoparticle crystals, optionally rare earth doped nanoparticle crystals are present.
171. The vessel of any preceding embodiment, wherein the vessel is a syringe barrel and the vessel further comprises:
   a. a plunger rod that is the non-transparent area in which the wave-shifting crystals, optionally wave-shifting nanoparticle crystals, optionally rare earth doped nanoparticle crystals are present, and/or
   b. a needle shield or tip cap that is the non-transparent area in which the wave-shifting crystals, optionally wave-shifting nanoparticle crystals, optionally rare earth doped nanoparticle crystals are present.
172. The vessel of any preceding embodiment, in which the wave-shifting crystals, optionally wave-shifting nanoparticle crystals, optionally rare earth doped nanoparticle crystals are applied to or embedded in at least one of the non-transparent areas.
173. The vessel of any preceding embodiment, in which the wave-shifting crystals, optionally wave-shifting nanoparticle crystals, optionally rare earth doped nanoparticle crystals are blended into a thermoplastic material that makes up at least a portion of the non-transparent area.
174. The vessel of any preceding embodiment, in which the wave-shifting crystals, optionally wave-shifting nanoparticle crystals, optionally rare earth doped nanoparticle crystals are blended into an ink and applied to a portion of the vessel to produce the non-transparent area.
175. The vessel of any preceding embodiment, wherein the one or more non-transparent areas comprise text, a scannable code, or a geometric shape, optionally in which the scannable code is a bar code or QR code.
176. The vessel of any preceding embodiment, wherein the one or more non-transparent areas are channels or recesses burned into the vessel wall by a laser.
177. The vessel of any preceding embodiment, wherein the one or more non-transparent areas are embossed on the vessel, optionally wherein the vessel is a vial and the one or more non-transparent areas are embossed on a base of the vial.
178. The vessel of any preceding embodiment, wherein the one or more non-transparent areas provide sufficient contrast with the transparent vessel wall to be detected by the human eye, a camera of a smartphone or tablet, or a conventional scanner.
179. The vessel of any preceding embodiment, wherein the one or more non-transparent areas are gray-scale or black
180. The vessel of any preceding embodiment, wherein the wave-shifting crystals, optionally wave-shifting nanoparticle crystals, optionally rare earth doped nanoparticle crystals are applied to or embedded in the channels or recesses.
181. The vessel of any preceding embodiment, wherein the scannable code and the wave-shifting crystals, optionally wave-shifting nanoparticle crystals, optionally rare earth doped nanoparticle crystals are configured to be interrogated by a smart phone or tablet and capable of being detected by a camera of the smart phone or tablet.
182. The vessel of any preceding embodiment, wherein the wave-shifting crystals, optionally wave-shifting nanoparticle crystals, optionally rare earth doped nanoparticle crystals have diameters less than 500 microns, optionally between about 1-500 microns, optionally from about 10-500 microns, optionally from about 50-500 microns, optionally from about 100-500 microns, optionally from about 1-200 microns, optionally from about 10-200 microns, optionally from about 50-200 microns, optionally from about 50-100 microns.
183. The vessel of any preceding embodiment, wherein the vessel comprises at least one wall made of glass, optionally borosilicate glass or aluminosilicate glass, optionally borosilicate glass, optionally Type 1 borosilicate glass, optionally aluminosilicate glass, optionally Type 1 aluminosilicate glass.
184. The vessel of any preceding embodiment, in which the wave-shifting crystals, optionally wave-shifting nanoparticle crystals, optionally rare earth doped nanoparticle crystals are embedded in the at least one wall made of glass.
185. The vessel of any preceding embodiment, in which the wall of the vessel in which the rare earth doped nanoparticle crystals are incorporated is transparent.
186. The vessel of any preceding embodiment, further comprising a coating on at least a portion of at least one wall of the vessel.
187. The vessel of any preceding embodiment, in which the coating is present on an interior surface of the at least one wall.
188. The vessel of any preceding embodiment, in which the coating is present on an exterior surface of the at least one wall.
189. The vessel of any preceding embodiment, in which the coating is configured to provide the vessel with improved gas barrier properties.
190. The vessel of any preceding embodiment, in which the coating is configured to provide the interior surface of the at least one wall with improved lubricity properties.
191. The vessel of any preceding embodiment, in which the coating is applied by chemical vapor deposition (CVD) or atomic layer deposition (ALD), optionally CVD, optionally ALD.
192. The vessel of any preceding embodiment, in which the coating comprises one or more layers having the composition Si_{w}OₓC_{y} or Si_{w}NₓC_{y}, where w is 1, x is from about 0.5 to 2.4, and y is from about 0.6 to about 3, as determined by XPS.
193. The vessel of any preceding embodiment, in which the coating comprises one or more layers having the composition SiOₓ, wherein x is from 1.5 to 2.9.
194. The vessel of any preceding embodiment, in which the coating comprises one or more metal oxide layers, optionally one or more metal oxide layers having the composition Al2O3, AlxTiyOz, HfO2, In2O3, MgO, SiO2, SrTiOx, Ta2O5, TiO2, Y2O3, ZnO, ZnO:Al, ZrO2, La2O3, or CeO2, optionally one or more metal oxide layers having the composition Al2O3.
195. The vessel of any preceding embodiment, in which the coating is applied by wet solution deposition.
196. The vessel of any preceding embodiment, in which the wave-shifting crystals, optionally wave-shifting nanoparticle crystals, optionally rare earth doped nanoparticle crystals are incorporated into the coating.
197. The vessel of any preceding embodiment, in which the at least one wall of the vessel having the coating in which the wave-shifting crystals, optionally wave-shifting nanoparticle crystals, optionally rare earth doped nanoparticle crystals are incorporated is transparent.
198. The vessel of any preceding embodiment, in which the wall having the coating in which the wave-shifting crystals, optionally wave-shifting nanoparticle crystals, optionally rare earth doped nanoparticle crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
199. The vessel of any preceding embodiment, in which the wave-shifting crystals, optionally wave-shifting nanoparticle crystals, optionally rare earth doped nanoparticle crystals are present in the coating in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
200. The vessel of any preceding embodiment, in which the wave-shifting crystals, optionally wave-shifting nanoparticle crystals, optionally rare earth doped nanoparticle crystals are present in an ink, and at least a portion of a vessel wall comprises the ink.
201. The vessel of any preceding embodiment, in which the ink is applied to an exterior wall of the vessel.
202. The vessel of any preceding embodiment, in which the ink is transparent.
203. The vessel of any preceding embodiment, in which the wall having the ink in which the wave-shifting crystals, optionally wave-shifting nanoparticle crystals, optionally rare earth doped nanoparticle crystals are incorporated has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
204. The vessel of any preceding embodiment, in which the ink is holographic.
205. The vessel of any preceding embodiment, in which the ink is applied to the at least a portion of the vessel in a predetermined pattern.
206. The vessel of any preceding embodiment, in which the ink is applied in a scannable coded pattern, optionally a bar code or QR code.
207. The vessel of any preceding embodiment, in which the wave-shifting crystals, optionally wave-shifting nanoparticle crystals, optionally rare earth doped nanoparticle crystals are present in the ink in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
208. The vessel of any preceding embodiment, in which the coating or ink is applied to the vessel by inkjet printing.
209. The vessel of any preceding embodiment, in which the coating or ink is applied to the vessel by pad printing.
210. The vessel of any preceding embodiment, in which the wave-shifting crystals, optionally wave-shifting nanoparticle crystals, optionally rare earth doped nanoparticle crystals are present in a label, optionally an adhesive label, and at least a portion of the vessel or closure comprises the label.
211. The vessel of any preceding embodiment, in which the label is adhered to an exterior wall of the vessel.
212. The pharmaceutical package of any preceding embodiment, in which the label is transparent.
213. The vessel of any preceding embodiment, in which the wall having the label in which the wave-shifting crystals, optionally wave-shifting nanoparticle crystals, optionally rare earth doped nanoparticle crystals are present has at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).
214. The vessel of any preceding embodiment, in which at least a portion of the label is holographic.
215. The vessel of any preceding embodiment, in which the wave-shifting crystals, optionally wave-shifting nanoparticle crystals, optionally rare earth doped nanoparticle crystals are present in at least a portion of the label in a predetermined pattern.
216. The vessel of any preceding embodiment, in which tthe wave-shifting crystals, optionally wave-shifting nanoparticle crystals, optionally rare earth doped nanoparticle crystals are present in the label in a scannable coded pattern, optionally a bar code or QR code.
217. The vessel of any preceding embodiment, in which the wave-shifting crystals, optionally wave-shifting nanoparticle crystals, optionally rare earth doped nanoparticle crystals are present in a portion of the label in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
218. The vessel of any preceding embodiment, wherein a portion of the vessel or closure is etched, optionally laser etched, to produce a recess and the wave-shifting crystals, optionally wave-shifting nanoparticle crystals, optionally rare earth doped nanoparticle crystals are incorporated into at least a portion of a recess.
219. The vessel of any preceding embodiment, wherein etching forms a recess having a predetermined pattern.
220. The vessel of any preceding embodiment, in which the predetermined pattern comprises a scannable coded pattern, optionally a bar code or QR code.
221. The vessel of any preceding embodiment, in which a polymeric resin comprising the wave-shifting crystals, optionally wave-shifting nanoparticle crystals, optionally rare earth doped nanoparticle crystals is positioned in the recess.
222. The vessel of any preceding embodiment, in which the polymeric resin comprises an epoxy; optionally in which the polymeric resin is an epoxy.
223. The vessel of any preceding embodiment, in which the vessel is a vial and the recess is located on a base of the vial.
224. The vessel of any preceding embodiment, in which the vessel is a syringe barrel and the recess is located on a flange of the syringe barrel.
225. The vessel of any preceding embodiment, in which the wave-shifting crystals, optionally wave-shifting nanoparticle crystals, optionally rare earth doped nanoparticle crystals are present in the polymeric resin in an amount of about 1000 ppm or less, alternatively about 750 ppm or less, alternatively about 500 ppm or less, alternatively about 250 ppm or less, alternatively about 100 or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.
226. The vessel of any preceding embodiment, in which the wave-shifting crystals, optionally wave-shifting nanoparticle crystals, optionally rare earth doped nanoparticle crystals are luminescent.
227. The vessel of any preceding embodiment, in which the wave-shifting crystals, optionally wave-shifting nanoparticle crystals, optionally rare earth doped nanoparticle crystals are configured/tuned to react to one or more specific wavelengths of light.
228. The vessel of any preceding embodiment, in which the wave-shifting crystals, optionally wave-shifting nanoparticle crystals, optionally rare earth doped nanoparticle crystals are configured/tuned to luminesce in response to light having a wavelength within the ultraviolet spectrum, light having a wavelength within the visible spectrum, light having a wavelength within the infrared spectrum, or any combination thereof.
229. The vessel of any preceding embodiment, in which the wave-shifting crystals, optionally wave-shifting nanoparticle crystals, optionally rare earth doped nanoparticle crystals are configured/tuned to luminesce solely in response to light having a wavelength within the ultraviolet spectrum.
230. The vessel of any preceding embodiment, in which the wave-shifting crystals, optionally wave-shifting nanoparticle crystals, optionally rare earth doped nanoparticle crystals are configured/tuned to luminesce solely in response to light having a wavelength within the visible spectrum.
231. The vessel of any preceding embodiment, in which the wave-shifting crystals, optionally wave-shifting nanoparticle crystals, optionally rare earth doped nanoparticle crystals are configured/tuned to luminesce solely in response to light having a wavelength within the infrared spectrum.
232. The vessel of any preceding embodiment, in which the wave-shifting crystals, optionally wave-shifting nanoparticle crystals, optionally rare earth doped nanoparticle crystals are configured/tuned to luminesce only in response to light having a wavelength within a defined wavelength range.
233. The vessel of any preceding embodiment, in which the wave-shifting crystals, optionally wave-shifting nanoparticle crystals, optionally rare earth doped nanoparticle crystals are cathodoluminescent.
234. The vessel of any preceding embodiment, in which the wave-shifting crystals, optionally wave-shifting nanoparticle crystals, optionally rare earth doped nanoparticle crystals are down-converting phosphors.
235. The vessel of any preceding embodiment, in which the wave-shifting crystals, optionally wave-shifting nanoparticle crystals, optionally rare earth doped nanoparticle crystals are up-converting phosphors.
236. The vessel of any preceding embodiment, in which the wave-shifting crystals, optionally wave-shifting nanoparticle crystals, optionally rare earth doped nanoparticle crystals are configured/tuned to produce an emission in one or more defined emission wavelength bands/ranges.
237. The vessel of any preceding embodiment, in which the wave-shifting crystals, optionally wave-shifting nanoparticle crystals, optionally rare earth doped nanoparticle crystals are configured/tuned to have a defined rise time, decay time, or both.
238. The vessel of any preceding embodiment, in which the wave-shifting crystals, optionally wave-shifting nanoparticle crystals, optionally rare earth doped nanoparticle crystals are configured/tuned to produce an emission having an intensity within a defined range.
239. The vessel of any preceding embodiment, in which the wave-shifting crystals, optionally wave-shifting nanoparticle crystals, optionally rare earth doped nanoparticle crystals are configured/tuned to produce an emission having dimensions within a defined range.
240. The vessel of any preceding embodiment, in which the wave-shifting crystals, optionally wave-shifting nanoparticle crystals, optionally rare earth doped nanoparticle crystals are configured and present in an amount sufficient such that their luminescence is detectable by a hand-held authentication device, an industrial authentication device, optionally a mobile authentication device, optionally a smartphone or similar device, or a combination of devices.
241. The vessel of any preceding embodiment, in which the authentication device interrogates the vessel using one or more discrete wavelengths.
242. The vessel of any preceding embodiment, in which the wave-shifting crystals, optionally wave-shifting nanoparticle crystals, optionally rare earth doped nanoparticle crystals have diameters between about 10 nm and about 1,500 nm, alternatively between about 10 nm and about 1,000 nm, alternatively between about 10 nm and about 500 nm, alternatively between about 10 nm and about 250 nm, alternatively between about 10 nm and about 100 nm, alternatively between about 10 nm and about 50 nm, alternatively between about 100 and 1,500 nm, alternatively between about 100 and 1,000 nm, alternatively between about 200 and 1,500 nm, alternatively between about 200 and about 1,000 nm.
243. The vessel of any preceding embodiment, in which the wave-shifting crystals, optionally wave-shifting nanoparticle crystals, optionally rare earth doped nanoparticle crystals have dimensions/diameters 400 nm or less, alternatively 350 nm or less, alternatively 300 nm or less, alternatively 250 nm or less, alternatively 200 nm or less, alternatively 150 nm or less, alternatively 100 nm or less, alternatively 50 nm or less, alternatively between about 30 and about 50 nm.
244. The vessel of any preceding embodiment, in which the wave-shifting crystals are wave-shifting nanoparticle crystals.
245. The vessel of any preceding embodiment, in which the wave-shifting crystals are rare earth doped crystals.
246. The vessel of any preceding embodiment, in which the wave-shifting crystals are rare earth doped nanoparticle crystals.
247. The vessel of any preceding embodiment, in which the rare earth doped crystals, optionally rare earth doped nanoparticles, comprise a rare earth element-containing lattice and a dopant.
248. The vessel of any preceding embodiment, in which the dopant comprises a rare earth element, and wherein the rare earth element-containing lattice contains a first rare earth element and the dopant comprises a second rare earth element, whereby the second rare earth element differs from the first rare earth element.
249. The vessel of any preceding embodiment, in which the first rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.
250. The vessel of any preceding embodiment, in which the second rare earth element is selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.
251. The vessel of any preceding embodiment, in which the dopant comprises two or more different rare earth elements.
252. The vessel of any preceding embodiment, wherein the lattice comprises NaYF₄.
253. The vessel of any preceding embodiment, wherein the dopant comprises Yb and a second rare earth element.
254. The vessel of any preceding embodiment, wherein the dopant comprises one of the following combinations: Er and Yb; Tm and Yb, Nd and Yb, Ho and Yb, or Pr and Yb.
255. The vessel of any preceding embodiment, in which the rare earth doped crystals, optionally rare earth doped nanoparticles, comprise a lattice and one or more rare earth element dopants.
256. The vessel of any preceding embodiment, in which the lattice comprises NaLiF.
257. The vessel of any preceding embodiment, in which the dopant comprises Nd or Pr.
258. The vessel of any preceding embodiment, in which the lattice comprises Y2O3.
259. The vessel of any preceding embodiment, in which the dopant comprises Er and Yb.
260. The vessel of any preceding embodiment, in which the lattice comprises Gd, optionally Gd₂SO₂ or Gd₂O₃.
261. The vessel of any preceding embodiment, in which the wave-shifting crystal comprises one or more of Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er.
262. The vessel of any preceding embodiment, of any preceding embodiment, in which the rare earth doped crystals have a polyhedral morphology.
263. The vessel of any preceding embodiment, in which the rare earth doped crystals have a uniform or substantially uniform morphology.
264. The vessel of any preceding embodiment, in which the wave-shifting crystals, optionally wave-shifting nanoparticle crystals, optionally rare earth doped nanoparticle crystals are configured to produce an emission in response to interrogation by a device, optionally a smartphone, having an IR illuminator, a VCSEL, an LED light, or a combination thereof.
265. The vessel of any preceding embodiment, in which the wave-shifting crystals, optionally wave-shifting nanoparticle crystals, optionally rare earth doped nanoparticle crystals are configured and present in an amount to produce an emission that is readable by a device, optionally a smartphone, having a CMOS sensor or CMOS camera.
266. The vessel of any preceding embodiment, in which the wave-shifting crystals, optionally wave-shifting nanoparticle crystals, optionally rare earth doped nanoparticle crystals are of a uniform or substantially uniform size, in which substantially uniform means within a tolerance of about 10 nm or less.
267. The vessel of any preceding embodiment, wherein the vessel is a vial and wherein the rare earth doped crystals are present in or on the bottom wall of the vial.
268. The vessel of any preceding embodiment, wherein the vessel has been subjected to sterilization, optionally sterilization by irradiation, optionally sterilization by gas.
269. The vessel of any preceding embodiment, wherein the wave-shifting crystals, optionally wave-shifting nanoparticle crystals, optionally rare earth doped nanoparticle crystals are configured to withstand sterilization of the vessel, optionally sterilization by irradiation, optionally sterilization by gas.
270. The vessel of any preceding embodiment, wherein the vessel has been subjected to autoclaving at a temperature of 120° C. or higher.
271. The vessel of any preceding embodiment, wherein the wave-shifting crystals, optionally wave-shifting nanoparticle crystals, optionally rare earth doped nanoparticle crystals are configured to withstand autoclaving at a temperature of 120° C. or higher.
272. The vessel of any preceding embodiment, wherein the wave-shifting crystals, optionally wave-shifting nanoparticle crystals, optionally rare earth doped nanoparticle crystals are configured to operate as a temperature indicator, a pressure sensor, or both.

### Methods

273. A method of authenticating and/or tracing a pharmaceutical package or vessel, the method comprising:
   providing a pharmaceutical package or vessel according to any one of the previous embodiments;
   interrogating the package to determine if the wave-shifting crystals, optionally wave-shifting nanoparticle crystals, optionally rare earth doped nanoparticle crystals have one or more predetermined luminescence characteristics;
   identifying the package based on the results of the interrogation.
274. The method of any preceding embodiment, wherein the one or more predetermined luminescence characteristics comprises:
   emission within one or more defined wavelength bands;
   emission having a defined rise time,
   emission having a defined decay time,
   emission having a defined intensity at a given time,
   emission in a defined spatial pattern, or
   any combination thereof.
275. The method of any preceding embodiment, wherein the step of interrogating comprises
   applying light having one or more wavelengths to the pharmaceutical package or vessel to excite the wave-shifting crystals, optionally wave-shifting nanoparticle crystals, optionally rare earth doped nanoparticle crystals, and
   detecting one or more luminescence characteristics of the light emitted by the wave-shifting crystals, optionally wave-shifting nanoparticle crystals, optionally rare earth doped nanoparticle crystals.
276. The method of any preceding embodiment, wherein the one or more discrete wavelengths are selected from one or more wavelengths within the ultraviolet spectrum, one or more wavelengths within the visible spectrum, one or more wavelengths within the infrared spectrum, or any combination thereof.
277. The method of any preceding embodiment, wherein the one or more discrete wavelengths are selected from one or more wavelengths within the ultraviolet spectrum.
278. The method of any preceding embodiment, wherein the one or more discrete wavelengths are selected from one or more wavelengths within the visible spectrum.
279. The method of any preceding embodiment, wherein the one or more discrete wavelengths are selected from one or more wavelengths within the infrared spectrum.
280. The method of any preceding embodiment, wherein the applying is performed by a hand-held device, optionally wherein the pharmaceutical package is a cartridge and the hand-held device is an auto-injector or injection pen.
281. The method of any preceding embodiment, wherein the detecting is also performed by the hand-held device, optionally wherein the pharmaceutical package is a cartridge and the hand-held device is an auto-injector or injection pen.
282. The method of any preceding embodiment, wherein the light emitted by the wave-shifting crystals, optionally wave-shifting nanoparticle crystals, optionally rare earth doped nanoparticle crystals has one or more discrete wavelengths selected from one or more wavelengths within the ultraviolet spectrum, one or more wavelengths within the visible spectrum, one or more wavelengths within the infrared spectrum, or any combination thereof.
283. The method of any preceding embodiment, wherein the light emitted by the wave-shifting crystals, optionally wave-shifting nanoparticle crystals, optionally rare earth doped nanoparticle crystals has one or more discrete wavelengths within the ultraviolet spectrum.
284. The method of any preceding embodiment, wherein the light emitted by the wave-shifting crystals, optionally wave-shifting nanoparticle crystals, optionally rare earth doped nanoparticle crystals has one or more discrete wavelengths within the visible spectrum.
285. The method of any preceding embodiment, wherein the light emitted by the wave-shifting crystals, optionally wave-shifting nanoparticle crystals, optionally rare earth doped nanoparticle crystals has one or more discrete wavelengths within the infrared spectrum.
286. The method of any preceding embodiment, wherein the applying light and the detecting light are performed by the same device.
287. The method of any preceding embodiment, wherein the step of interrogating the package is performed using a smart phone or tablet.
288. A method of preparing a pharmaceutical package or vessel according to any one of the previous embodiments, the method comprising:
   injecting a thermoplastic material comprising the wave-shifting crystals, optionally wave-shifting nanoparticle crystals, optionally rare earth doped nanoparticle crystals into a mold to form the vessel or at least a portion of the vessel.
289. A method of preparing a pharmaceutical package or vessel according to any one of the previous embodiments, the method comprising:
   injecting a thermoplastic material comprising the wave-shifting crystals, optionally wave-shifting nanoparticle crystals, optionally rare earth doped nanoparticle crystals into a mold to form a preform, and
   blow molding or stretch blow molding the preform to form the vessel or at least a portion of the vessel.
290. A method of preparing a pharmaceutical package or vessel according to any one of the previous embodiments, the method comprising:
   providing the vessel;
   coating at least one wall of the vessel with a coating material comprising the wave-shifting crystals, optionally wave-shifting nanoparticle crystals, optionally rare earth doped nanoparticle crystals.
291. A method of preparing a pharmaceutical package or vessel according to any one of the previous embodiments, the method comprising:
   providing the vessel;
   burning channels or recesses in the vessel wall with a laser, thereby forming one or more non-transparent areas; and
   coating at least one of the one or more non-transparent areas with a coating material comprising the wave-shifting crystals, optionally wave-shifting nanoparticle crystals, optionally rare earth doped nanoparticle crystals.
292. The method of any previous embodiment, wherein the coating is performed by CVD, ALD, or wet solution deposition, optionally wherein the coating is performed by CVD, optionally wherein the coating is performed by ALD, optionally wherein the coating is performed by wet solution deposition.
293. A method of preparing a pharmaceutical package or vessel according to any one of the previous embodiments, the method comprising: providing the vessel;
   applying an ink comprising the wave-shifting crystals, optionally wave-shifting nanoparticle crystals, optionally rare earth doped nanoparticle crystals to at least a portion of the vessel, optionally to an exterior wall of the vessel.
294. The method of any previous embodiment, wherein the ink is applied to at least a portion of the vessel using an ink jet printer.
295. A method of preparing a pharmaceutical package or vessel according to any one of the previous embodiments, the method comprising:
   providing the vessel;
   applying a label comprising the wave-shifting crystals, optionally wave-shifting nanoparticle crystals, optionally rare earth doped nanoparticle crystals to at least a portion of the vessel, optionally to an exterior wall of the vessel.
296. The method of any previous embodiment, further comprising, prior to filling the vessel with the pharmaceutical solution, inspecting the vessel to ensure:
   the presence of the wave-shifting crystals, optionally wave-shifting nanoparticle crystals, optionally rare earth doped nanoparticle crystals, that the positioning of the wave-shifting crystals, optionally wave-shifting nanoparticle crystals, optionally rare earth doped nanoparticle crystals on the vessel is correct,
   that the light emitted by the wave-shifting crystals, optionally wave-shifting nanoparticle crystals, optionally rare earth doped nanoparticle crystals has one or more predetermined emission characteristics, or
   any combination thereof.
297. The method of any previous embodiment, wherein the one or more predetermined luminescence characteristics comprises:
   emission within one or more defined wavelength bands;
   emission having a defined rise time,
   emission having a defined decay time,
   emission having a defined intensity at a given time,
   emission in a defined spatial pattern, or
   any combination thereof.
298. The method of any previous embodiment, further comprising
   filling the lumen with the pharmaceutical solution; and
   sealing the lumen with the closure.
A1. A shipping case containing a plurality of pharmaceutical packages comprising:
   a container comprising a bottom wall, one or more and optionally a plurality of side walls, and a top wall;
   a plurality of pharmaceutical packages, each of which contains a pharmaceutical formulation;
   a tag configured to transmit data that includes the location of the shipping case, the temperature of the shipping case, or both.
A2. The shipping case of any preceding embodiment, wherein the tag is configured to transmit both the location and the temperature of the shipping case.
A3. The shipping case of any preceding embodiment, wherein the tag includes a power source.
A4. The shipping case of any preceding embodiment, wherein the power source is a battery.
A5. The shipping case of any preceding embodiment, wherein the power source has an operating lifetime of at least one year, optionally at least two years, optionally at least three years, optionally at least four years, optionally at least five years.
A6. The shipping case of any preceding embodiment, wherein the tag is configured to transmit data by satellite network, Wi-Fi network, cellular phone network, short-range wireless technology (e.g. Bluetooth), or any combination thereof.
A7. The shipping case of any preceding embodiment, wherein the tag comprises a GPS or A-GPS element.
A8. The shipping case of any preceding embodiment, wherein the tag comprises a temperature sensor.
A9. The shipping case of any preceding embodiment, wherein the tag is configured to transmit the location data, the temperature data, or both at defined intervals.
A10. The shipping case of any preceding embodiment, wherein the tag is configured to transmit the location data, the temperature data, or both at least once per day, optionally at least once per 12 hours, optionally at least once per 8 hours, optionally at least once per 4 hours, optionally at least once per 2 hours, optionally at least once per hour.
A11. The shipping case of any preceding embodiment, wherein the tag is configured to transmit at least the location data any time the location of the shipping case changes.
A12. The shipping case of any preceding embodiment, wherein the tag is configured to transmit at least the temperature data any time the temperature of the shipping case changes.
A13. The shipping case of any preceding embodiment, wherein the tag is configured to transmit at least the temperature data if the temperature exceeds a predefined threshold value.
A14. The shipping case of any preceding embodiment, wherein the predefined threshold value comprises an upper limit of permissible shelf-life temperatures for the pharmaceutical formulation, a lower limit of permissible shelf-life temperatures for the pharmaceutical formulation, or both.
A15. The shipping case of any preceding embodiment, wherein the location data, the temperature data, or both is available via mobile application installed on a laptop, tablet, or smartphone.
A16. The shipping case of any preceding embodiment, wherein the tag has a thickness less than 20 mm, optionally less than 15 mm, optionally less than 12 mm, optionally less than 10 mm, optionally less than 7 mm, optionally less than 5 mm, optionally less than 3 mm.
A17. The shipping case of any preceding embodiment, wherein the tag has a length dimension less than 25 mm, optionally less than 20 mm, optionally less than 15 mm, optionally less than 10 mm; and a width dimension less than 25 mm, optionally less than 20 mm, optionally less than 15 mm, optionally less than 10 mm.
A18. The shipping case of any preceding embodiment, wherein the tag has a weight less than 5 grams, optionally less than 4 grams, optionally less than 3 grams, optionally less than 2 grams.
A19. The shipping case of any preceding embodiment, wherein the tag is operable at temperatures as low as −20° C., optionally as low as −30° C., optionally as low as −40° C., optionally as low as −50° C., optionally as low as −60° C., optionally as low as −70° C.
A20. The shipping case of any preceding embodiment, wherein the pharmaceutical packages comprise vials or syringes, each of which contains an injectable pharmaceutical formulation.
A21. The shipping case of any preceding embodiment, wherein the pharmaceutical packages comprise one or more pharmaceutical package described in any of embodiments 1 to 146.
A22. The shipping case of any preceding embodiment, wherein the plurality of pharmaceutical packages comprises between about 200 and about 500 pharmaceutical packages.
A23. The shipping case of any preceding embodiment, wherein the pharmaceutical packages are contained in a plurality of boxes.
A24. The shipping case of any preceding embodiment, wherein the container holds the plurality of the boxes and wherein each of the boxes holds a portion of the plurality of pharmaceutical packages.
A25. The shipping case of any preceding embodiment, where each of the boxes holds between 20 and 40 pharmaceutical packages.
A26. The shipping case of any preceding embodiment, wherein the container holds between 10 and 20 boxes.
A27. The shipping case of any preceding embodiment, wherein the top wall is removable, e.g. a removable cover.
A28. The shipping case of any preceding embodiment, wherein the top wall comprises a plurality of portions, each of which is hinged to the upper end of one of the plurality of sidewalls.
A29. The shipping case of any preceding embodiment, wherein the container is corrugated fiberboard.
A30. The shipping case of any preceding embodiment, wherein the corrugated fiberboard has a coating that reduces particle attraction.
A31. The shipping case of any preceding embodiment, wherein the container is corrugated plastic.
A32. The shipping case of any preceding embodiment, wherein the container is a polymer-fiber composite.
A33. The shipping case of any preceding embodiment, wherein the tag is held within the container, optionally where the tag is held within the container beneath one or more of the plurality of boxes.
A34. The shipping case of any preceding embodiment, wherein the tag is contained by a pouch.
A35. The shipping case of any preceding embodiment, wherein the tag or pouch is affixed to an interior surface of the container.
A36. The shipping case of any preceding embodiment, where the tag or pouch is affixed to an interior surface of the container by a tamper-evident mechanism.
A37. The shipping case of any preceding embodiment, wherein the tag or pouch is affixed to an interior surface of the container by an adhesive label.
A38. The shipping case of any preceding embodiment, wherein an interior wall of the container comprises a pocket or recess in which the tag or pouch is positioned.
A39. The shipping case of any preceding embodiment, wherein the tag or pouch is integrated into the container.
A40. The shipping case of any preceding embodiment, wherein the tag or pouch is integrated into the bottom wall, one of the plurality of sidewalls, or the top wall of the container.
A41. The shipping case of any preceding embodiment, wherein the tag or pouch is positioned between a first linerboard and a second linerboard of a corrugated fiberboard.
A42. The shipping case of any preceding embodiment, wherein the tag or pouch is positioned in a recess in the corrugated board.
A43. The shipping case of any preceding embodiment, wherein the shipping case is configured so that the tag is not visible when the container is closed.
A44. The shipping case of any preceding embodiment, wherein the shipping case is configured so that the tag is not visible when the container is opened.
A45. The shipping case of any preceding embodiment, wherein the tag is affixed to the container by a tamper-evident element.
B1. A method of tracking the location, temperature, or both of pharmaceutical packages comprising:
   providing the shipping case of any preceding embodiment; and tracking
      (i) the location of the shipping case,
      (ii) the temperature of the shipping case, or
      (iii) both (i) and (ii),
   at one or more, and optionally numerous, times throughout the supply chain of the pharmaceutical packages.
B2. The method of any preceding embodiment, comprising tracking the temperature of the shipping case to determine whether the temperature exceeds a predefined threshold temperature.
B3. The method of any preceding embodiment, wherein the predefined threshold temperature is an upper limit of permissible shelf-life temperatures for the pharmaceutical formulation.
B4. The method of any preceding embodiment, comprising tracking the location of the shipping case.
B5. The method of any preceding embodiment, further comprising identifying whether the shipping case is diverted.
B6. The method of any preceding embodiment wherein the tag transmits the location data, the temperature data, or both at defined intervals.
B7. The method of any preceding embodiment, wherein the tag transmits the location data, the temperature data, or both at least once per day, optionally at least once per 12 hours, optionally at least once per 8 hours, optionally at least once per 4 hours, optionally at least once per 2 hours, optionally at least once per hour.
B8. The method of any preceding embodiment, wherein the tag transmits at least the location data any time the location of the shipping case changes.
B9. The method of any preceding embodiment, wherein the tag transmits at least the location data if the location of the shipping case corresponds with one or more predefined areas.
B10. The method of any preceding embodiment, wherein the tag transmits at least the temperature data any time the temperature of the shipping case changes.
B111. The method of any preceding embodiment, wherein the tag transmits at least the temperature data if the temperature of the shipping case exceeds a predefined threshold value, optionally wherein the predefined threshold temperature is an upper limit of permissible shelf-life temperatures for the pharmaceutical formulation, a lower limit of permissible shelf-life temperatures for the pharmaceutical formulation, or both.
B12. The method of any preceding embodiment, wherein the tag transmits the data by satellite network, Wi-Fi network, cellular phone network, short-range wireless technology (e.g. Bluetooth), or any combination thereof.
B13. The method of any preceding embodiment, wherein the tracking is performed via mobile application installed on a laptop, tablet, or smartphone.
B14. The method of any preceding embodiment, wherein the tracking is performed via the Internet.
B15. The method of any preceding embodiment, wherein the tracking comprising real-time tracking.
B16. The method of any preceding embodiment, further comprising receiving an alert if the shipping case enters one or more predefined areas, leaves one or more predefined areas, or both.
B17. The method of any preceding embodiment, further comprising receiving an alert if the temperature of the shipping case exceeds a predefined threshold value, optionally wherein the predefined threshold value is an upper limit of permissible shelf-life temperatures for the pharmaceutical formulation, a lower limit of permissible shelf-life temperatures for the pharmaceutical formulation, or both.
B18. The method of any preceding embodiment, wherein the alert is received via mobile phone text message.
B19. The method of any preceding embodiment, further comprising maintaining the location data in a database so that a location history of the shipping case is available.
B20. The method of any preceding embodiment, wherein the tracking is performed by an intended recipient of the shipping case.
B21. The method of any preceding embodiment, wherein the tracking is performed by a sender of the shipping case.
B22. The method of any preceding embodiment, further comprising diverting the shipping case if it is found that the temperature exceeded the predefined threshold, optionally if it is found that the temperature exceeded the predefined threshold for a predefined period of time.
B23. The method of any preceding embodiment, further comprising diverting the shipping case in response to an identified location of the shipping case.

1. A vessel configured to contain a pharmaceutical solution within a lumen thereof and to be authenticated and/or traced by way of producing a light emission having one or more predetermined characteristics, comprising:
a vessel defining a lumen,
in which the vessel comprises wave-shifting marker crystals configured to emit light having one or more characteristics by which the package may be identified.

2. The vessel of claim 1, wherein the marker crystals are rare earth doped crystals.

3. The vessel of claim 1, wherein the vessel is a syringe barrel, a cartridge, or a vial.

4. The vessel of claim 1, wherein the marker crystals are incorporated into a wall of the vessel.

5. The vessel of claim 1, wherein the vessel comprises at least one wall made of a thermoplastic material.

6. The vessel of claim 1, in which the wave-shifting crystals are present in an ink or coating, and at least a portion of a vessel wall comprises the ink or coating.

7. The vessel of claim 1, in which the wall having the marker crystals is transparent.

8. The vessel of claim 1, wherein the vessel is blow molded from a preform comprising a thermoplastic resin that contains the marker crystals or injection molded from a thermoplastic resin that contains the marker crystals.

9. The vessel of claim 1, in which the marker crystals have dimensions/diameters 50 microns or less.

10. The vessel of claim 1, in which the marker crystals are present in or on the wall of the vessel in an amount of about 100 ppm or less.

11. The vessel of claim 5, in which at least a portion of the thermoplastic vessel wall comprises two or more layers, wherein at least one of the two or more layers is free of the marker crystals, and at least one of the two or more layers contains the marker crystals.

12. The vessel of claim 5, in which at least a portion of the thermoplastic wall includes an in-mold label or component containing the marker crystals.

13. The vessel of claim 1, in which the marker crystals are configured and present in an amount sufficient such that, when excited, the emission is detectable/readable by a conventional smartphone or tablet computer.

14. The vessel of claim 1, wherein the vessel comprises one or more non-transparent areas and wherein the marker crystals are present in at least one of the non-transparent areas.

15. The vessel of claim 14, wherein the one or more non-transparent areas comprise letters and/or numbers, a scannable code, or a geometric shape.

16. The vessel of claim 14, wherein the one or more non-transparent areas are channels or recesses burned into the vessel wall by a laser and wherein the marker crystals are applied to or embedded in the channels or recesses.

17. The vessel of claim 1, in which the marker crystals are configured/tuned to react to one or more specific wavelengths of light.

18. The vessel of claim 1, wherein the marker crystals are configured/tuned to produce an emission in one or more defined wavelength bands/ranges; the marker crystals are configured/tuned to have a defined rise time, decay time, or both; the marker crystals are configured/tuned to produce an emission having an intensity within a defined range; the marker crystals are configured/tuned to produce an emission having dimensions within a defined range, or any combination thereof.

19. The vessel of claim 14, in which the vessel is a vial; and wherein a base of the vial comprises the non-transparent area in which the marker crystals are present.

20. The vessel of claim 14, in which the vessel is a syringe barrel; and wherein a flange of the syringe barrel comprises the non-transparent area in which the marker crystals are present.

21. The vessel of claim 1, further comprising a pharmaceutical solution within the lumen.
